(19) United States
(12) Patent Application Publication
(10) Pub. No.: US 2018/0177654 A1
(43) Pub. Date: Jun. 28, 2018

(54) HOSPITAL BED OR GURNEY HAVING SELECTIVE PATIENT PRIVACY

(71) Applicants: Stephen Muscarello, Barrington, IL (US); Robert W. Connors, Lake Barrington, IL (US)

(72) Inventors: Stephen Muscarello, Barrington, IL (US); Robert W. Connors, Lake Barrington, IL (US)

(21) Appl. No.: 15/836,059

(22) Filed: Dec. 8, 2017

Related U.S. Application Data
(60) Provisional application No. 62/512,511, filed on May 30, 2017.
(60) Provisional application No. 62/438,200, filed on Dec. 22, 2016.

(51) Int. Cl. A61G 7/05; A61G 1/04

(52) U.S. Cl. CPC A61G 7/0516; A61G 1/04; A61G 7/0525; A61G 7/0524; A61G 7/0512

(57) ABSTRACT

A hospital bed includes a frame defining a location to place a mattress, and at least one side panel in mechanical communication with the frame, the at least one side panel selectively expandable so as to provide patient privacy when desired and contractible when privacy is not desired. The expandable panel may include expandable and contractible shells or an expandable and contractible plate that resides within or on the outside of the panel. In a further alternative embodiment, portable patient privacy apparatuses are provided in which a hood is manually expandable from the patient to cover the patient. The portable patient privacy apparatuses may be used to provide patient privacy to existing hospital beds and gurneys.

### PRIORITY CLAIM

This application claims priority to and the benefit of U.S. Provisional Patent Application Ser. No. 62/512,511, filed May 30, 2017, entitled, “Hospital Bed Or Gurnee Having Selective Patient Privacy” and U.S. Provisional Patent Application Ser. No. 62/438,200, filed Dec. 22, 2016, entitled, “Hospital Bed Or Gurnee Having Selective Patient Privacy”, the entire contents of each of which are incorporated herein by reference and relied upon.

### BACKGROUND

The present disclosure relates generally to patient privacy and more particularly to hospital equipment providing patient privacy.

Hospitals want to be proud of the patient experience that they provide. Hospitals want to provide the type of experience they would want for their family members or friends if hospitalized. The emerging age of consumerism in healthcare is forcing hospitals to reexamine their traditional practices and provide greater sensitivity and responsiveness to patient preferences. Conventional customer service training, for example, is often not enough. Hospitals are therefore increasingly trying to reinvent their patient experiences.

Efforts are underway, for example, to integrate “high touch” and “high tech” care at hospitals of all types and sizes. In another example, attempts are underway to design facilities that minimize stress, support family involvement, and remove physical barriers between nurses and patients. Along these lines, hospitals are also attempting to emphasize personalized relationships between nurses and patients, with more “hands-on” care provided by nurses at the bedside. Similarly, hospitals are attempting to increase the availability and use of complementary therapies in inpatient settings to meet the general increase in patient demand for such therapies. In another example, certain hospitals are attempting to move beyond the traditional role of the hospital chaplain and train hospital staff to provide additional spiritual support for patients and family members.

While the above factors are important, they are going to take time and resources to implement. And some hospitals are simply not going to be able to meet all or even any of the above-listed objectives. One area not addressed above, which the inventors feel is a much easier fix, is the privacy that the patient experiences both in transport to and at the hospital. Take, for example, a runner who overheats during a race, passes out, and has to be taken by ambulance to hospital. The poor runner will undoubtedly lie in a gurney for multiple minutes in front of many curious onlookers while the ambulance and transport are prepped.

Similar situations occur routinely in hospitals. Patients waiting for surgery or testing in a hospital bed may be left in a common hallway outside of the operating room, which is being cleaned or prepped. Patients recovering from surgery or after testing in a hospital bed may likewise be left in a common hallway, while a follow-up procedure is performed or the patient's room is scheduled or prepped.

In any of the above situations, the patient lying in a gurney or hospital bed may desire privacy. Similarly, patients sharing rooms with other patients may desire privacy at certain times without having to call a nurse to pull a curtain or divider.

For each of the reasons, and for others apparent to those of skill in the art, a need exists to improve the patient experience by improving patient privacy.

### SUMMARY

Patient privacy and the overall quality care are of paramount importance as healthcare systems face the progression toward comprehensive value based reimbursement (“VBR”). The patient privacy panels discussed herein, whether automated or manual, serve to enhance the holistic patient experience and therefore add meaningful value to the healthcare system at large. The absence of patient privacy panels results in discomfort not only for the patient but also for guests, employees, vendors and other individuals that are in healthcare facilities every day. Patients are frequently moved throughout healthcare facilities with no existing provision for privacy. The patient movement includes, for example, being moved through hallways, waiting for radiology, “camping” in hallways, and being stuck in emergency room overflow situations.

The present disclosure sets forth multiple embodiments for providing privacy to a patient who is temporarily or semi-permanently placed in a hospital bed or gurney. In one embodiment, a hospital bed is provided with multiple panels. One, two or more, or all of the panels may be expandable panels as discussed herein. For example, the hospital bed may have a head panel, foot panel, two left side panels and two right side panels. Each of those panels may be referred to herein collectively as side panels or generally individually as a side panel. Each of those panels may also be an expandable panel as discussed herein. Or, for example, only the head panel, foot panel, head-end left side panel, and head-end right side panel are expandable, while the foot-end left side panel and the foot-end right side panel are not expandable. Other combinations are contemplated.

Whether or not a particular panel is expandable, the panel may also by rotatable and/or translatable relative to a frame of the bed. For example, the left and right side panels may be rotated down so as to be out of the way for the patient to get onto or off of the mattress. The left and right side panels may be rotated up so as to block and protect the patient from falling out of bed. The head and foot side panels may for example be translatable up and down for patient protection and to access the mattress. The rotation and translation of the side panels is performed manually in one embodiment, but may be automated in various alternative embodiments.

The frame of the bed holds a mattress. The frame is also hinged, mechanized and/or motorized (or subject to pneumatic or oil-based pressure), so that the frame may be bent to raise the patient's upper body, lower body, or place the patient in pseudo sitting position. The frame may then be bent into a horizontal configuration, so that the patient may lie in a prone position.

The expandable panels of the present disclosure include a bottom shell that slidingly engages a top shell. The bottom shell may fit inside of or outside of the top shell. In an embodiment, the bottom shell is mechanically linked to the frame, while the top shell is slideable and moveably with respect to the bottom shell. The linkage between the bottom shell and the bed frame may be one, as discussed above, which enables the overall panel to rotate and/or translate relative to the frame.

The shells may be made of molded plastic, and may be of the same material that is used currently for hospital bed siding. The shells are generally hollow on the inside, so that they may house the motion control equipment to provide the expandable and contractible movement of the present disclosure. In an embodiment, the motion control equipment includes a linear actuator.

In an embodiment, the linear actuator includes upper and lower bearings that are mounted to the inside of the lower shell, for example, to the inner wall of the shell closer to the bed or frame. A lead or ball screw is extended vertically between the upper and lower bearings. A drive arm is provided having a first portion that threadingly engages the lead or ball screw. A second portion of the lead or ball screw includes an elongated member that extends up to a top inside surface of the upper shell. The top of the shell defines an aperture that receives a fastener that fastens to or threads into a top of the member. In this manner, the upper and lower shells are mechanically connected, wherein the upper shell may be translated relative to the lower shell by rotating the lead or ball screw to move the carriage and its elongated member. Rotating the lead or ball screw in a first direction raises the upper member with respect to the lower member. Rotating the lead or ball screw in a second direction lowers the upper member with respect to the lower member.

The lead or ball screw is driven via a motor, such as a stepper motor. The motor may be coupled to the lower bearing via a mechanical reduction device, such as a planetary gear box, timing belt, or belt and pulley, which increases the torque output of the motor, enabling the motor to be small, compact and lightweight. The motor may operate on a standard 120 VAC. Limit switches may also be placed at the end of travel in each direction for the drive arm to cut the motor in the direction in which a limit has been reached. In an alternative embodiment, the motor is provided with an encoder that provides feedback to a control unit of the hospital bed, so that the control unit can keep track of the position of the drive arm and stop the drive arm when an end of travel limit as been reached.

All electrical wiring, such as power and sensor signal wires, may be run from a control unit having a power supply, through the insides of the beams of the frame, and into the sells of the expandable panels. In this manner, the wiring may be completely or virtually completely hidden from view. A power cord runs from the control unit to wall outlet providing, e.g., 120 VAC or 230 VAC. The control unit may include one or more transformer to convert the input voltage into the proper type and/or level of voltage needed to drive the motors, such as 12 or 24 VDC.

The control unit is also in electrical communication with one or more user input device for actuating the expanding panels of the present disclosure. The control unit may communicate with the one or more user input device via wired or wireless communication, e.g., via Bluetooth™ WiFi™, Zigbee®, Z-Wave®, wireless Universal Serial Bus (“USB”), infrared, nearfield communication (“NFC”) or any other suitable wireless communication technology. In one embodiment, a user input device is tethered to the control unit so that the device may be used by the patient or someone outside of the bed, such as a doctor, nurse, caregiver, family member or friend. In another embodiment, the user input device is a wireless pad. Alternatively or additionally, a user input device is provided on the top or front side of one, or more, or each expanding panel. The panel mounted user input devices are more for someone outside of the bed, such as a doctor, nurse, caregiver, family member or friend. Each of the user input devices described herein may control other functionality of the hospital bed (such as the motors for adjusting the frame) in addition to the functionality associated with the expandable panels of the present disclosure.

Each of the user input devices may have a single up-down toggle arrow button. If the patient presses the up arrow for a given expandable panel, the control unit causes the panel to expand, such that the upper shell rises with respect to the lower shell. If the patient instead presses the down arrow for a given expandable panel, the control unit causes the panel to contract, such that the upper shell lowers with respect to the lower shell. In an embodiment, the up-down toggle arrow button is a momentary type button in an embodiment, such that (i) the patient needs to keep pressing the button for the expandable panel to keep moving and (ii) when the patient releases the button, panel movement stops. The patient (or other person) can thereby set the upper shell at any desired height within the overall range of travel. In an embodiment, the user input device is provided with a vibrator, and the control unit is programmed to cause the vibrator within the input device to vibrate when the patient (or other person) tries to actuate any of the panels past its fully retracted or fully expanded state. The vibrator lets the user know that further actuation of the button will result in no action. In an alternative embodiment, the control unit is programmed such that pressing the up-down toggle arrow button momentarily in the up or down direction causes the panel to expand or contract to its final position without further input from the user.

In an embodiment, the up-down toggle arrow button operates in the momentary way just described when the patient presses the button, but does not press the button as far as possible. In addition, the button is configured such that if is pressed as far as possible, the button locks into a maintained state. Here, the button locks into an “up” state or a “down” state and the panel expands or contracts to its final position without further input from the user. In a further alternative embodiment, separate momentary and maintained buttons are provided for any one, or more, or all of the expanding panels of the present disclosure. In a further alternative embodiment, each panel is provided with separate momentary and maintained buttons, in which the user (i) presses the momentary button until the panel expands or contracts to a desired position and (ii) presses and releases the maintained button after which the panel expands or contracts fully.

Any of the user input devices, including the ones located on the panels themselves, may be provided with a way to move multiple ones, or all of the panels of the present disclosure. For example, any of the user input devices may display a small pictogram of the hospital bed highlighting each of the panels. The pictogram may show characters representing six panels, including a head side panel, a foot side panel, two left side panels, and two right side panels. Each of the characters is in turn associated with a button, such as a membrane switch. The user selects the button associated with the panel that the user wishes to modify, causing the control unit to focus on the selected pane. The user then uses the up-down button as described above to move the selected panel as desired. The pictogram may further be associated with multi-panel buttons, such as an “all” button that tells the control unit to move all expandable panels as commanded by the user, an “upper” button that tells the control unit to move the head side panel and the upper left and right side panels as commanded by the user, and a “lower” button that tells the control unit to move the foot side panel and the lower left and right side panels as commanded by the user. Thus in one embodiment the user can fully expand or contract each of the panels simultaneously in two button presses by pressing the “all” button followed by pressing a maintained up-down arrow button.

The expanding panels of the improved hospital bed just described provide a convenient and relatively cost-effective to provide selective patient privacy. The panels are easy to actuate and are fully automatic. The panels also integrate into the look of existing high-end hospital beds and in no way restrict any of the existing functionality provided by such beds.

In a first alternative expanding panel embodiment, each of the panels of the bed includes a shell which may be made of two shell halves. A plate is located between the shell halves. A slot is provided at the top of the shell for allowing the plate to extend out of the shell to form an expanded panel or to contract into the shell to form a contracted panel. The top of the shell may also provide brushes on either side of the slot to contact the plate as it is moving through the slot, preventing particulate from entering the shell. The shell may include handles that enable the shell to be rotated and/or translated back and forth manually between a bed-entry/exit state and a patient in-bed state. The top of the plate may also have one or more handle that enables the plate to be lifted out from the shell or pushed back into the shell. The bottom of the plate may have one or more roller bearing and associated housing for smoothly guiding the plate as it is moved, supporting the bottom of the plate as it is moved, and for providing a hardstop against the inside of the top of the shell when the plate is lifted fully and the panel is expanded fully.

Alternatively, an expandable and retractable bellows is provided within the shell and beneath the plate. The bellows may include one or more sealed section that receives pressurized air or other fluid, such as oil, to enable the patient or caregiver to expand or contract the first alternative panel automatically. The top of the bellows in an embodiment connects to the bottom of the plate. The top of the bellows thereby serves as a hardstop for the expanding movement of the plate. The bellows fits snugly within the shell in an embodiment, which helps to steady the plate inside and outside of the shell. The bellows may also be provided with a relief valve that enables positive pressure to be vented from the bellows in the event that the first alternative expanding panel becomes stuck in an expanded position.

In a second alternative expanding panel embodiment, each of the panels of the bed includes a shell and a plate is located on an outside of the shell. The outside of the shell includes slot forming members that hold the plate to the outside of the shell. The shell may include handles that enable the shell to be rotated and/or translated back and forth manually between a bed-entry/exit state and a patient in-bed state. The top of the plate may also have one or more handle that enables the plate to be lifted upwardly along an outside of the shell or be down long the outside of the shell. The bottom of the plate may have one or more tab that hardstops against an inwardly extending tab at the top of each slot forming member when the second alternative expanding panel is fully expanded. The one or more handle at the top of the plate hitting the top of the slot forming members serves as a hardstop when the second alternative expanding panel is fully contracted.

In a third alternative expanding panel embodiment, each of the panels of the bed includes a shell and the bellows described above is located at the top of the shell. The shell may include handles that enable the shell to be rotated and/or translated back and forth manually between a bed-entry/exit state and a patient in-bed state. The top of the bellows may also have one or more handle that enables the bellows to be lifted upwardly manually to form an expanded panel or to be compressed manually to form a contracted panel. The bellows in an alternative embodiment is expanded and retracted automatically by the patient or caregiver via positive and negative air or other fluid pressure. A pneumatic or other fluid, such as oil, line may be extended within the shell to the bellows located at the top of the shell. The line at the bottom of the shell may be provided with a relief valve that enables positive pressure to be vented from the bellows in the event that the third alternative expanding panel becomes stuck in an expanded position.

In a fourth alternative expanding panel embodiment, each of the panels of the bed includes a lower shell and a rotating shell connected rotatably to the lower shell via a least one hinge. The lower shell may include handles that enable the lower shell to be rotated and/or translated back and forth manually between a bed-entry/exit state and a patient in-bed state. The rotating shell may also have one or more handle that enables the rotating shell to be rotated manually upwardly to form an expanded panel or to be rotated downwardly manually to form a contracted panel. The hinge may be located along an upper, outer edge of the lower panel and a lower, outer edge of the rotating panel, so that a bottom of the rotating panel may come to rest on a top of the lower panel when the fourth alternative expanding panel is in its expanded position.

The above examples each involved panels associated with a hospital bed. The following primary embodiment discloses a different solution, which is a lower cost solution that does not require the hospital bed to be modified at all. This patient privacy apparatus may be used with any hospital bed and gurney. The portable patient privacy apparatus may be stored on the side of the bed or be folded up with the gurney and removed when desired for use. The privacy apparatus rests on the bed and fits around the user's head. In an embodiment, the apparatus is manually unfolded to provide privacy and manually collapsed for storage when not needed. The apparatus accordingly does not require AC or battery power

The portable patient privacy apparatus in various embodiments includes a U-shaped or polygonal-shaped base including a first end and a second end. The U-shaped or polygonal-shaped base is placed on the bed or gurney around the patient's head. If polygonal-shaped, the base can be five-sided, with two sides extending to the first and second ends, and three sides making a 180 degree turn (e.g., four 45 degree bends) between the other two sides. Located above the base is a correspondingly U-shaped or polygonal-shaped member including a first end mated with the first end of the base and a second end mated with a second end of the base. A hood is located between the base and the member, wherein the hood is foldable such that when the member is laid against the base, the hood folds onto itself between the member and the base, and when the member is moved away from the base with the first ends remaining in a mated relationship and the second ends remaining in a mated relationship, the hood unfolds between the member and the base to provide a privacy cover for the patient. The portable patient privacy apparatus also includes a structure in mechanical communication with the base, wherein the structure is configured to discourage or prevent the patient privacy apparatus from moving after being placed on the hospital bed or gurney.

The structure for discouraging or preventing the patient privacy apparatus from moving after being placed on the hospital bed or gurney can take different forms. In one embodiment, the structure includes one or more strap in mechanical communication with the base and sized to extend around and secure the apparatus to a mattress supporting of the bed or gurney the patient. Here, the straps may include buckles on their ends for tightening the straps about the mattress. In a second embodiment, the structure includes one or more strap positioned and arranged to secure the base to a head section of the hospital bed or gurney. Here, the straps may include hooks or hook and loop connectors for securing to the frame at the head section of the hospital bed or gurney. In a third embodiment, the structure includes a flange extending from the base, the flange providing at least one of weight or friction to stabilize the apparatus when the member is moved with respect to the base. In a fourth embodiment, a weighted flap is attached to the base. The flap may be weighted with sand for example. In other embodiments, combinations of the above structures may be employed.

In an embodiment, the member of the patient privacy apparatus is a top member, and at least one correspondingly U-shaped or polygonal-shaped intermediate member is provided that supports the hood when the top member is unfolded with respect to the base. The intermediate members provide spoke-like support to the hood and help the hood to provide an expanded cover for the patient. The intermediate members, like the base and top member, also each include a first end mated with the first ends of the base and top member a second end mated with a second ends of the base and top member. In one embodiment, the first and second ends of the top member, the intermediate members and the base are in a hinged relationship with each other. That is, the first and second ends of each of the members and base may terminate at a hinge. The top and base members may attach to the hinge, while the ends of the intermediate members terminate before the hinge.

The hood is made of a material that can withstand an antiseptic wash, such as rubber, plastic or a washable fabric. The hood may also include an openable hatch for viewing the patient when the member is unfolded from the base. The hatch is sealed closed via a flap that connects with the rest of the hood via hook and loop connections in one embodiment. The user undoes the hook and loop connections and allows the flap to fall beneath the hole of the hatch, so that the user can monitor the patient, e.g., when moving the patient in the hospital bed or gurney.

In the instance in which the structure for discouraging or preventing the patient privacy apparatus from moving after being placed on the hospital bed or gurney includes the flange, the flange may extend extends perpendicularly from the base. The flange may be flat or curved such that apparatus rests on one or more peripheral edge of the flange. The flange may be made of rubber or include a rubber contacting surface to increase friction with the mattress. 39. In the instance in which the structure for discouraging or preventing the patient privacy apparatus from moving after being placed on the hospital bed or gurney includes the flange or the weighted flap, the flange or flap may include at least one of (i) one or more hook for hooking the apparatus to a side of the hospital bed or gurney for storage, or (ii) a handle or handle cutout for transporting the apparatus.

In another primary embodiment, the patient privacy apparatus is instead fastened to the gurney. The gurney includes a collapsible frame assembly that folds flat as does the fastened patient privacy apparatus, such that the entire gurney may be stored and removed for use in the same manner as known gurneys. The patient privacy apparatus integrated with the collapsible frame is in one embodiment the same as or very similar to the portable hood assembly described herein. While the portable hood assembly is described in one embodiment as being U-shaped, the hood assembly integrated with the gurney may be square or rectangular to fit the shape of the collapsible frame of the gurney. Any of the hood assemblies described herein may be square, rectangular, U-shaped or have any other desirable polygonal shape.

The hood assembly of the integrated gurney in one embodiment includes a base member, an outer member and plural intermediate members, each of which attach to and support an openable and collapsible hood. The base member and outer member are in one embodiment attached to first and second hinges that allow for the opening and closing of the hood. The first and second hinges fasten (e.g., bolt) to or compress onto the collapsible frame assembly, e.g., to first and second corresponding side members of an upper frame of the frame assembly. The base member may be attached additionally in one or more spot to the frame assembly. Any of the hoods described herein may include an openable hatch that enables a user to view the patient, injured or sick person, e.g., while pushing or pulling the gurney of the present disclosure.

In light of the disclosure herein and without limiting the disclosure in any way, in a first aspect of the present disclosure, which may be combined with any other aspect described herein unless specified otherwise, a hospital bed includes a frame defining a location to place a mattress; and at least one side panel in mechanical communication with the frame, the at least one side panel selectively expandable so as to provide patient privacy when desired and contractible when privacy is not desired.

In a second aspect, which may be combined with any other aspect described herein unless specified otherwise, the at least one side panel is additionally selectively translatable relative to the frame.

In a third aspect, which may be combined with the second aspect in combination with any other aspect described herein unless specified otherwise, with any other aspect described herein unless specified otherwise, the at least one side panel is manually translatable relative to the frame.

In a fourth aspect, which may be combined with any other aspect described herein unless specified otherwise, the at least one side panel is additionally selectively rotatable relative to the frame.

In a fifth aspect, which may be combined with the fourth aspect in combination with any other aspect described herein unless specified otherwise, the at least one side panel is manually rotatable relative to the frame.

In a sixth aspect, which may be combined with any other aspect described herein unless specified otherwise, the hospital bed includes a control unit and a user input device in communication with the control unit, the control unit programmed to enable the user to actuate a button of user the user input device to cause the at least one side panel to expand or contract.

In a seventh aspect, which may be combined with the sixth aspect in combination with any other aspect described herein unless specified otherwise, the user input device and the control unit are configured such that the at least one side panel expands or contracts as the user continues to actuate the button of the user input device.

In an eighth aspect, which may be combined with the sixth aspect in combination with any other aspect described herein unless specified otherwise, the user input device and the control unit are configured such that the at least one side panel continues to expand or contract after the user discontinues actuation of the button of the user input device.

In a ninth aspect, which may be combined with the sixth aspect in combination with any other aspect described herein unless specified otherwise, the button of the user input device includes first and second settings, wherein the first setting and the control unit are configured to cause the at least one side panel to expand or contract as the user continues to actuate the input device at the first setting, and wherein the second setting and the control unit are configured to cause the at least one side panel to continue to expand or contract after the user discontinues actuation of the second setting.

In a tenth aspect, which may be combined with the sixth aspect in combination with any other aspect described herein unless specified otherwise, the button of the user input device is a first button, and which includes a second button, wherein the first button and the control unit are configured to cause the at least one side panel to expand or contract as the user continues to actuate the first button, and wherein the second button and the control unit are configured to cause the at least one side panel to continue to expand or contract after the user discontinues actuation of the second button.

In an eleventh aspect, which may be combined with the sixth aspect in combination with any other aspect described herein unless specified otherwise, the user input device is at least one of (i) located so as to be actuated by a patient lying in bed, (ii) located so as to be actuated by a non-patient standing next to the bed, (iii) located along a flexible cord, (iv) provided separately as part of a wireless controller, (v) located on the at least one panel, or (vi) located on a user's personal communication device (“PCD”).

In a twelfth aspect, which may be combined with the eleventh aspect in combination with any other aspect described herein unless specified otherwise, the hospital bed includes a plurality of input devices located or provided according to at any two or more of (i) to (vi).

In a thirteenth aspect, which may be combined with any other aspect described herein unless specified otherwise, the at least one selectively expandable side panel includes a first shell that slidingly engages the second shell.

In a fourteenth aspect, which may be combined with the thirteenth aspect in combination with any other aspect described herein unless specified otherwise, the second shell is in mechanical communication with the frame and includes a linear actuator that translates the first shell with respect to the second shell to selectively expand or contract the at least one side panel.

In a fifteenth aspect, which may be combined with the fourteenth aspect in combination with any other aspect described herein unless specified otherwise, the linear actuator includes a motor outputting to a lead screw and a translatable drive arm threadingly engaging the lead screw.

In a sixteenth aspect, which may be combined with the fifteenth aspect in combination with any other aspect described herein unless specified otherwise, the motor and the lead screw are mounted to the second shell, and wherein the drive arm is in mechanical communication with the first shell.

In a seventeenth aspect, which may be combined with the fifteenth aspect in combination with any other aspect described herein unless specified otherwise, the drive arm includes a first portion threadingly engaging the lead screw and a second elongated portion mechanically engaging the first shell.

In an eighteenth aspect, which may be combined with the seventeenth aspect in combination with any other aspect described herein unless specified otherwise, the second elongated portion mechanically engages a top of the first shell.

In a nineteenth aspect, which may be combined with the eighteenth aspect in combination with any other aspect described herein unless specified otherwise, a top of the second elongated portion is mechanically secured to the top of the first shell.

In a twentieth aspect, which may be combined with the fifteenth aspect in combination with any other aspect described herein unless specified otherwise, the motor is mechanically connected to the lead screw via mechanical reduction device.

In a twenty-first aspect, which may be combined with any other aspect described herein unless specified otherwise, the at least one side panel is selectively expandable via a plate located within a shell of the panel, the shell including a slot enabling the plate to move outside of and back into the shell.

In a twenty-second aspect, which may be combined with the twenty-first aspect in combination with any other aspect described herein unless specified otherwise, the hospital bed includes a bellows within the shell and beneath the plate, the bellows selectively expandable via positive pressure and selectively contractible via negative pressure.

In a twenty-third aspect, which may be combined with any other aspect described herein unless specified otherwise, the at least one side panel is selectively expandable via a plate located on an outside surface of the panel, the outside surface including plural slot forming members slideably holding the plate.

In a twenty-fourth aspect, which may be combined with any other aspect described herein unless specified otherwise, the at least one side panel is selectively expandable via an expandable bellows located on a top surface the panel, the bellows optionally selectively expandable via positive pressure and selectively contractible via negative pressure.

In a twenty-fifth aspect, which may be combined with any other aspect described herein unless specified otherwise, the at least one side panel is selectively expandable via a rotatable shell connected hingedly to a lower shell, the lower shell in mechanical communication with the frame.

In a twenty-sixth aspect, which may be combined with any other aspect described herein unless specified otherwise, a hospital bed includes: a frame defining a location to place a mattress; a first side panel in mechanical communication with the frame, the first side panel selectively expandable so as to provide patient privacy when desired and contractible when privacy is not desired; a second side panel in mechanical communication with the frame, the second side panel selectively expandable so as to provide patient privacy when desired and contractible when privacy is not desired; and a control unit programmed to enable the user to expand or contract the first and second side panels separately.

In a twenty-seventh aspect, which may be combined with the twenty-sixth aspect in combination with any other aspect described herein unless specified otherwise, the first and second side panels are disposed on opposing sides of the frame.

In a twenty-eighth aspect, which may be combined with the twenty-sixth aspect in combination with any other aspect described herein unless specified otherwise, the first and second side panels are disposed perpendicular to one another.

In a twenty-ninth aspect, which may be combined with the twenty-sixth aspect in combination with any other aspect described herein unless specified otherwise, the first and second side panels are disposed on a same side of the frame.

In a thirtieth aspect, which may be combined with the twenty-sixth aspect in combination with any other aspect described herein unless specified otherwise, the control unit is further programmed to enable the user to expand or contract the first and second side panels together.

In a thirty-first aspect, which may be combined with the twenty-sixth aspect in combination with any other aspect described herein unless specified otherwise, the hospital bed includes at least one additional side panel that is non-expandable.

In a thirty-second aspect, which may be combined with the thirty-first aspect in combination with any other aspect described herein unless specified otherwise, the first and second selectively expandable side panels and the at least one additional non-expandable side panel are selectively translatable and/or rotatable relative to the frame.

In a thirty-third aspect, which may be combined with any other aspect described herein unless specified otherwise, a portable patient privacy apparatus for a hospital bed or gurney includes: a U-shaped or polygonal-shaped base including a first end and a second end; a correspondingly U-shaped or polygonal-shaped member including a first end mated with the first end of the base and a second end mated with the second end of the base; a hood located between the base and the member, the hood foldable such that when the member is folded against the base, the hood folds onto itself between the member and the base, and when the member is unfolded away from the base with the first ends remaining in a mated relationship and the second ends remaining in a mated relationship, the hood unfolds between the member and the base to provide patient privacy cover; and a structure in mechanical communication with the base configured to discourage the patient privacy apparatus from moving after being placed on the hospital bed or gurney.

In a thirty-fourth aspect, which may be combined with the thirty-third aspect in combination with any other aspect described herein unless specified otherwise, the structure includes at least one of (i) one or more strap in mechanical communication with the base and sized to extend around and secure the apparatus to a mattress supporting the patient, (ii) one or more strap positioned and arranged to secure the base to a head section of the hospital bed or gurney, (iii) a flange extending from the base, the flange providing at least one of weight or friction to stabilize the apparatus when the member is moved with respect to the base, or (iv) a weighted flap attached to the base.

In a thirty-fifth aspect, which may be combined with the thirty-fourth aspect in combination with any other aspect described herein unless specified otherwise, the flange extends perpendicularly from the base.

In a thirty-sixth aspect, which may be combined with the thirty-fourth aspect in combination with any other aspect described herein unless specified otherwise, the flange is curved such that the apparatus rests on one or more peripheral edge of the flange.

In a thirty-seventh aspect, which may be combined with the thirty-fourth aspect in combination with any other aspect described herein unless specified otherwise, the flange is rubber or includes a rubber contacting surface to increase friction.

In a thirty-eighth aspect, which may be combined with the thirty-fourth aspect in combination with any other aspect described herein unless specified otherwise, the flange includes at least one of (i) one or more hook for hooking the apparatus to a side of the hospital bed or gurney for storage, or (ii) a handle or handle cutout for transporting the apparatus.

In a thirty-ninth aspect, which may be combined with the thirty-third aspect in combination with any other aspect described herein unless specified otherwise, the member is a top member, and which includes at least one correspondingly U-shaped or polygonal-shaped intermediate member supporting the hood when the top member is moved with respect to the base.

In a fortieth aspect, which may be combined with the thirty-ninth aspect in combination with any other aspect described herein unless specified otherwise, the at least one intermediate member includes a first end mated with the first ends of the base and top member and a second end mated with a second ends of the base and top member.

In a forty-first aspect, which may be combined with the thirty-third aspect in combination with any other aspect described herein unless specified otherwise, the first ends of the base and top member and the second ends of the base and top member are each mated via a hinged relationship.

In a forty-second aspect, which may be combined with the thirty-third aspect in combination with any other aspect described herein unless specified otherwise, the hood includes an openable hatch for viewing the patient when the member is unfolded from the base.

In a forty-third aspect, which may be combined with the thirty-third aspect in combination with any other aspect described herein unless specified otherwise, the hood is made of a material configured to withstand an antiseptic wash.

In a forty-fourth aspect, which may be combined with any other aspect described herein unless specified otherwise, a hospital bed system includes: a hospital bed including a control unit; and a computer application downloadable to a user's personal communication device (“PCD”), the computer application configured and arranged to operate with the control unit to control at east one function of the hospital bed.

In a forty-fifth aspect, which may be combined with the forty-fourth aspect in combination with any other aspect described herein unless specified otherwise, the bed includes at least one side panel selectively expandable so as to provide patient privacy when desired and contractible when privacy is not desired, and wherein the at least one function of the hospital bed includes a function associated with the at least one selectively expandable side panel.

In a forty-sixth aspect, which may be combined with the forty-fourth aspect in combination with any other aspect described herein unless specified otherwise, the hospital bed system includes a protocol for associating the computer application on the user's PCD with the hospital bed.

In a forty-seventh aspect, which may be combined with the forty-sixth aspect in combination with any other aspect described herein unless specified otherwise, the hospital bed system includes a server computer, wherein the computer application is in wireless communication with the server computer to send bed usage data to the server computer.

In a forty-eighth aspect, which may be combined with the forty-seventh aspect in combination with any other aspect described herein unless specified otherwise, the hospital bed includes at least one side panel selectively expandable so as to provide patient privacy when desired and contractible when privacy is not desired, the bed usage data concerning the at least one selectively expandable side panel.

In a forty-ninth aspect, which may be combined with the forty-fourth aspect in combination with any other aspect described herein unless specified otherwise, the hospital bed system includes a server computer, wherein the control unit is in wired or wireless communication with the server computer to send bed usage data to the server computer.

In a fiftieth aspect, which may be combined with the forty-ninth aspect in combination with any other aspect described herein unless specified otherwise, the hospital bed includes at least one side panel selectively expandable so as to provide patient privacy when desired and contractible when privacy is not desired, the bed usage data concerning the at least one selectively expandable side panel.

In a fifty-first aspect, which may be combined with any other aspect described herein unless specified otherwise, a gurney includes: a collapsible frame assembly; and a hood assembly including (i) a polygonal-shaped base member including a first end and a second end, (ii) a correspondingly polygonal-shaped outer member including a first end and a second end, (iii) a hood located between the base member and the outer member, the hood foldable such that when the outer member is folded against the base member, the hood folds onto itself between the outer member and the base member, and when the outer member is unfolded away from the base member with the first ends remaining in a mated relationship and the second ends remaining in a mated relationship, the hood unfolds between the outer member and the base member to provide patient privacy cover, (iii) a first hinge connected to the first end of the base member, the first end of the outer member and the collapsible frame, and (iv) a second hinge connected to the second end of the base member, the second end of the outer member and the collapsible frame.

In a fifty-second aspect, which may be combined with the fifty-first aspect in combination with any other aspect listed herein unless specified otherwise, at least one of the first or second hinge includes (i) an upper portion connected to the at least one of the first or second end of the base member, the at least one of the first or second end of the outer member and (ii) a lower portion connected to the collapsible frame.

In a fifty-third aspect, which may be combined with the fifty-first aspect in combination with any other aspect listed herein unless specified otherwise, the frame assembly includes an upper frame and a lower frame, and wherein the first and second hinges are connected to the upper frame.

In a fifty-fourth aspect, which may be combined with the fifty-first aspect in combination with any other aspect listed herein unless specified otherwise, the frame assembly includes first and second side members, and wherein the first hinge is connected to the first side member and the second hinge is connected to the second side member.

In a fifty-fifth aspect, which may be combined with the fifty-fourth aspect in combination with any other aspect listed herein unless specified otherwise, at least one of the first hinge is fastened to the first side member or the second hinge is fastened to the second side member.

In a fifty-sixth aspect, which may be combined with the fifty-fifth aspect in combination with any other aspect listed herein unless specified otherwise, the at least one first or second hinge includes (i) an upper portion connected to the at least one first or second end of the base member and the at least one first or second end of the outer member and (ii) a lower portion fastened to the first or second side member.

In a fifty-seventh aspect, which may be combined with the fifty-fifth aspect in combination with any other aspect listed herein unless specified otherwise, the at least one first or second side member is deformed at a location where at least one of the first hinge is fastened to the first side member or the second hinge fastened to the second side member.

In a fifty-eighth aspect, which may be combined with the fifty-fourth aspect in combination with any other aspect listed herein unless specified otherwise, at least one of the first hinge includes first and second halves fastened together to compress onto the first side member or the second hinge includes first and second halves fastened together to compress onto the second side member.

In a fifty-ninth aspect, which may be combined with the fifty-eighth aspect in combination with any other aspect listed herein unless specified otherwise, the at least one first or second hinge includes (i) an upper portion connected to the at least one first or second end of the base member and the at least one first or second end of the outer member and (ii) a lower portion compressed onto the first or second side member.

In a sixtieth aspect, which may be combined with the fifty-eighth aspect in combination with any other aspect listed herein unless specified otherwise, the at least one first or second side member is deformed at a location where at least one of the first hinge is compressed onto the first side member or the second hinge is compressed onto the second side member.

In a sixty-first aspect, which may be combined with the fifty-first aspect in combination with any other aspect listed herein unless specified otherwise, the polygonal-shaped base member of the hood assembly is part of the collapsible frame.

In a sixty-second aspect, which may be combined with the fifty-first aspect in combination with any other aspect listed herein unless specified otherwise, the polygonal-shaped base member of the hood assembly is connected in at least one location to the collapsible frame in addition to connections provided via the first and second hinges.

In a sixty-third aspect, which may be combined with the fifty-first aspect in combination with any other aspect listed herein unless specified otherwise, the hood assembly includes at least one correspondingly polygonal-shaped intermediate member supporting the hood when the outer member is moved with respect to the base member.

In a sixty-fourth aspect, which may be combined with the sixty-third aspect in combination with any other aspect listed herein unless specified otherwise, the at least one intermediate member includes a first end mated with the first ends of the base member and the outer member and a second end mated with the second ends of the base member and the outer member.

In a sixty-fifth aspect, which may be combined with the fifty-first aspect in combination with any other aspect listed herein unless specified otherwise, the hood includes an openable hatch for viewing the patient when the outer member is unfolded from the base member.

In a sixty-sixth aspect, any of the structure, functionality and alternatives discussed in connection with any one of FIGS. 1 to 25 may be combined with any of the structure, functionality and alternatives discussed in connection with any other one or more of FIGS. 1 to 25.

In light of the above discussion and aspects of the present disclosure, it is accordingly an advantage of the present disclosure to provide improved patient privacy.

It is another advantage of the present disclosure to provide in one primary embodiment a hospital bed with expandable privacy panels that operate automatically upon an operator button press.

It is a further advantage of the present disclosure to provide a hospital bed with expandable privacy panels that are integrated within the other structure of the hospital bed.

It is yet another advantage of the present disclosure to provide a hospital bed with expandable privacy panels that are integrated within the other structure of the hospital bed.

It is yet a further advantage of the present disclosure to provide a hospital bed with expandable privacy panels that are selectively actuated.

It is still another advantage of the present disclosure to provide a hospital bed with expandable privacy panels that may be moved individually or collective.

It is still a further advantage of the present disclosure to provide a hospital bed with expandable privacy panels that may be translated or rotated in addition to being expanded.

Moreover, it is an advantage of the present disclosure to provide in another primary embodiment a portable patient privacy apparatus that may be selectively placed on a hospital bed or gurney.

It is another advantage of the present disclosure to provide a portable patient privacy apparatus that may be stored on a side of or inside of a hospital bed or gurney.

It is a further advantage of the present disclosure to provide a portable patient privacy apparatus that does not require electrical power.

It is yet another advantage of the present disclosure to provide a portable patient privacy apparatus that is easy to unfold and refold.

It is yet a further advantage of the present disclosure to provide a portable patient privacy apparatus that stays in place even if the head portion of the bed or gurney is raised.

The advantages discussed herein may be found in one, or some, and perhaps not all of the embodiments disclosed herein. Additional features and advantages are described herein, and will be apparent from the following Detailed Description and the figures.

### BRIEF DESCRIPTION OF THE FIGURES

FIG. 1 is a perspective view illustrating one embodiment of a hospital bed of the present disclosure with patient privacy panels in a non-expanded state.

FIG. 2 is a perspective view illustrating one embodiment of a hospital bed of the present disclosure with multiple patient privacy panels in an expanded state.

FIG. 3 is a side elevation view illustrating one embodiment of a frame of a hospital bed of the present disclosure with various patient privacy panels in a lowered and non-expanded state attached thereto, e.g., for a patient to get into or get out of the hospital bed.

FIG. 4 is a side elevation view illustrating one embodiment of a frame of a hospital bed of the present disclosure with various patient privacy panels in a raised and non-expanded state attached thereto, e.g., for a patient currently lying in the bed.

FIG. 5 is a side elevation view illustrating one embodiment of a frame of a hospital bed of the present disclosure with various patient privacy panels in a raised and expanded state attached thereto, e.g., for a patient currently lying in the bed and desiring patient privacy.

FIG. 6A is a side elevation view illustrating a frame of a hospital bed of the present disclosure and one embodiment for mechanically coupling the patient privacy panels to the frame.

FIG. 6B is a side elevation view illustrating a frame of a hospital bed of the present disclosure and various additional embodiments for mechanically coupling the patient privacy panels to the frame.

FIGS. 7A to 7D illustrate the hospital bed of FIGS. 1 to 6B in various states of patient privacy and showing other alternative embodiments.

FIG. 8A is a sectioned side elevation view illustrating one embodiment for the expanding and contracting patient privacy panels of the present disclosure in a fully contracted state.

FIG. 8B is a sectioned side elevation view illustrating one embodiment for the expanding and contracting patient privacy panels of the present disclosure in a fully expanded state.

FIG. 9 is a perspective view of one embodiment of a linear actuation assembly used with the expanding and contracting patient privacy panels of FIGS. 8A and 8B.

FIG. 10A is a top plan view illustrating one embodiment for a master user input device for controlling each of the expandable patient privacy panels of the present disclosure.

FIG. 10B is a top plan view illustrating one embodiment for an individual panel user input device for controlling a single one of the expandable patient privacy panels of the present disclosure.

FIG. 11A is a schematic view of one embodiment for networking beds having the patient privacy panels of the present disclosure with one or more server computer.

FIG. 11B is a schematic view of another embodiment for networking beds having the patient privacy panels of the present disclosure with one or more server computer.

FIGS. 12 to 14 are perspective and sectioned views a first alternative embodiment of an expandable panel for a hospital bed of the present disclosure.

FIG. 15 is a perspective view of a second alternative embodiment of an expandable panel for a hospital bed of the present disclosure.

FIG. 16 is a perspective view of a third alternative embodiment of an expandable panel for a hospital bed of the present disclosure.

FIG. 17 is a side elevation view of a fourth alternative embodiment of an expandable panel for a hospital bed of the present disclosure.

FIG. 18 is a perspective of one embodiment for a manually actuated portable patient privacy apparatus of the present disclosure in a fully folded state.

FIG. 19 is a perspective of the embodiment for the manually actuated portable patient privacy apparatus of FIG. 18 in a fully unfolded state.

FIGS. 20A and 20B are perspective views of another embodiment for a manually actuated portable patient privacy apparatus of the present disclosure in a fully folded state.

FIGS. 21A and 21B are perspective views of a further embodiment for a manually actuated portable patient privacy apparatus of the present disclosure in a fully folded state.

FIG. 22 is a side elevation section view of one embodiment of a hinge section for any of the portable patient privacy apparatuses of the present disclosure.

FIGS. 23 and 24 are perspective views of one embodiment of a gurney having a built-in or connected hood providing selective patient privacy, wherein FIG. 23 illustrates the hood in a folded state or condition, while FIG. 24 illustrates the hood in an unfolded state or condition.

FIG. 25 is a sectioned perspective view of one embodiment of a hinge for the built-in or connected hood of the gurney of FIGS. 23 and 24.

### DETAILED DESCRIPTION

### Automated Bed

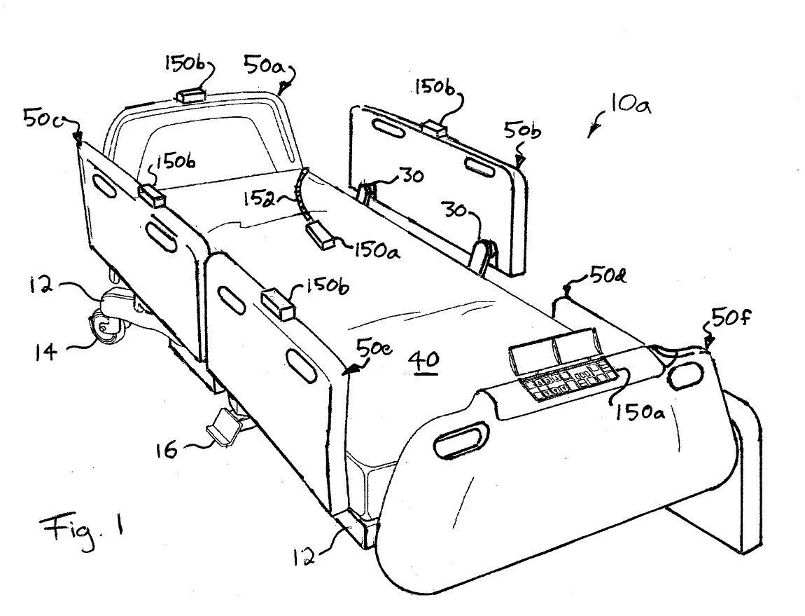

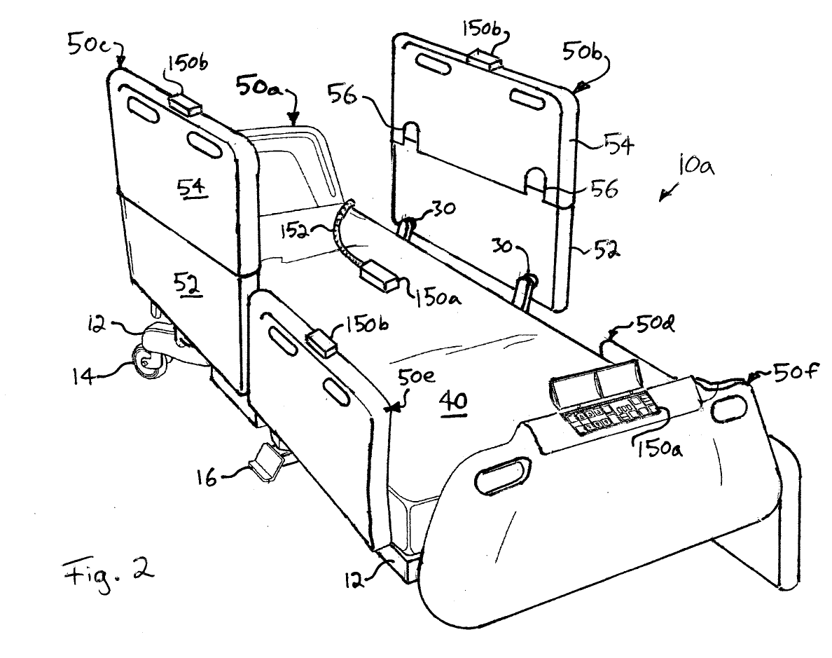

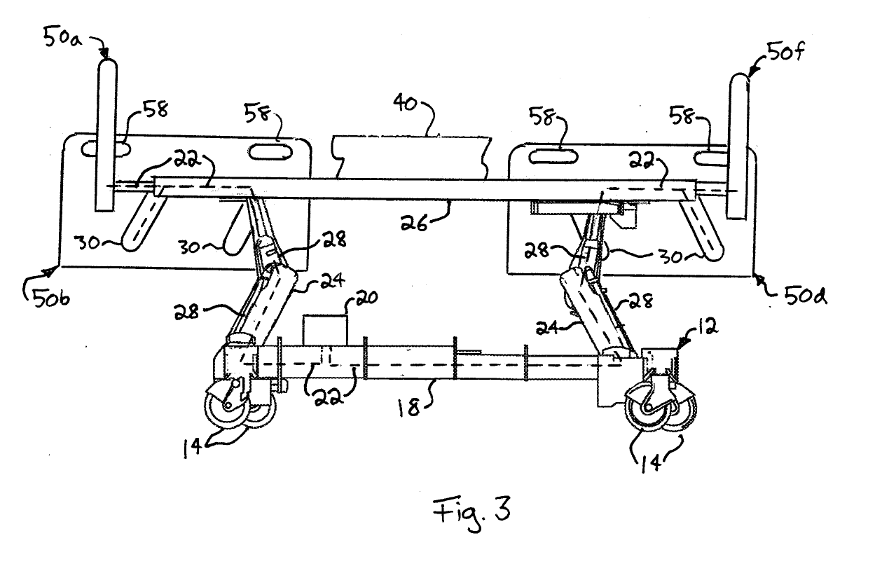

Referring now to the drawings and in particular to FIGS. 1 and 2, one embodiment of a hospital bed 10a having selectively actuated patient privacy panels of the present disclosure is illustrated. Hospital bed 10a includes a frame 12 upon which is placed a mattress 40. Frame 12 in the illustrated embodiment is fastened to plural spinning wheels 14, enabling bed 10a to be wheeled in and out of rooms and along hallways of a hospital or other caregiving center. FIG. 1 illustrates that frame may operate with one or more foot pedal 16, which enables a nurse or other caregiver to releasably lock hospital bed 10a in place at a desired location. Frame 12 is discussed in more detail in connection with FIGS. 3 to 5.

Hospital bed 10a of the present disclosure includes one or more expandable and contractible panels 50a to 50f (referred to herein collectively as panels 50 or generally individually as panel 50. Hospital bed may only provide a single expandable panel 50, may make all panels 50a to 50e expandable and contractible, or may provide a mix of expandable and non-expandable panels (e.g., upper three panels 50a, 50b, 50c and foot panel 50f being expandable and contractible, while the remaining panels covering by the patient's legs are not expandable. For purposes of illustration, all six side panels 50a to 50f are expandable and contractible. As used herein, the term “side panels” includes head panel 50a and foot panel 50f in addition to the two left (in relation to patient lying in bed) side panels 50b and 50d and the two right (in relation to patient lying in bed) side panels 50c and 50e.

FIG. 1 illustrates all six side panels 50a to 50f in a fully contracted or non-expanded state. Panels 50a, 50b, 50c, 50e and 50f are in a raised state, while panel 50d is in a lowered state. Panels 50a, 50b, 50c, 50e and 50f in the raised state protect the patient and enable a nurse or caregiver to grasp and move bed 10a via the handles of the panels. Panel 50d in the lowered state enables the patient to get into and out of bed 10a. For example, in FIG. 1, if the patient wants to get into or out of their left side of bed 10a, panel 50b may be lowered in addition to already lowered panel 50d, so that the patient may easily do so. When lowered, the top of panels 50a to 50f is flush with or below the top of mattress 40.

In an embodiment, panels 50a to 50f may each be raised and lowered. Alternatively, only panels 50b, 50c, 50d and 50e may be raised and lowered since head panel 50a and foot panel 50f do not need to be lowered for the patient to get into or out of bed 10a. Head panel 50a and foot panel 50f here are accordingly in a permanently raised state or condition. In the embodiments illustrated below, panels 50 are manually raised and lowered; however, it is also contemplated to automate the raising and lowering of the panels. As shown below, the raising and lowering may be done rotationally, translationally, or rotationally and translationally. It should be appreciated that the raising and lowering of panels 50 is different than and independent from the expansion and contraction of the panels as described herein.

FIGS. 1 and 2 illustrate that panels 50 are connected to frame 12 via mounts 30, e.g., via two mounts per panel 50. Mounts 30 are the devices that rotate and/or translate, so that panels 50 may be raised and lowered as just described. FIGS. 1 and 2 illustrate an embodiment in which mounts 30 connect to an inner wall of a lower shell 52 of each expandable panel 50. An upper shell 54 fits snugly over lower shell 52 of each expandable panel 50. Upper shell 54 is provided with cutouts 56 that fit around the connection of mounts 30 to inner shell when upper shell 54 is retracted down over lower shell 52.

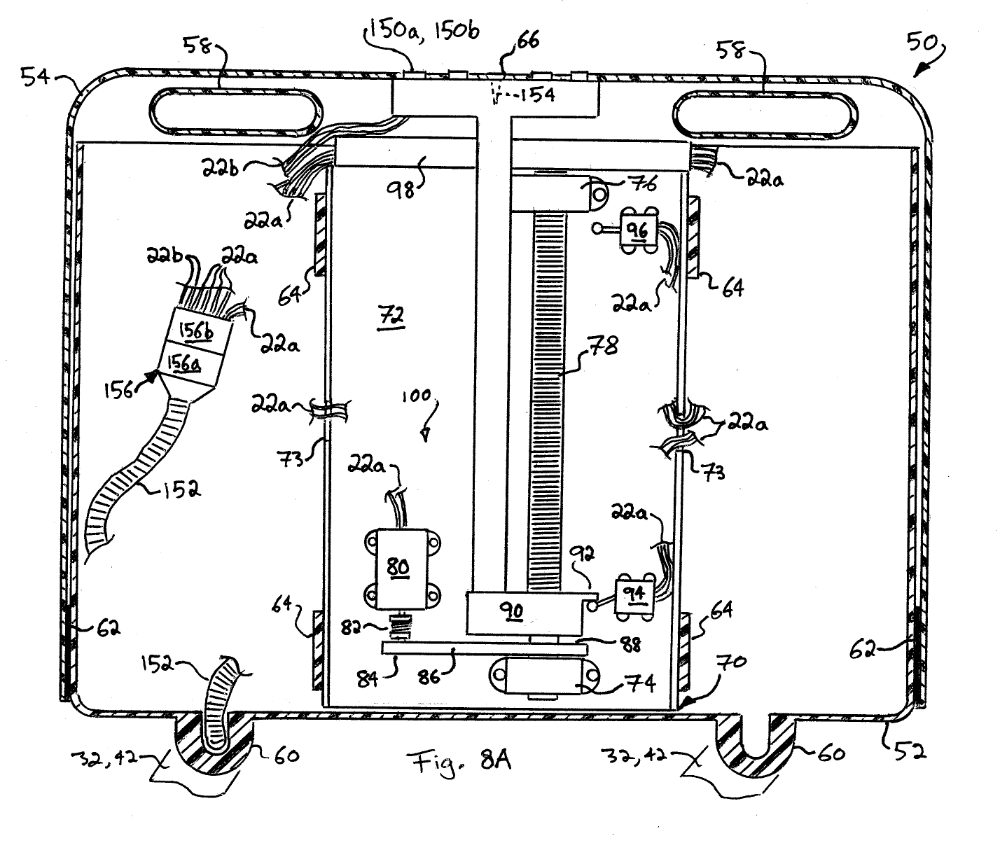

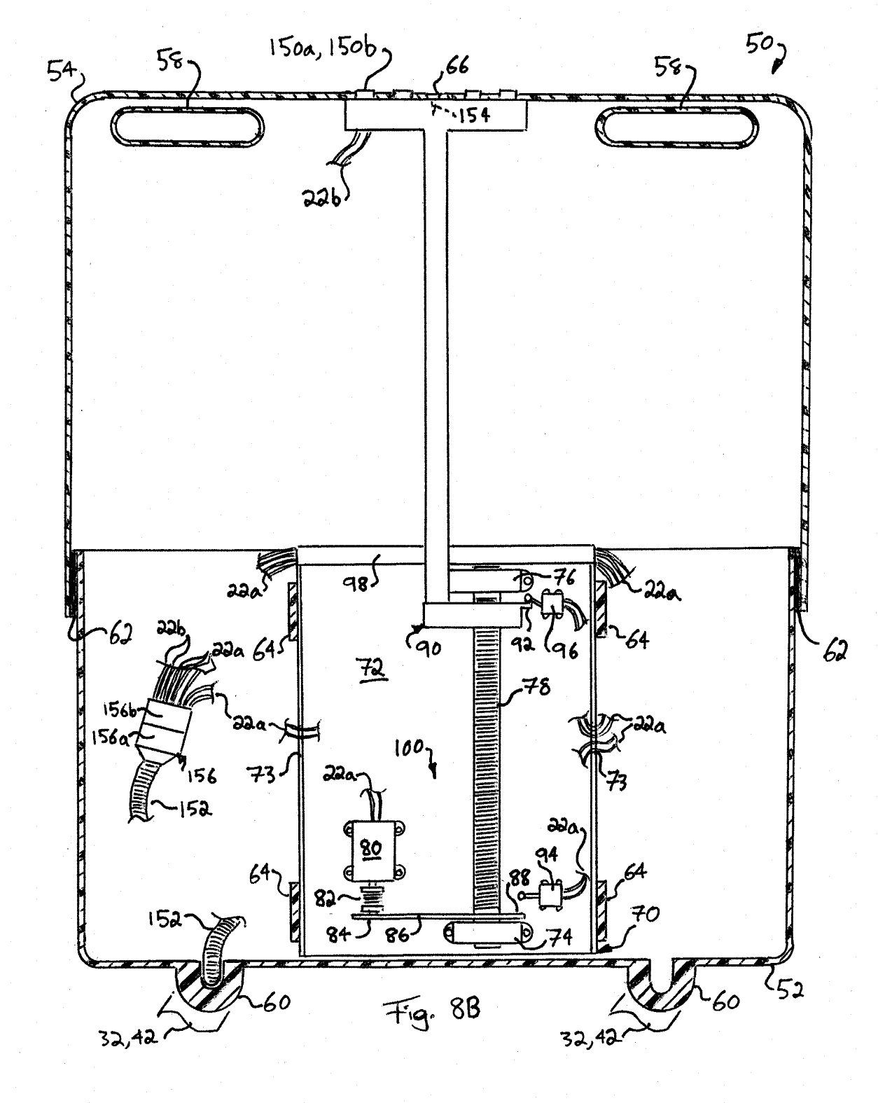

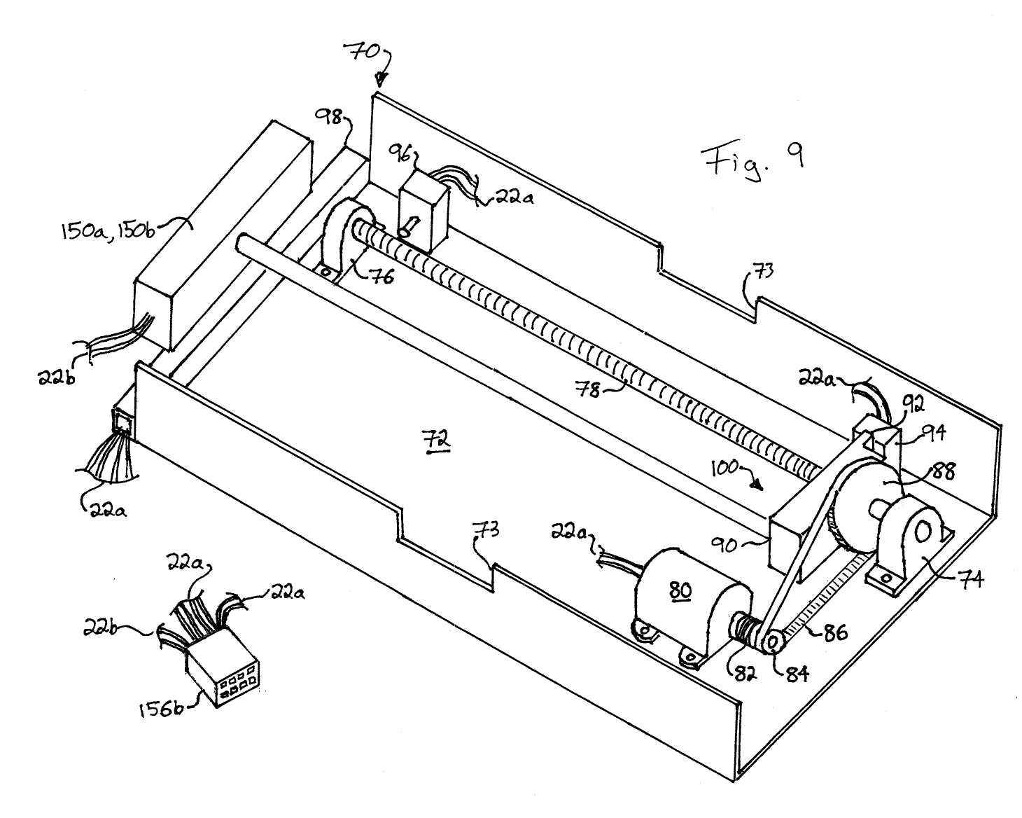

FIG. 2 illustrates expandable side panels 50b and 50c in a fully expanded state. Here, the appreciable amount of privacy blocking that expanded panels 50a to 50f provide is illustrated. A patient left in bed 10a in a hallway of a hospital, for example a patient recovering from surgery, may be shielded from others passing in the hallway, allowing the patient to rest peacefully and in private. Or, a patient in bed 10a in his or her hospital room shared with another patient may selectively expand anyone or more of panels 50a to 50f when, for example, the patient roommate's family or friends come to visit. Panels 50a to 50f may each be selectively expended and contracted to any desired position between fully expanded and fully contracted as explained in detail below in connection with FIGS. 8 and 9. For example, panels 50a to 50f may be selectively expanded as needed to block sun from a window from bothering the patient or placing a glare on a television.

FIGS. 1 and 2 also illustrate various user control options. A master user input device 150a may be, for example, tethered to be via a flexible electrical conduit 152. Master user input device 150a may alternatively or additionally be panel mounted to one or more or all of expandable panels 50, e.g., to foot panel 50f. Master user input device 150a may further alternatively or additionally be in wireless communication with control unit of bed 10a, e.g., via Bluetooth™ WiFi™ Zigbee®, Z-Wave®, wireless Universal Serial Bus (“USB”), infrared, nearfield communication (“NFC”) or any other suitable wireless communication technology. Master user input device 150a may further alternatively or additionally be provided as a software application (“app”) downloadable to a user's smartphone, wherein the app is configured to sync with the controller of bed 10a when the smartphone is placed within a few feet from the control unit.

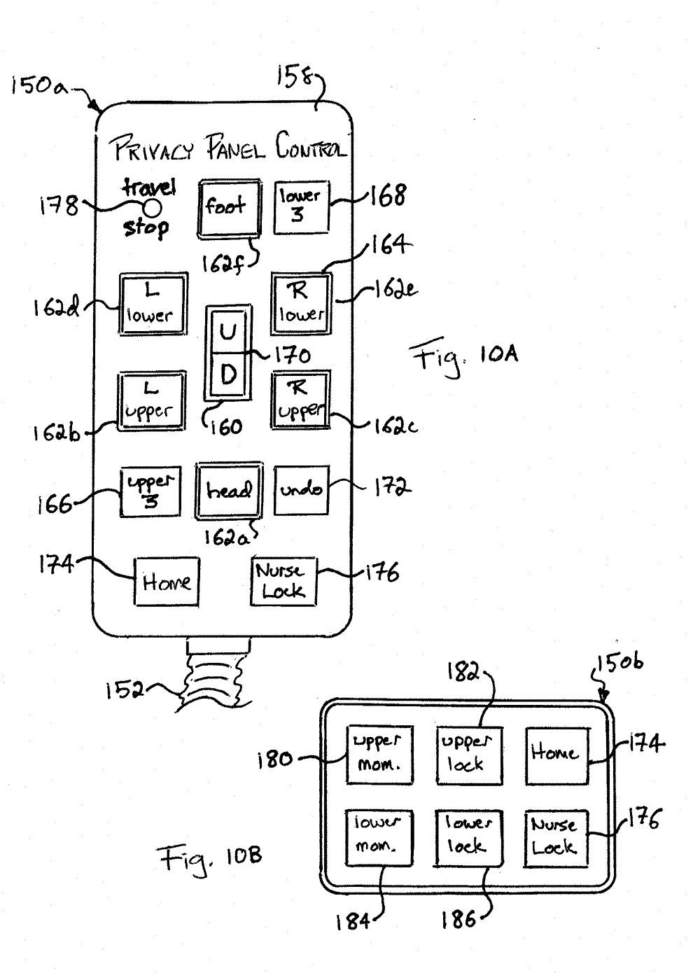

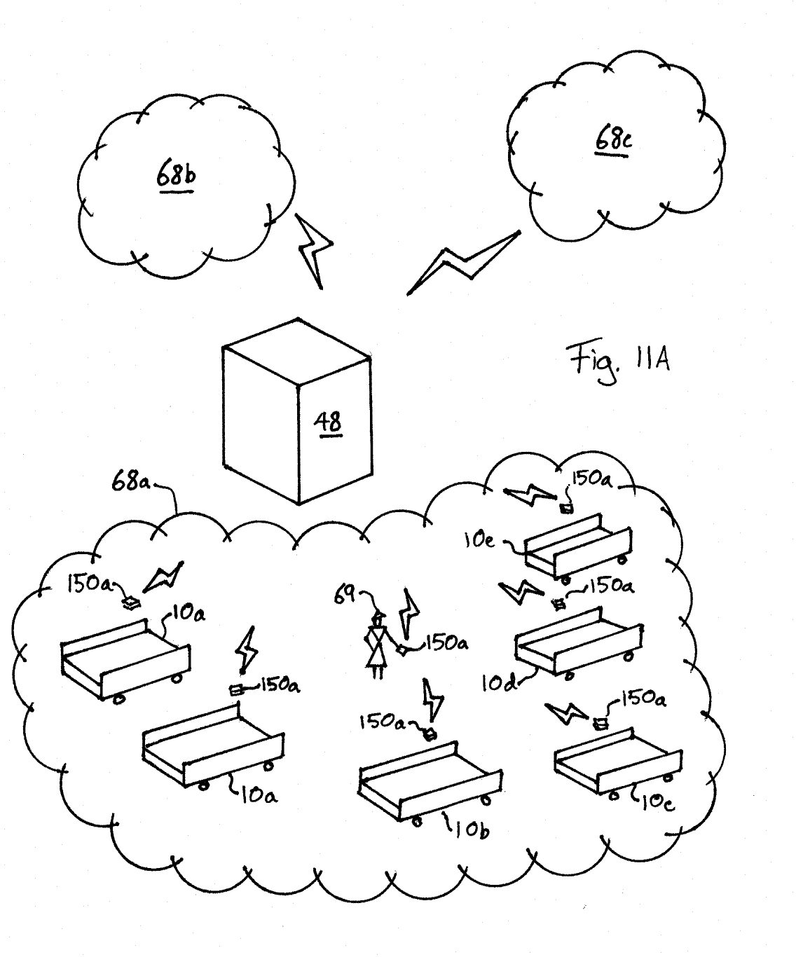

Master user input device 150a enables selective control of all panels 50a to 50f and groups of same in various embodiments. Master user input device 150a is explained in more detail in connection with FIG. 10A. An individual panel user interface device 150b may be provided alternatively or additionally. In FIGS. 1 and 2, an individual panel user interface device 150b is mounted to panels 50b, 50c, 50d and 50e. Individual panel user interface device 150b provides various motion control options for a single panel 50 and is described in detail below in connection with FIG. 10B. Individual panel user interface device 150b is best suited to be panel mounted to its respective panel, but device 150b could be provided alternatively or additionally in any of the configurations described above for master user input device 150a.

Referring now to FIGS. 3 to 5, the connection of panels 50 to frame 12 and the various physical states of the panels are illustrated in more detail. In the illustrated embodiment, frame 12 is placed on wheels 14 as discussed above, so that bed 10a may be moved to a desired location. Frame 12 includes cross-beams 18 to which wheels 14 are spinnably attached. Cross-beams 18 in the illustrated embodiment support a control unit 20, which controls all electromechanical, pneumatic, and/or oil pressure forms of motion that bed 10a provides. For example, legs 24 that connect to cross-beams 18 and to a mattress platform 26 may be provided with pneumatic or oil pressure piston-cylinders 28 that are controlled via control unit 20 to unfold or fold the legs 24 as desired to place mattress platform 26 and thus mattress 40 in a desired position, e.g., so that the patient may lie down flat for sleeping or sit up to eat, watch television, etc.

In the illustrated embodiment, wiring 22 runs from control unit 20 inside one or more cross-beams 18 and legs 24 to mattress platform 26. Wiring 22 runs within mattress platform into one of the mounts 30 of each expandable side panel 50. Wiring 22 runs within mounts 30 into panels 50 where it connects to various electrically operated components of panels 50 discussed in detail below in connection with FIGS. 8 and 9. Wiring 22 is accordingly completely or virtually completely hidden from view in one embodiment.

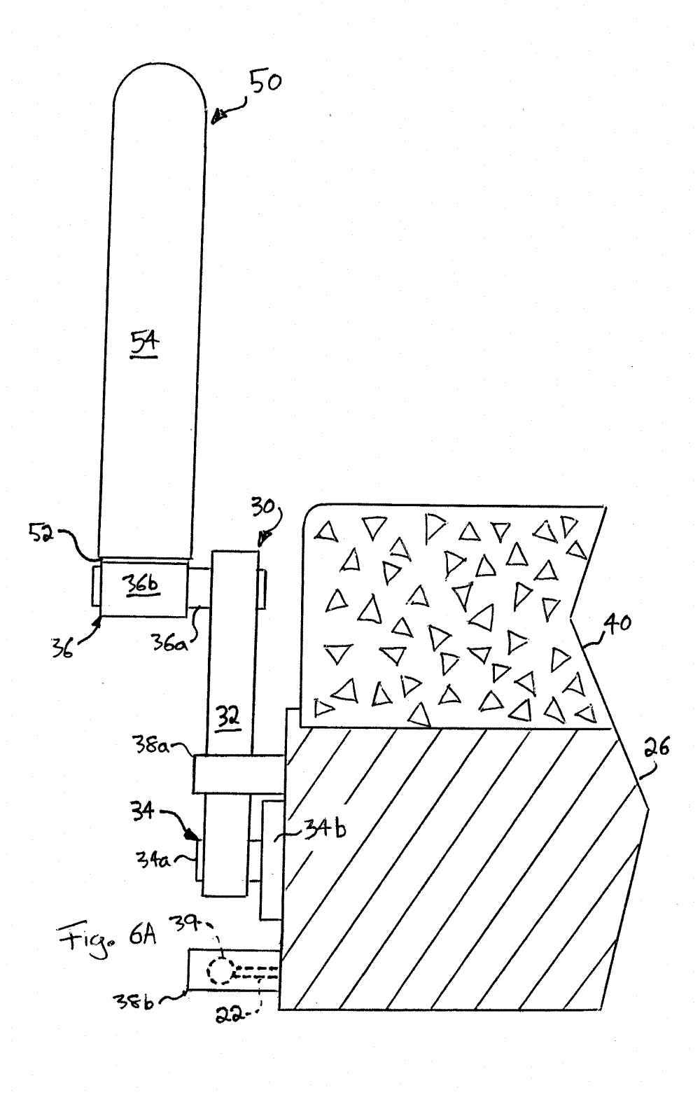

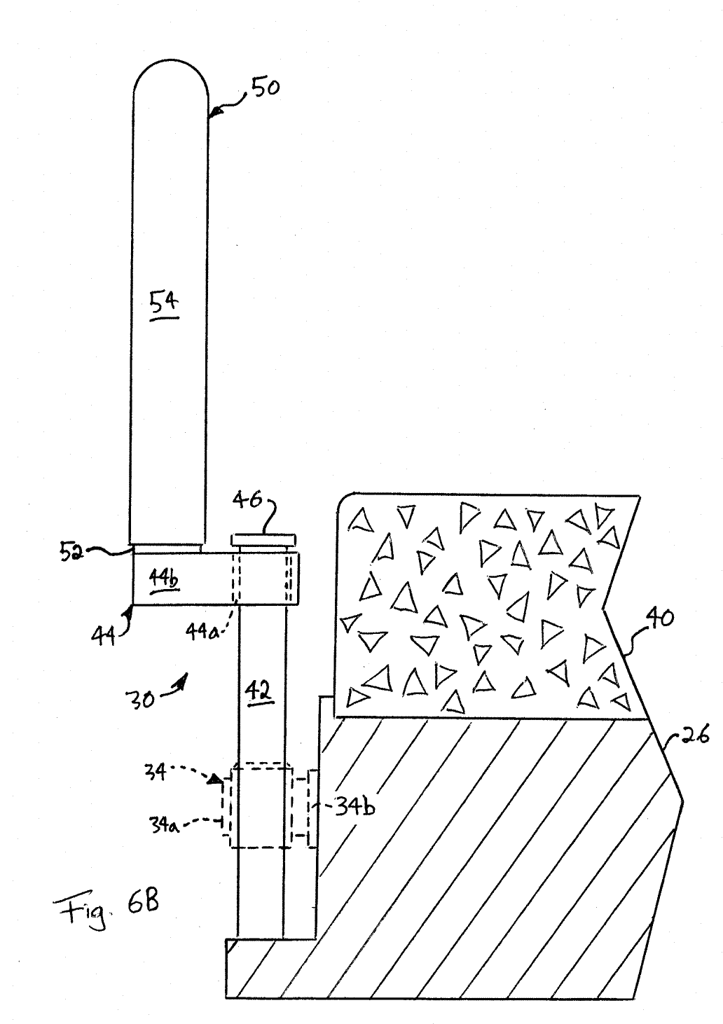

FIGS. 3 to 5 illustrate one embodiment in which expandable side panels 50b, 50c, 50d and 50e are rotated to achieve the patient bed-entry and bed-exit state versus the patient in-bed state, which is discussed in more detail in connection with FIG. 6A. Alternatively or additionally, expandable side panels 50b, 50c, 50d and 50e are translated down and up to achieve the patient bed-entry and bed-exit state and the patient in bed-state, respectively, described in detail in connection with FIG. 6B. In the illustrated embodiment, head expandable panel 50a and foot expandable panel 50f are not placed in the patient bed-entry and bed-exit state and instead reside only in the patient in-bed state. Alternatively, head expandable panel 50a and foot expandable panel 50f are likewise able to be placed in the patient bed-entry and bed-exit state via any of the structures and procedures discussed herein.

In FIG. 3, expandable side panels 50b, 50c, 50d and 50e are each rotated out and down to achieve the patient bed-entry and bed-exit state. In particular, expandable side panels 50b and 50d are rotated away from each other and downwardly, as illustrated, while expandable side panels 50c and 50e are rotated away from each other and downwardly to achieve the patient bed-entry and bed-exit state of FIG. 3. To do so, mounts 30 are each rotatably coupled to both side panels 50b, 50c, 50d and 50e and to mattress platform 26 or some other sturdy portion of frame 12. From the viewpoint illustrated in FIG. 3, mounts 30 of panel 50b are rotated in a counterclockwise manner about the axis of the rotatable connection of members 30 to frame 12 until the members hit a hardstop provided by frame 12, e.g., mattress platform 26. At this point, the top of panel 50b is flush with or below the top of mattress 40 to allow for easy patient bed entry or exit. From the viewpoint illustrated in FIG. 3, mounts 30 of panel 50d are rotated in a clockwise manner about the axis of the rotatable connection of members 30 to frame 12 until the members hit a hardstop provided by frame 12, e.g., mattress platform 26. At this point, the top of panel 50d is flush with or below the top of mattress 40 to allow for easy patient bed entry or exit. The same occurs for panels 50c and 50e. Handles 58 provided with each of panels 50b, 50c, 50d and 50e are useful for rotating the panels into the patient bed-entry and bed-exit state of FIG. 3.

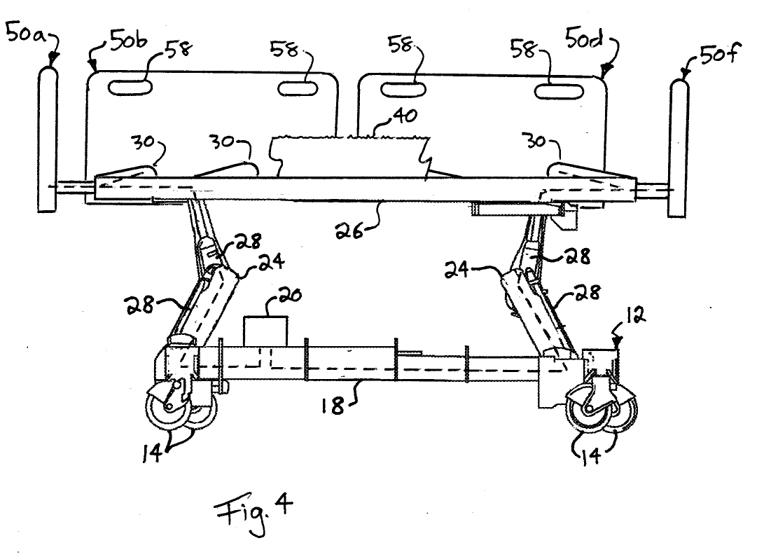

In FIG. 4, expandable side panels 50b, 50c, 50d and 50e are each rotated in and up to achieve the patient in-bed state. In particular, expandable side panels 50b and 50d are rotated towards each other and upwardly, as illustrated, while expandable side panels 50c and 50e are rotated towards each other and upwardly to achieve the patient in-bed state of FIG. 4. As before, mounts 30 are each rotatably coupled to both side panels 50b, 50c, 50d and 50e and to mattress platform 26 or some other sturdy portion of frame 12. From the viewpoint illustrated in FIG. 4, mounts 30 of panel 50b are rotated in a clockwise manner about the axis of the rotatable connection of members 30 to frame 12 until the members hit a hardstop provided by frame 12, e.g., mattress platform 26. At this point, the top of panel 50b is above the top of mattress 40 to help keep the patient in bed 10a from falling out. From the viewpoint illustrated in FIG. 3, mounts 30 of panel 50d are rotated in a counterclockwise manner about the axis of the rotatable connection of members 30 to frame 12 until the members hit a hardstop provided by frame 12, e.g., mattress platform 26. At this point, the top of panel 50d is above the top of mattress 40 to help keep the patient in bed 10a from falling out. Handles 58 provided with each of panels 50b, 50c, 50d and 50e are useful for rotating the panels into the patient in-bed state of FIG. 4.

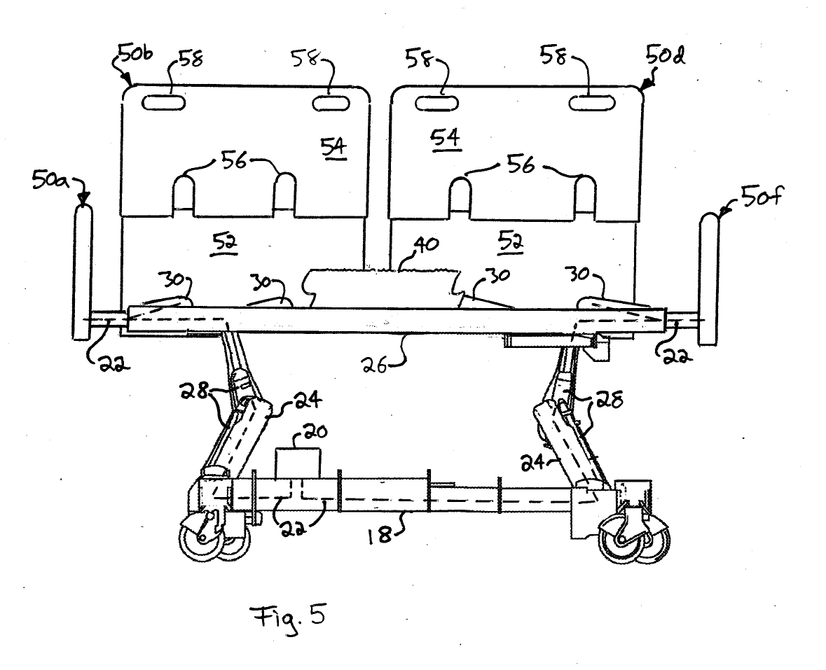

In FIGS. 3 and 4 none of expandable panels 50a, 50b, 50d or 50f is expanded, each are instead fully contracted. In FIG. 5, the patient, nurse or caregiver has decided that to provide patient privacy and has expanded panels 50b and 50d, e.g., via user input device 150a or 150b. Panels 50c and 50e not illustrated in FIG. 5 could likewise be selectively expanded to provide additional patient privacy. While FIG. 5 illustrates panels 50b and 50d expanded while in the patient in-bed state of FIG. 4, it is contemplated to also allow any of panels 50 to be expanded or contracted while in the patient bed-entry and bed-entry/exit state of FIG. 3. For example, a sensor, e.g., limit switch or proximity switch, may be provided that detects when either one or both of members 30 associated with a panel 50 have reached the hardstop provided by frame 12, e.g., mattress platform 26, for the bed-entry and bed-entry/exit state of FIG. 3. Upon such a detection, an output signal is sent from the sensor to control unit 20, which automatically attempts to fully contract the panel. Thus, if the panel 50 is at all expanded, it is automatically contracted when the panel is placed in the bed-entry and bed-entry/exit state of FIG. 3, so that the top of the panel resides desirably flush with or below the top of mattress 40.

FIG. 5 illustrates that upper shell 54 defines or includes cutouts 56 that fit around the attachment of mounts 30 to frame 12 of bed 10a to an inner surface of lower shell 52 of panel 50. FIGS. 6A and 6B illustrate an alternative embodiment in which mounts 30 mount to an underside of lower shells 52 of panels 50, so that cutouts 56 in upper shell 54 are not needed. FIG. 6A illustrates one configuration for the rotating mount 30 described in connection with FIGS. 3 to 5. The example of FIG. 6A illustrates mattress 40 resting upon mattress platform 26 of frame 12. Mount 30 includes a member 32 connected at its bottom end to a frame bearing 34. Frame bearing 34 includes a first portion 34a that attaches fixedly to member 32 and attaches rotatably to second portion 34b of frame bearing 34, which in turn attaches fixedly to mattress platform 26. First portion 34a and second portion 34b of frame bearing 34 may be coupled rotatably to each other via ball bearings or roller bearings, for example. Member 32 is likewise connected at its top end to a panel bearing 36. Panel bearing 36 includes a first portion 36a that attaches fixedly to an upper end of member 32 and attaches rotatably to second portion 36b of panel bearing 36, which in turn attaches fixedly to panel 50. First portion 36a and second portion 36b of panel bearing 34 may also be coupled rotatably to each other via ball bearings or roller bearings, for example.

FIG. 6A illustrates a first hardstop 38a, which extends from mattress platform 26 and catches mount 30 when the mount is rotated up (out from the page) and into the patient in-bed state of FIG. 4. A second hardstop 38b also extends from mattress platform 26 and catches mount 30 when the mount is rotated down (into the page) into the patient bed-entry and bed-entry/exit state of FIG. 3. As discussed above, second hardstop 38b may be provided with an electrical contact switch or other type of sensor 39 that sends a signal via electrical wires 22 when panel 50 reaches the patient bed-entry and bed-entry/exit state of FIG. 3 to control unit 20, which is programmed to automatically attempt to contract the panel in case it is at all expanded, so that the panel is not in the patient's way when trying to get into or out of bed 10a.

All components of mounts 30 of FIGS. 6A and 6B may be made of metal, such as any one or more of steel, stainless steel, aluminum, and alloys thereof. Any one or more component of mount 30 may be made, e.g., molded, alternatively of a rugged plastic, such as teflon. FIG. 6B illustrates various configurations for a translating mount 30 or a mount 30 the both rotates and translates. The example of FIG. 6B illustrates mattress 40 resting upon mattress platform 26 of frame 12. Mount 30 includes a shaft 42 connected at its bottom end to mattress platform 26 or other portion of frame 12. Shaft 42 in an embodiment is round and accepts an arm 44, which includes a sliding seal 44a, such as plastic or rubber collar having a coefficient of friction selected to allow panel 50 to be moved manually up and down along shaft 42, while holding panel 50 in place at a desired position. Pushing arm 44 all the way down shaft 42 places the top of panel 50 flush or below the top of mattress assuming panel 50 is retracted fully.

The distal end 44b of arm 44 is attached to the bottom of lower shell 52 as illustrated in FIG. 6B. The top of shaft 42 may have a larger diameter cap 46 as illustrated to prevent panel 50 from being removed completely from members 30 by accident. As shown in phantom line, the frame bearing arrangement 34 of FIG. 6A may be added to the shaft 42 of FIG. 6B to provide a combined rotated and translated procedure for moving panels 50 between the patient bed-entry and bed-exit state of FIG. 3 and the patient in-bed state of FIG. 4. Although not illustrated in FIG. 6B, to add rotation, arm 44 would also be modified to have the panel bearing arrangement 36 of FIG. 6A, so that shaft 42 rotates relative to mattress platform 26 or frame 12, while panel rotates relative to the shafts 42 of the multiple members 30 supporting the panel.

Viewing FIG. 3 for example, it is contemplated to rotatably connect lower shell 52 to the outside members 30 (through which wiring 22 extends into panels 50) and to removeably connect lower shell 52, e.g., via a removeable safety pin, to inside members 30 (through which wiring 22 does not extend into panels 50). In FIG. 6A, for example, lower panel 52 via first portion of panel bearing 36a may be rotatably connected to member 30 if member 30 is the outer member or removeably connected to member 30 via a removeably safety pin (not illustrated) if member 30 is the inner member. Alternatively in FIG. 6A, lower panel 52 via second portion of panel bearing 36b may be rotatably connected to first portion of panel bearing 36a if member 30 is the outer member or removeably connected to first portion of panel bearing 36b via a removeably safety pin (not illustrated) if member 30 is the inner member.

Regardless of which structure described above is used, if any of panels 50 should become stuck in its expanded position, e.g., the position of FIG. 8B, that panel 50 may be moved out of the way by (i) removing the safety pin from the connection between lower shell 52 and inner member 30, so that lower shell 52, and thus the corresponding panel 50, may come free from inner member 30, and (ii) rotate the panel away from mattress 40 about the rotatable connection to outer member 30, enabling the patient to exit bed 10a. In FIG. 3, for example, head-end side panel 50b would be rotated counterclockwise about the rotatable connection to its outside member 30 if stuck in its expanded position. Foot-end side panel 50d would be rotated clockwise about the rotatable connection to its outside member 30 if stuck in its expanded position. Head panel 50a and foot panel 50f may not need the above-described emergency structure and functionality because a patient does not normally exit a hospital bed via its head or foot.

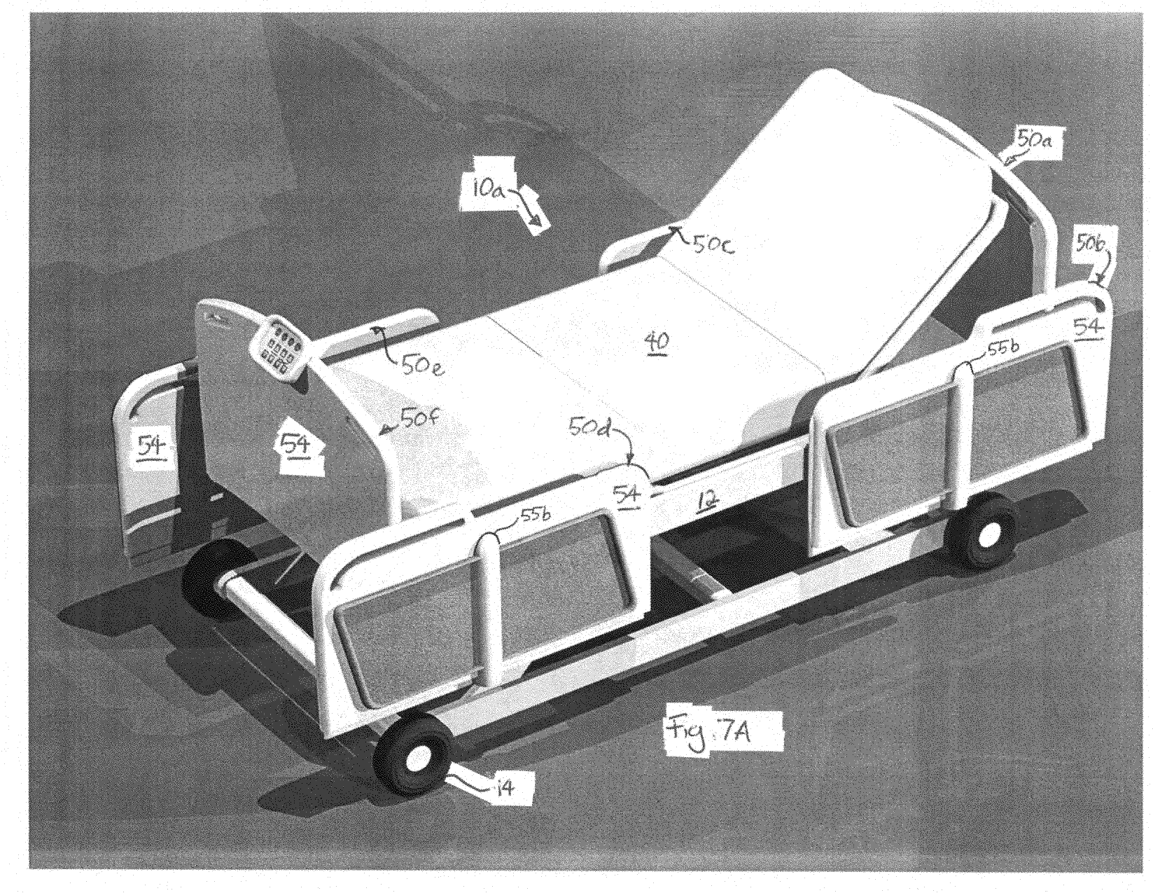

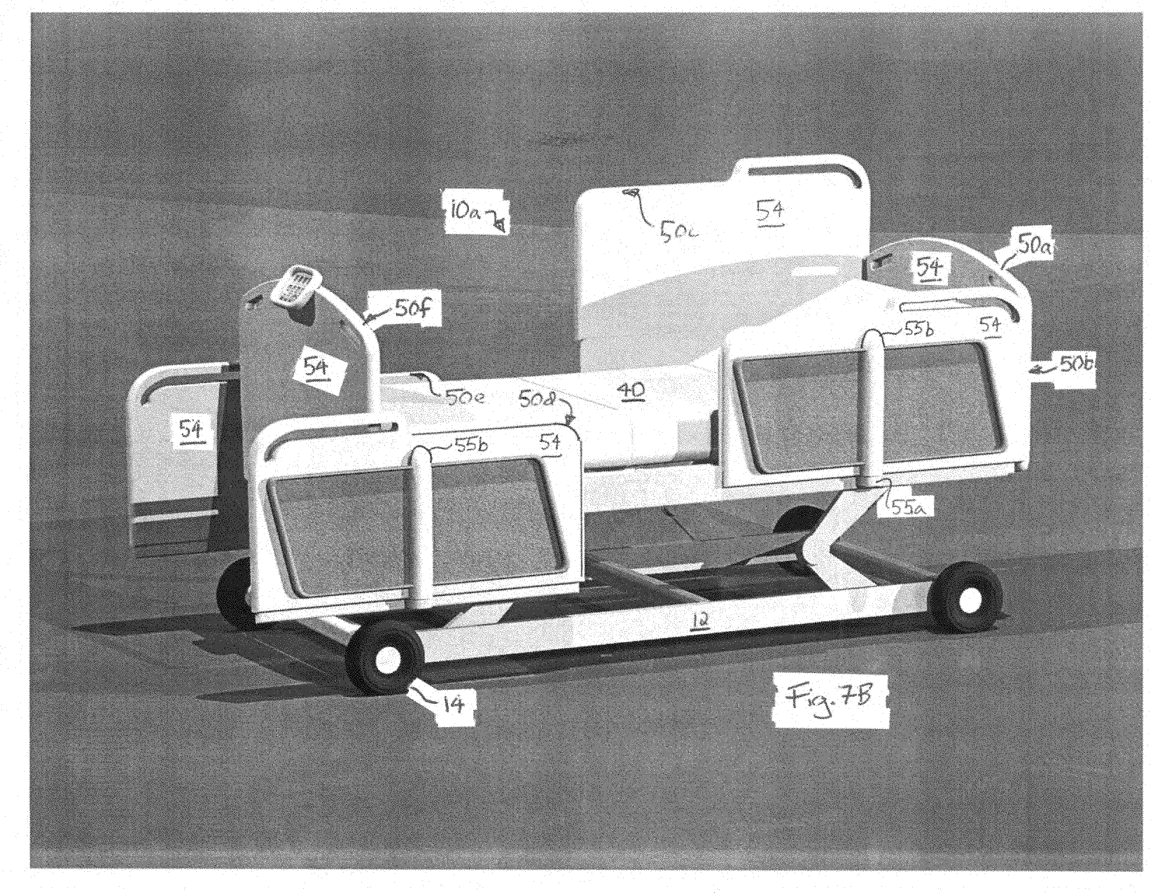

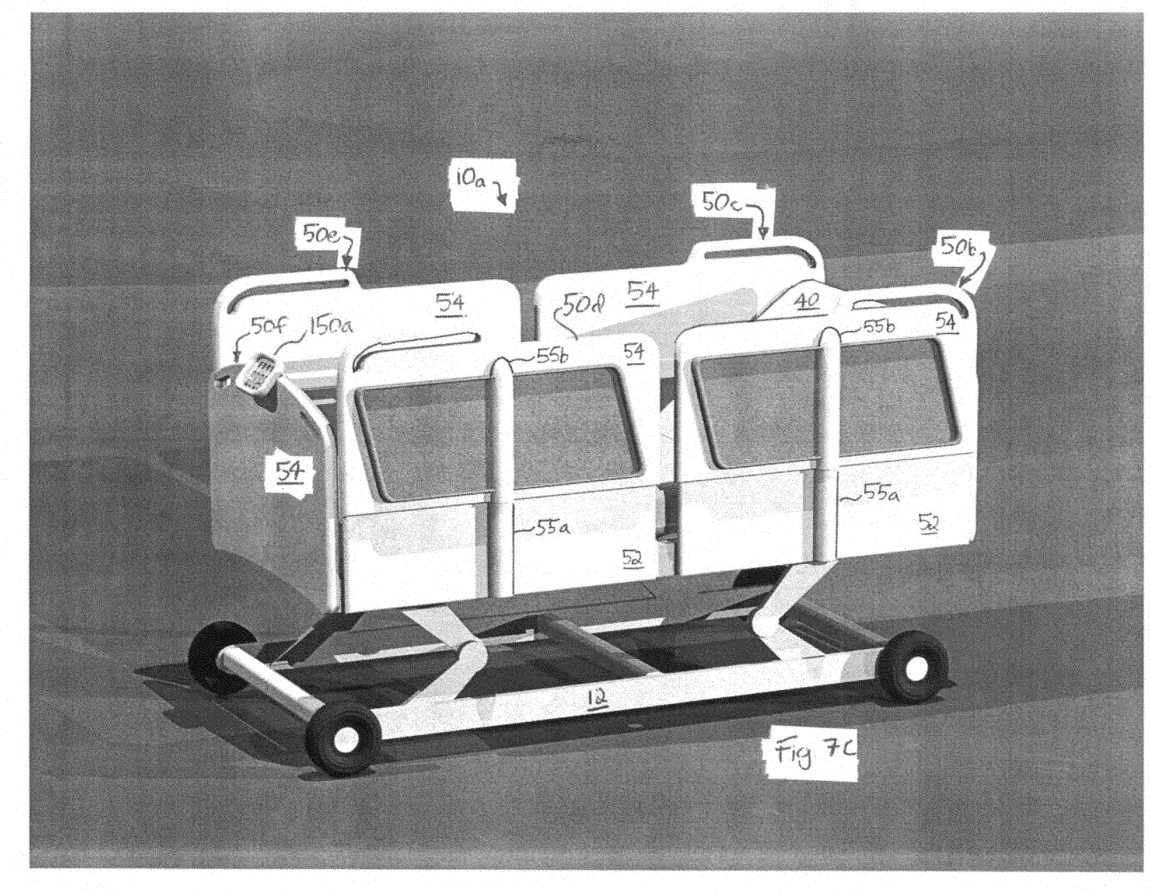

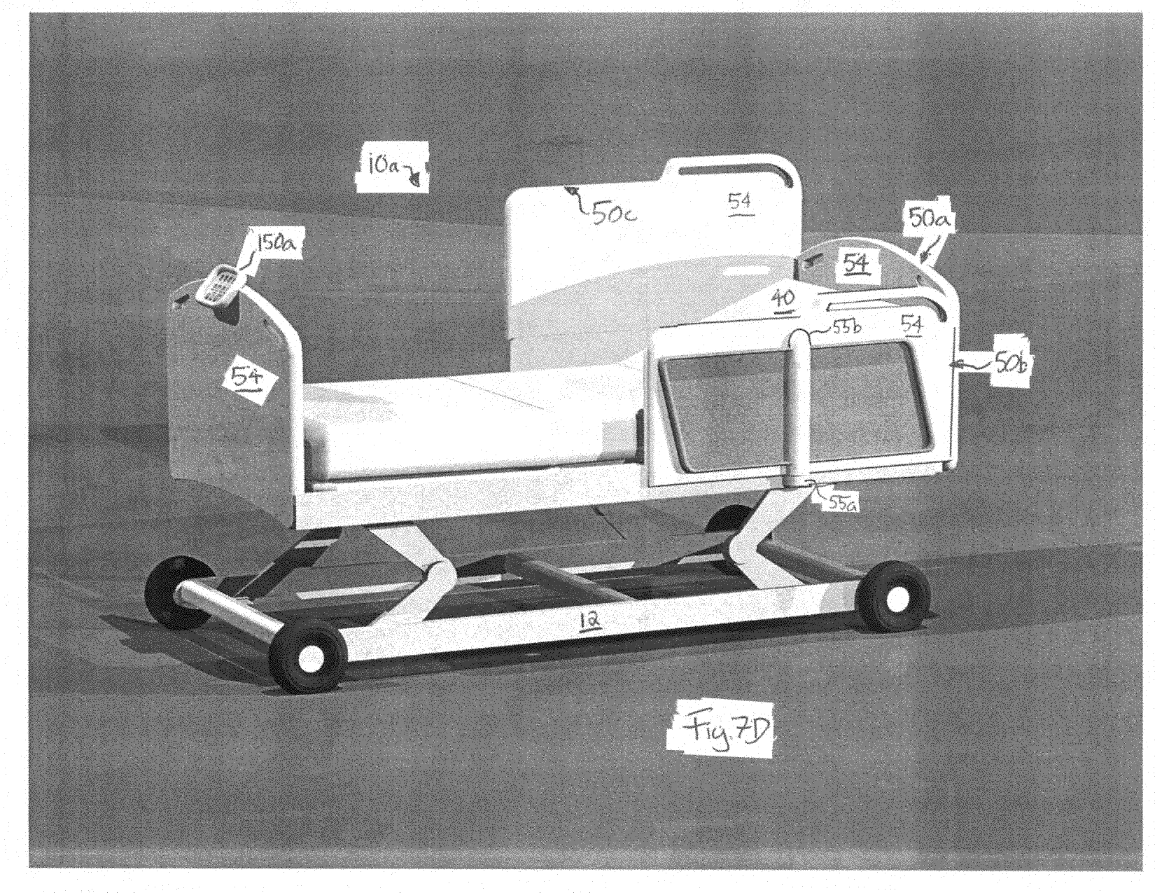

FIGS. 7A to 7D illustrate hospital bed 10a in various states of patient privacy and additional alternative embodiments. FIG. 7A illustrates bed 10a in a patient bed-entry or bed-exit state with side panels 50b, 50c, 50d and 50e fully retracted and rotated downwardly. The patient can easily get into or out of bed 10a as illustrated. Head panel 50a and foot panel 50f may be left in an upward position in the bed-entry or bed-exit state. FIG. 7B illustrates hospital bed 10a in one patient desired state of privacy. Here, the patient desires panels 50d and 50e to be in a lowered patient bed-entry or bed-exit state and panel 50b to be up in a patient in-bed state, but in a fully retracted position. The patient's primary privacy concern is at the head and right side of the bed (relative to the patient), where the patient has chosen to fully expand panel 50c. FIG. 7C illustrates a situation in which the patient desires a lot of patient privacy, wherein all four side panels 50a, 50b, 50c and 50d are expanded. Only head panel 50a and foot panel 50f remain in a retracted position.

FIG. 7D illustrates one alternative embodiment wherein side panels 50d and 50e are not provided. Panels 50a to 50c and 50f are provided however. Panels 50b and 50c are expandable and retractable as described herein. Head panel 50a and foot panel 50f may or may not be expandable and retractable. It is accordingly contemplated to provide any combination of one or more panels 50a to 50f, wherein any one or more panel of the combination is or is not expandable and retractable as described herein.

FIGS. 7A to 7D also illustrate that to allow panels 50a to 50f to be thinner, any one or more or all of the panels 50a to 50f may be provided with enlarged areas for enclosing a linear actuator located within each expandable and retractable panel. In the illustrated embodiment, the enlarged areas include linear actuator holding cylinders 55a and 55b. It should be appreciated that the enlarged areas may have other shapes, such as rectangular, oval, or elliptical. As discussed in detail below, expandable and retractable panels 50a to 50f may each be made of a lower shell 52 and an upper shell 54. In FIGS. 7A to 7D lower shell 52 includes a linear actuator holding cylinders 55a that fits inside of a are linear actuator holding cylinder 55b of upper shell 54. Various embodiments for a linear actuator are discussed below. Linear actuator holding cylinders 55a and 55b expand to surround the, e.g., motor and lead screw, of the linear actuator, enabling the remaining portions of lower shell 52 and an upper shell 54 to be thinner.

Referring now to FIGS. 8A and 8B, an embodiment for the internal workings of expandable and contractible panels 50 (each of panels 50a to 50f) is illustrated. Panels 50 as discussed above include a lower shell 52 and an upper shell 54. Both shells 52 and 54 are illustrated in FIGS. 8A and 8B as being sectioned to show their inside components. Shells 52 and 54 are made of metal or plastic and are in one embodiment made of a durable plastic that is easily molded to achieve good tolerances, and which is resistant to sterilizing chemicals used to sanitize panels when needed. In the illustrated embodiment, member 32 or shaft 42 of mounts 30 are connected to mounting flanges 60 formed or provided at the bottom surface of lower shell 52 so that cutouts 56 in upper shell are not needed as has been discussed herein.

A gasket 62, such as a felt gasket, is applied, e.g., adhesively to the lower edge of the inner surface of upper shell 54 to: (i) seal the narrow gap between lower and upper shells 52 and 54, and (ii) provide a smooth surface for the outside of lower shell 52 to rub against. Another suitable material providing a smooth rubbing surface is teflon. Gasket 62 rides up and down with upper shell as illustrated in FIGS. 8A and 8B. In an embodiment, gasket 62 extends all the way around lower shell 52, such that upper shell 54 is prevented from rocking or tilting when translating up and down relative to lower shell 52.

FIGS. 8A and 8B also illustrate that handles 58 are sectioned and therefore are more than mere cutouts in upper shell 54 and are instead solid on the inside of upper shell 54, so that they provide a smooth feel to a person grasping and moving panels 50 via handles 58. Lower shell 52 in the illustrated embodiment is also molded or formed to have guides 64, which may only extend part of the way out from the inner surface of lower shell 52. Guides slidingly accept a linear actuation assembly 70. Actuation assembly 70 is illustrated further in FIG. 9. It is contemplated not to have to fasten linear actuation assembly 70 to lower shell 52. Instead, the weight of the assembly, combined with (i) the support from guides 64, (ii) the connection of the assembly to upper shell 54 and (iii) the continuous support provided by gasket 62 between shells 52 and 54, is believed to be enough to hold linear actuation assembly 70 quite sturdily during linear actuation. If needed however linear actuation assembly 70 may be connected to lower shell 52 via one or more fasteners, e.g., via one or more threaded connections into a mounting plate 72 of linear actuation assembly 70.

Mounting plate 72 of linear actuation assembly 70 is in one embodiment a metal plate formed for example of aluminum, steel, or stainless steel. Mounting plate 72 in an embodiment is three-sided having a broad mounting surface seen in FIGS. 8A and 8B, which is bent at both vertical sides to have two shorter stiffening sides that are sized and shaped to fit snugly in between the inner surfaces of lower shell 52. To that end, the shorter stiffening sides may need to be contoured to conform to a rounded bottom of lower shell 52.

A pair of bearings 74 and 76 are mounted at the bottom and top respectively of the broad mounting surface of mounting plate 72. Bearings 74 and 76 rotatably support either end of a lead or ball screw 78, such that lead or ball screw 78 may rotate relative to the mounted bearings 74 and 76, which include oiled ball or roller bearings to provide a very smooth rotation with little noise.

A motor 80 is likewise mounted to the broad mounting surface of mounting plate 72. Motor 80 may be a DC or AC brushed or brushless, stepper or servo motor as desired. Motor 80 is a two-way motor, however, motor does not have to have sophisticated control ability and in an embodiment is a small, inexpensive, but sturdy motor. In the illustrated embodiment, motor 80 may be connected via a flexible coupler 82 to a smaller pulley 84. Flexible coupler 82 dampens noise due to vibration and protects against sudden shock load, e.g., when motor 80 is stopped. Smaller pulley 84 is connected via a timing belt 86 to a larger pulley 88, which is mounted to a non-threaded shaft portion of lead or ball screw 78.

Smaller pulley 84 and larger pulley 88 may have radii forming a 1:2, 1:3 or 1:4 ratio, which decreases the output speed of motor 80 but increases its torque capability. That in combination with the relatively light weight of upper shell 54 and the fact that upper shell 54 does not need to move at a high speed allow for motor 80 to be relatively small and compact. It should be appreciated that pulleys 84 and 88 and timing belt 86 may be replaced by a gear arrangement, such as a gear box (e.g., worm gear) that also provides a torque increasing ratio, e.g., 1:2, 1:3 or 1:4.

A drive arm 90 is threadingly engaged to the threads of lead or ball screw 78. The distal end of drive arm 90 in the illustrated embodiment is provided with either master user input device 150a or individual panel user input device 150b. The proximal end of drive arm 90 in the illustrated embodiment is provided with a limit switch catch 92. Lead or ball screw 78 and drive arm 90 may be made of metal, such as aluminum, steel or stainless steel. It may be possible however to mold lead or ball screw 78 and drive arm 90 out of a tough plastic, such as teflon. Given the threaded and moving relationship between lead or ball screw 78 and drive arm 90, it may be desirable to make each of the same material, such as a harder metal like steel, which can be lubricated to provide smooth, quite motion.

A lower limit switch 94 is positioned at the bottom of mounting plate 72 of linear actuation assembly 70 so as to interact with catch 92 of drive arm 90 to stop drive arm at a desired fully retracted position in which upper shell 54 is fully contracted against lower shell 52 as illustrated in FIG. 8A. An upper limit switch 96 is positioned at the top of mounting plate 72 of linear actuation assembly 70 so as to interact with catch 92 of drive arm 90 to stop drive arm at a desired fully expanded position in which upper shell 54 is fully expanded relative to lower shell 52 as illustrated in FIG. 8B. Limit switches 94 and 96 and motor 80 are each in electrical communication with control unit 20. When an arm of either limit switch 94, 96 is moved enough so as to make or break an internal contact, control unit 20 is caused to stop motor 80 from moving further in the direction that caused catch 92 to trip the limit switch 94, 96. When catch 92 and drive arm 90 are moved in the opposite direction, limit switches 94 and 96 reset themselves as is known in the art.

In the illustrated embodiment, limit switches 94 and 96 enable motor 80 to be a simple motor that rotates in a first direction to cause upper shell 54 to expand relative to lower shell 52 and rotates in a second direction to cause upper shell 54 to contract relative to lower shell 54. Position encoding and/or servoing are not needed because limit switches 94 and 96 dictate when to cut out motor 80 in a given direction. This arrangement is advantageous because it is relatively simple, inexpensive, effective, and not affected by power loss. That is, when power resumes after a power loss, control unit 20 does not need to know where drive arm 90 is located along lead or ball screw 78. Instead, drive arm 90 can be made to translate in either direction until a limit switch 94 and 96 is tripped. It should be appreciated that while the illustrated electromechanical limit switches 94 and 96 provide one suitable and robust type, other types of limit switches may also be suitable, such as proximity switches, magnetic pick-ups, optical, e.g., infrared, switches, and the like.

In an alternative embodiment, limit switches 94 and 96 are not provided and motor 80 is provided instead with encoder feedback that tells control unit 20 how many rotary pulses that motor 80 has moved in a given direction, which control unit 20 converts into a linear distance knowing various features of lead or ball screw 78 (e.g., turns per centimeter) and the ratio of pulleys 84 and 88. Here, control unit 20 keeps track of where drive arm 90 resides along lead or ball screw 78 and stops motor 80 in both directions when the drive arm reaches a limit set in software. Power loss therefore becomes a factor because the loss of power may wipe out the location of drive arm 90 from a memory of control unit 20. One solution to this problem is to provide a battery back-up within control unit 20 that powers the memory upon power loss. Another solution is to provide a single limit switch, such as lower limit switch 94 that provides a home position upon regaining power. Here, control unit 20 is programmed so that upon power-up, it commands each panel to fully retract to the home position set by limit switch 94, thereby enabling control unit to know the position of each panel 50 in memory. Control unit 20 then uses encoder feedback from each motor 80 to update the position of each panel 50 as it is moved. A further solution is to use an “absolute” type of encoder having an output corresponding to a specific position along lead or ball screw 78. Here, upon power-up control unit 20 accepts the position specifying signal from the absolute encoder and retrieves the corresponding position of drive arm 90 along lead or ball screw 78, e.g., from a look-up table stored in memory.

Lower bearing 74, upper bearing 76, lead or ball screw 78, motor 80, flexible coupler 82, smaller pulley 84, timing belt 86, larger pulley 88, drive arm 90, limit switch catch 92, lower limit switch 94 and upper limit switch 96 form one embodiment of linear actuator 100, which is electromechanical in nature. It should be appreciated that linear actuator 100 for each panel 50 may alternatively include a pneumatically operated or oil-pressure operated piston-cylinder, which is positioned and arranged to move upper shell 54 up and down with respect to lower shell 52, which is moveably mounted to frame 12 as discussed herein.

As discussed above, the distal end of drive arm 90 in the illustrated embodiment is attached to or formed with a housing for either master user input device 150a or individual panel user input device 150b. Upper shell 54 in an embodiment is formed with one or more gasketed opening that allows the user input device 150a, 150b to protrude sealingly through upper shell 54, so that a user can interact with the buttons et al. of the user input device. In the illustrated embodiment, user input device 150a, 150b is provided with one or more threaded mounting hole 154 that aligns with one or more clearance mounting hole 66 formed in upper shell 54. Suitable fasteners are used to thread into threaded mounting hole 154 and pull user input device 150a, 150b tightly and sealingly against upper shell 54.

FIGS. 8A and 8B also illustrate an embodiment of the wiring needed to power the electromechanical version of linear actuator 100 and user input device 150a, 150b. FIGS. 8 and 9 illustrate that linear actuator wiring 22a and user input device wiring 22b are run within a flexible electrical conduit 152 for each expandable panel 50 of the present disclosure through one of the mounts 30 supporting the panel, through the mounting flange 60 of lower shell 52 connected to that mount, into the inner space of panel 50. User input wiring 22b is illustrated as having only two wires but may have more wires as needed. Linear actuator wiring 22a is illustrated as having two wires for each limit switch 94, 96 and two wires for motor 80, totaling eight wires, however, more wires may be provided for different types of switches and/or motors as needed.

Flexible electrical conduit 152 inside of panel (illustrated in cutaway form in FIGS. 8A and 8B) is provided with a service loop of extra length so that linear actuation assembly 70 may be easily removed from and inserted into lower shell 52 after upper shell 54 is removed from the lower shell. Flexible electrical conduit 152 inside of panel runs to a quick disconnect connector 156 having quick disconnect connector half 156a connected to the wires running into panel 50 from frame 12 and quick disconnect connector half 156b connected to linear actuator wiring 22a and user input device wiring 22b. Quick disconnect connector halves 156a and 156b snap together and pull apart to make and break multiple electrical connections at once. Pulling quick disconnect connector halves 156a and 156b apart enables linear actuation assembly 70 to be easily removed from lower shell 52 after upper shell 54 is removed from the lower shell.

The side walls of mounting plate 72 are provided with multiple cutouts 73 that enable wiring 22a (illustrated in cutaway form in FIGS. 8A and 8B) running from motor 80 and limit switches 94 and 96 to be routed outside of mounting plate 72 to quick disconnect connector half 156b in a manner such that wiring 22a cannot be jostled or moved to interfere with the motion of drive arm 90. To that end, limit switch wiring is routed in the illustrated embodiment through a wiring conduit 98 provided with linear actuation assembly 70, so that the wiring is routed safely behind drive arm 90. User input device wiring 22b (illustrated in cutaway form in FIGS. 8A and 8B) is also provided with a service loop that provides the length of wiring needed to enable upper shell 54 to move away from lower shell 52.

FIG. 8A illustrates panel 50 in a fully retracted form in which catch 92 of drive arm 90 has tripped lower limit switch 94. FIG. 8B illustrates panel 50 in a fully expanded form in which catch 92 of drive arm 90 has tripped upper limit switch 96. Drive arm 90 may be moved to and left to remain at any position along lead or ball screw 78 between the limit switch tripped positions of FIGS. 8A and 8B. Upper shell 54 may thereby be set at any position between fully retracted and fully expanded.

As shown above, it is contemplated that as little as one screw may need to be removed from threaded mounting hole 154 of whichever user input device 150a, 150b is provided at the end of drive arm 90 to then remove upper shell 54 from lower shell 52. Alternatively, multiple threaded mounting holes 154 may be provided in user input device 150a, 150b that align with multiple clearance mounting holes 66 formed in upper shell 54. In either case, removing upper shell 54 from lower shell 52 is easy to perform. Once upper shell 54 is removed, linear actuation assembly 70 can be removed slidingly from between guides 64 of lower shell 52 via the service loop provided for flexible electrical conduit 152. Quick disconnect connector halves 156a and 156b are pulled apart, leaving linear actuation assembly 70 free to be serviced or swapped out.

### Privacy Panel Control and System Integration

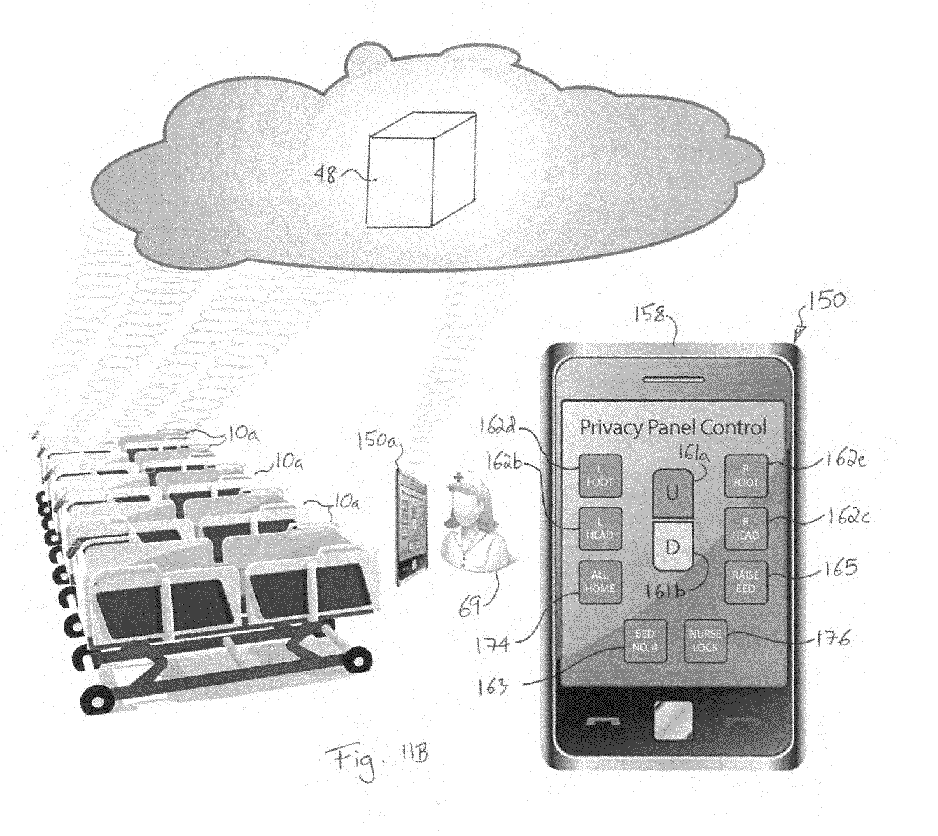

Referring now to FIGS. 10A, 10B, 11A and 11B, an embodiment for each of master user input device 150a and individual panel user input device 150b is illustrated. In FIG. 10A, master user input device 150a may be used to move each of panels 50a to 50f, while in FIG. 10B individual panel user input device 150b is dedicated to one of panels 50a to 50f. Master user input device 150a includes a housing 158, such as a liquid proof plastic housing connected in a liquid-tight manner flexible electrical conduit 152, which carries wires from master user input device 150a to control unit 20.

Housing 158 is alternatively a housing of a smartphone or other personal communication device (“PCD”) capable of downloading a software application (“app”) having the buttons and indicators of master user input device 150a. In an embodiment, the app is configured to send an interrogation (ping) signal to see which app-configured beds 10 (referring to all beds 10a to 10e) in the hospital, clinic or other treatment facility, or a portion thereof, respond. The responding beds 10 (referring to all beds 10a to 10e) send to the app their associated identification numbers. The app then provides a prompt to the patient, nurse, clinician or other caregiver at their PCD to choose which bed 10 (referring to all beds 10a to 10e) is to be controlled. The app is thereafter synched to the selected bed 10 (referring to all beds 10a to 10e). It is therefore expressly contemplated that a nurse or clinician could help a new patient to download the app and select the proper 10 (referring to all beds 10a to 10e) for the patient, after which the patient could use his or her own PCD to control the bed.

The app communicates with control unit 20 of the selected bed 10 wirelessly, e.g., via Bluetooth™ WiFi™ Zigbee®, Z-Wave®, wireless Universal Serial Bus (“USB”), infrared, nearfield communication (“NFC”) to perform any of the panel control functions discussed herein. It should be appreciated that app could be expanded to control all functions of bed 10 (referring to all beds 10a to 10e) including non-privacy panel actions, such as changing its position to sit-up, recline, etc.

Referring now to FIGS. 11A and 11B, it is further contemplated to have the app or the control unit 20 of the bed send data regarding control of the bed to one or more central server computer 48, where the data may be analyzed to see, for example, how often the bed changes position, which positions are most popular, which panels are activated the most, etc. FIG. 11A illustrates different hospitals 68a to 68c (may be any number of hospitals), each having one or more bed 10a to 10e. Element numbers 68a to 68c may represent different hospitals and/or multiple facilities as part of the same hospital. Hospital 68a illustrates that a single hospital may have a combination of any number of any type of bed 10a to 10e. Alternatively, a hospital may only have a single type of bed 10a to 10e.

All three hospitals 68a to 68c send bed usage data to one or more server computer 48. FIG. 11B illustrates that one or more server 48 may be a cloud based server. One or more server computer 48 compiles the data and analyzes it for whatever information is deemed important. In an embodiment, the data may be bed specific and have no patient identification to avoid any issue with patient privacy laws. FIG. 11A shows that the master user input device 150a app is downloaded to each patient's PCD. A nurse 69 also has the master user input device 150a app downloaded to the nurse's PCD as illustrated in FIG. 11B, which may be used to control any of beds 10a to 10e, e.g., via a bed selection button 163. Thus information for a particular bed, say bed 10e of hospital 68a, may come from multiple PCD's, e.g., the PCD of nurse 69 and the PCD of the patient at bed 10e, or from the control unit 20 of bed 48. It is therefore contemplated for sever computer 48 to create a file for each bed that may receive information from different PCD's, e.g., from different patients on different days or even from a nurse 69 and the patient on the same day.

In the illustrated embodiment, bed data from hospitals 68a to 68c is sent wirelessly from the master user input device 150a apps of the different PCD's to server computer 48. Alternatively, one or more server computer 48 may receive the bed operating data wired or wirelessly from the control units 20 of each of beds 10a to 10e. One or more server computer 48 may for example be located inside hospital 68a to 68d and be in wired communication with control units 20. Data may be sent to server computer 48 in real time as it is created or be stored temporarily at control unit 20 of the bed and sent later at a specific time, e.g., in the early morning when it is likely that at control unit 20 usage is at a minimum.

It is contemplated for the software at one or more server computer 48 to be learning software that studies patterns of use. The studies may involve two main categories. The first category is non-patient specific, that is, trends that are gleaned from multiple patients. Examples include: (i) studying which times during the day are most active for panel expansion and retraction, (ii) which panels are actuated the most, (iii) does panel actuation depend upon room placement, (iv) does panel actuation depend upon hospital room occupancy, (v) does panel actuation depend upon lighting, including indoor and/or outdoor lighting, (vi) does panel actuation depend upon patient age, (vii) does panel actuation depend upon patient sex, (viii) does panel actuation depend upon be position, e.g., sitting-up versus prone positions, (ix) does panel actuation depend upon where the hospital bed is located within a hospital or clinic, (x) what positions are the panels actuated to the most, e.g., fully expanded versus partially expanded, (xi) what combinations of panels actuated are the most popular, and (xii) percentage of panel actuation by a nurse or clinician versus percentage of panel actuation by the patient, etc.

The software at server 48 may evaluate any one or more of the above using one or more algorithm to output data that helps to hone and optimize future hospital beds having the expandable and retractable panels of the present disclosure. Features that may be honed include, for example, how many expandable and retractable panels to provide, how much expansion is needed, and/or how robust the linear actuators need to be.

The second category is patient specific, that is, trends that are gleaned for a single patient. For example, the software may track the patient using the patient's smartphone number. The software does not know the actual identity of the patient, but assumes that data received at one or more server 48 tagged with the same smartphone number belongs to the same patient. The software attempts to learn trends for the same smartphone number, such as time of day, frequency of actuation, type of actuation, e.g., full or partial, and which panels are actuated, for example. The software may use these trends to cause one or more recommendation to be made, e.g., via test messaging, to the patient or to a doctor, nurse or clinician treating the patient. For example, use instruction reminders may be sent at a time of day when the software has learned that a particular patient has routinely actuated one or more of the panels.

Returning to FIG. 10A, master user input device 150a in the illustrated embodiment includes an up-down rocker switch 160. Panel selection buttons 162a to 162f (referred to herein collectively as panel selection switches 162 or generally individually as panel selection switch 162) are dedicated to panels 50a to 50f, respectively. Panel selection buttons 162 in the illustrated embodiment are bordered by lights 164, such as green lights. In the illustrated embodiment, panel selection buttons 162a to 162f are presented on housing 158 in the order that a patient lying in bed would view panels 50a to 50f, with head panel selection button 162a closest to the patient, foot panel selection button 162f on the opposing side of rocker switch 160 from head panel selection button 162a, left-upper shell and left-lower selection buttons 162b and 162d, respectively, on the left side of housing 158 and right-upper shell and right-lower selection buttons 162c and 162e, respectively, on the right side of housing 158.

If master user input device 150a is instead mounted to one of left or right side panels 50b to 50e, head panel selection button 162a is pointed towards the head of bed 10a, while foot head panel selection button 162f is pointed towards the foot of bed 10a, and the text on the buttons is rotated ninety degrees as need to read right-side-up. If master user input device 150a is instead mounted to one of top or right side panels 50a or 50f, head panel selection button 162a may be pointed towards the left, while foot head panel selection button 162f is pointed towards the right, and the text on the buttons is rotated ninety degrees as need to read right-side-up.

The patient or other user presses the panel selection button 162a to 162f of whichever panel 50a to 50f that is to be expanded or retracted. Master user input device 150a may also provide multi-panel selection buttons, such as an upper-3 selection button 166, a lower-3 selection button 168 and a select-all button (not illustrated). Pressing upper-3 selection button 166 selects the upper three panels 50a to 50c. Pressing lower-3 selection button 168 selects the lower three panels 50d to 50f. Pressing the select-all button selects all six panels 50a to 50f for expansion or contraction. Regardless of how a panel selection button 162a to 162f is selected, light 164 of the button 162 becomes illuminated.

Rocker switch 160 pivots about an axis 170 and is spring biased in both up and down directions to return to an unactuated position. The patient or other user presses “U” to make whichever panels 50a to 50f have been selected using panel selection buttons 162a to 162f expand. If the patient or other user on presses “U” only half-way down, rocker switch 160 acts as a momentary switch in which the selected panel(s) expand only while the patient continues to push the “U”. Momentary actuation of the “U” enables the patient to expand any of the selected panels 50a to 50f to any intermediate position between fully retracted and fully expanded. If the patient or other user instead presses “U” all the way down, rocker switch 160 locks and becomes a maintained switch in which the selected panel(s) expand to a fully expanded state even after the patient or user releases rocker switch 160. Here, the patient or user only has to press the “U” for an instant to cause each of the selected panels 50a to 50f to expand fully. The patient or user presses “D” to instantly unlock rocker switch 160 from the locked “U” position.

The patient or other user presses “D” to make whichever panels 50a to 50f have been selected using panel selection buttons 162a to 162f contract. If the patient or other user on presses “D” only half-way down, rocker switch 160 acts as a momentary switch in which the selected panel(s) retract only while the patient continues to push the “D”. Momentary actuation of the “D” enables the patient to retract any of the selected panels 50a to 50f to any intermediate position between fully expanded and fully contracted. If the patient or other user instead presses “L” all the way down, rocker switch 160 locks and becomes a maintained switch in which the selected panel(s) contract to a fully contracted state even after the patient or user releases rocker switch 160. Here, the patient or user only has to press the “D” for an instant to cause each of the selected panels 50a to 50f to contract fully. The patient or user presses “U” to instantly unlock rocker switch 160 from the locked “D” position.

The patient or user may therefore cause control unit 20 to expand or contract three panels 50 fully with a few as two button presses, e.g., upper-3 selection button 166 or a lower-3 selection button 168 and rocker switch 160 in either locked “U” or “D” directions. Pressing undo button 172 cause control unit to instantly unselect any panel selection buttons 162a to 162f currently selected, enabling the patient or user to start over. Pressing home button 174 causes control unit 20 to instantly retract any fully or partially expanded panel 50 into a fully retracted or home position. Home button 174 enables the patient user to easily, with one button press, place bed 10a into a state in which the patient can get into or out of the bed.

Pressing nurse lock button 176 causes control unit 20 to lock out all functionality on master user input device 150a until a programmed code is entered by a nurse or caregiver to unlock user input device 150a. The code may for example be (i) a combination of any three button presses on user input device 150a, (ii) pressing any button of user input device 150a continuously for a predetermined period, e.g., three seconds, or (iii) if user input device 150a is implemented as a smartphone software app, a keypad may appear when undo button 172 is pressed, wherein the code may for example be a combination of three numbers entered via the keypad.

Control unit 20 illuminates travel stop indicator 178 (e.g., red) when the patient or user attempts to expand or contract a panel 50 that is already fully expanded or contracted. Housing 158 may also be provided with a vibrator that vibrates while travel stop indicator 178 is illuminated.

FIG. 11B illustrates that a smartphone version of master user input device 150a may include up and down virtual buttons 161a and 161b in place of up/down rocker switch 160 of the electromechanical version of master user interface device 150a. Either version of master user interface device 150a for a doctor, nurse or clinician may also be provided with a bed selection button 163, so that nurse 69, for example, may easily choose which bed to actuate. In one embodiment, pressing bed selection button 163 scrolls through each bed 10 programmed into nurse 69's smartphone one-by-one until reaching the desired bed. After a timeout period, the app at smartphone 150a sets the bed to be the bed displayed at bed selection button 163.

FIG. 11B also illustrates that any version of master user interface device 150a may also control any other functionality of hospital bed 10. In the illustrated example, user interface device 150a also controls whether bed 10 is in an upright sitting position for the patient or in a flat prone position for the patient. Integrating other bed functionality with the functionality for expandable and retractable panels 50a to 50f of the present disclosure enables a single user interface to control all or a desired amount of varying functionality for beds 10 of the present disclosure.

Individual panel user input device 150b of FIG. 10B is simplified relative to user input device 150a. Individual panel user input device 150b includes home button 174 and nurse lock button 176 as described above. In an embodiment, pressing home button 174 causes control unit 20 to instantly retract any fully or partially expanded panel 50 into a fully retracted or home position even though user input device 150b is dedicated to a single panel 50.

Pressing upper momentary button 180 causes control unit 20 to expand the panel 50 to which input device 150b is dedicated as long as the patient or user continues to press the button. Once the patient or user releases upper momentary button 180, control unit 20 stops motor 80 and the panel 50 remains at the stopped position. Upper momentary button 180 accordingly enables the patient or user to expand the panel 50 to any intermediate position between fully contracted and fully expanded. Pressing upper lock button 182 causes control unit 20 to expand the panel 50 to which input device 150b is dedicated to a fully expanded position instantly even after the user releases upper lock button 182.

Pressing lower momentary button 184 causes control unit 20 to contract the panel 50 to which input device 150b is dedicated as long as the patient or user continues to press the button. Once the patient or user releases upper momentary button 180, control unit 20 stops motor 80 and the panel 50 remains at the stopped position. Lower momentary button 184 accordingly enables the patient or user to contract the panel 50 to any intermediate position between fully expanded and fully contracted. Pressing lower lock button 186 causes control unit 20 to contract the panel 50 to which input device 150b is dedicated to a fully contracted position instantly even after the user releases lower lock button 186.

Individual panel user input device 150b may additionally provide travel stop indicator 178 of master user input device 150a if desired. Master user input device 150a in turn may alternatively or additionally provide momentary and maintained buttons 180 to 186 dedicated to each of panels 50a to 50f as set forth in connection with individual panel user input device 150b.

### Alternative Beds

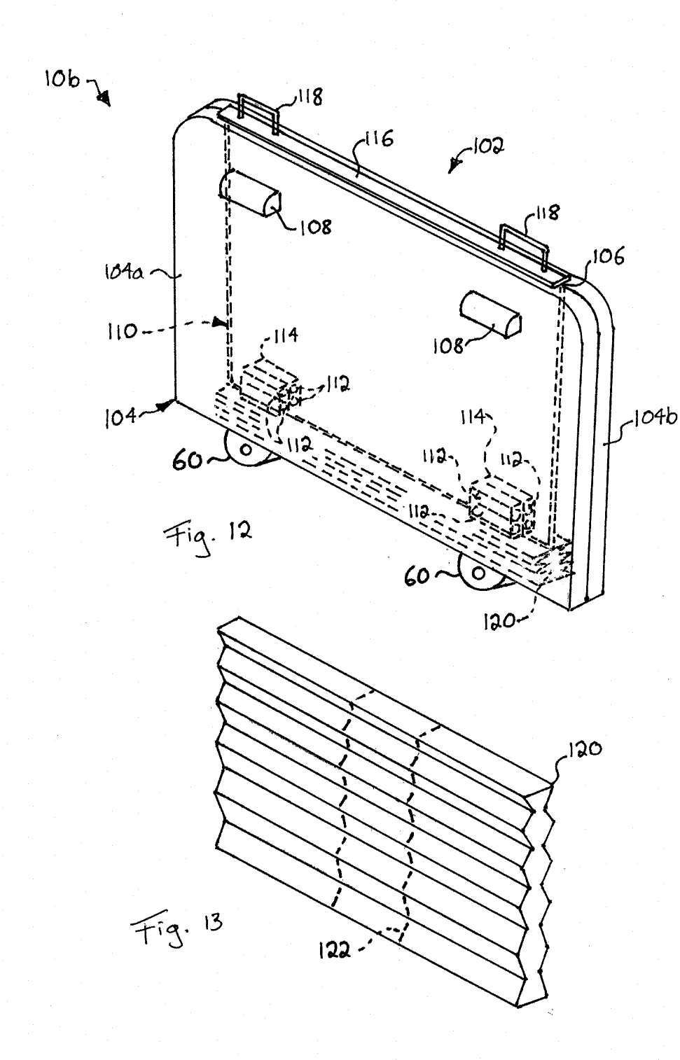

Referring now to FIGS. 12 to 14, a first alternative expanding panel 102 is illustrated for alternative bed 10b. Alternative bed 10b includes each of the structures, materials, functionality and alternatives for any one or more or all of frame 12, wheels 14, foot pedal 16, cross-beams 18, control unit 20, wiring 22, linear actuator wiring 22a, user input device wiring 22b, legs 24, mattress platform 26, piston-cylinders 28, mounts 30, member of mount 32, frame bearing 34, first portion of frame bearing 34a, second portion of frame bearing 34b, panel bearing 36, first portion of panel bearing 36a, second portion of panel bearing 36b, first hardstop 38a, second hardstop 38b, electrical contact switch or sensor 39, mattress 40, fold line of mattress 41, shaft 42, arm 44, sliding seal of arm 44a, distal end of arm 44b, and cap 46 of bed 10a. The difference is that panels 50a to 50f of bed 10a are replaced by panels 102a to 102f (referred to herein collectively as panels 102 or generally individually as panel 102) for bed 10b. Panels 102 may be provided, like before, for any one or more or all of head panel, foot panel, two left side panels and two right side panels of bed 10b. Moreover, panels 102 may be rotated and/or translated back and forth between the bed-entry/exit state of FIG. 3 and the patient in-bed state of FIG. 4 via any of the structures and methodologies discussed herein.

Panels 102 each include a shell 104, which may be formed of two shell halves, e.g., outer shell half 104a and inner shell half 104b molded, bolted or otherwise connected permanently or removeably together. Shell 104 may be made of any of the materials described above for lower shell 52 and upper shell 54, e.g., of a material that is easily cleaned and disinfected, and which can withstand cleaning solvents. FIG. 12 illustrates mounting flanges 60 at the bottom of shell 104, which mate with member 32 or shaft 42 of mounts 30 as illustrated above in connection with FIGS. 6A, 6B, 8A and 8B.

Either one of outer shell half 104a or inner shell half 104b, or shell halves 104a and 104b may collectively form a slot 106. Slot 106 enables an interior translatable plate 110 to be selectively lifted up through slot 106 or pushed down through slot 106. Plate 110 enables panels 102 to be selectively expandable like panels 50 and may be constructed of any of the materials described or incorporated for shells 52, 54 or 104.

Outer shell half 104a in the illustrated embodiment provides handles 108 on its side, such that handles 108 may be used regardless of whether translatable plate 110 is lifted, so that panel 102 is expanded or pushed into the interior of shell 104, so that panel 102 is not expanded or retracted. Handles 108 may therefore be used to rotate and/or translate panels 102 back and forth between the bed-entry/exit state of FIG. 3 and the patient in-bed state of FIG. 4 regardless of whether panel 102 is expanded or not. Handles 108 may also be used as an alternative on panels 50 for bed 10a.

Plate 110 may be supported within shell 104 via the provision of one or more roller bearing 112 provided on or both sides of plate 110 between the plate and one or more of the inner surfaces of outer shell half 104a and inner shell half 104b. Roller bearings 112 may be attached to plate 110, the inner surfaces of shell 104, or both. In the illustrated embodiment, roller bearings 112 are attached to the bottom of plate 110, so that the bearing housing 114 serves also as a hardstop when translatable plate 110 is lifted fully from shell 104 (panel 102 fully expanded). Supporting plate 110 at its bottom via the bearing housings 114 and at the top via slot 106 holds plate 110 firmly within shell 104 of panel 102. FIG. 12 illustrates that there may be multiple bearing housings 114, e.g., two or more on each side of plate 110. Housings 114 may be formed with or attached to plate and may be made of the same material as plate 110. Roller bearings 112 may snap-fit at the center of the diameter of their ends into pegs formed with housings 114.

Plate 110 is formed or attached to a top 116, which resides outside shell 104. Top 116 in the illustrated embodiment forms a “T” shape with plate 110. Alternatively, top 116 may form an “L” shape with plate 110. In any case, top 116 may be formed with or attached to handles 118 for manually lifting privacy providing plate 110 out of shell 104, for expansion, or for manually pushing plate 110 into shell, for retraction. In a further alternative embodiment, top 116 is formed with bends that provided an elongated handle, such that separate handles 118 are not needed.

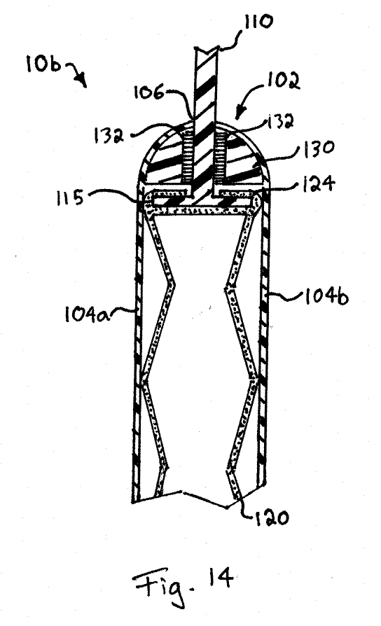

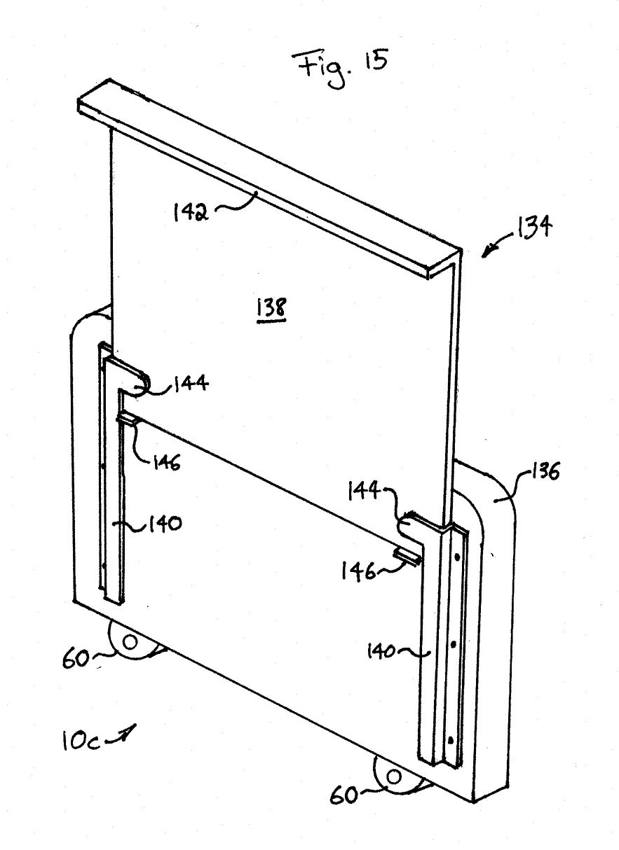

It is therefore contemplated that alternative panel 102 be manually operated in one embodiment, e.g., via a caregiver, family member or friend. Alternatively or additionally, an inflatable and retractable bellows 120 may be provided for automatic actuation. As illustrated in FIG. 13, bellows 120 may be made of rubber, such as silicone or neoprene, and can withstand whatever operating pressure is used, e.g., one to ten psig. Bellows 120 attaches to the bottom of plate 110. Bellows 120 for example may provide a flap (FIG. 14) that seals around a flange (FIG. 14) formed at the bottom of plate 110.

FIG. 13 illustrates that bellows 120 may include one or more sealed section 122 that receives a working fluid (e.g., air or oil), so that the entire bellows 120 does not need to be filled with such fluid. The weight of plate 110 is not significant and thus a smaller amount of working fluid may be used to lift and retract plate 110 out of and into panel 102. A single sealed section 122 in the middle of bellows is illustrated, however, multiple spaced apart sealed sections 122 may be provided alternatively.

Either input device 150a or 150b described above may be used to control positive pressure (e.g., air or oil) to inflatable bellows 120 to expand bellows 120 and thus panel 102 or negative pressure (e.g., air or oil) to inflatable bellows 120 to retract bellows 120 and thus panel 102. Inflation and deflation of bellows 120 may be momentary such that a desired intermediary position for plate 110 may be achieved. Alternatively or additionally, inflation and deflation of bellows 120 may be maintained, such that one press of an up or down button of input devices 150a and 150b causes plate 110 to be lifted or contracted fully out of or within shell 104.

FIG. 14 illustrates the top of shell 104 in more detail. If bellows 120 is provided, roller bearings 112 and bearing housings 114 may not be needed. An attachment flange 115 at the bottom of plate 110 is sealingly mounted within a flap 124 located at the top or bellows 120. A movement of bellows 120 thereby causes a corresponding movement of plate 110, such that an inflation of bellows 120 causes plate 110 to extend out of shell 104 and for panel 102 to expand, and such that a deflation of bellows 120 causes plate 110 to pull into shell 104 and for panel 102 to contract.

In the illustrated embodiment of FIG. 14, bellows 120 fits snugly within mated shell halves 104a and 104b. Additionally, the top of mated shell halves 104a and 104b includes a brush holder 130 having brushes 132 that contact plate 110 as the plate slides up and down within shell 104. Brushes 132 help to prevent particulate from entering shell 104 and provide a smooth ride for plate 110. Brush holder 130 and brushes 132 along with the snug fit of bellows 120 also hold plate 110 firmly even when plate 110 is fully extended out from shell 104. Plate 110 will have some play and will move if pressed but will not tip over.

If plate 110 is moved manually, there is no issue with panel 102 becoming stuck in its fully expanded position. If plate is inflated via bellows 120, then there is a remote possibility that bellows 120 could become stuck in a positively pressurized position. It is accordingly contemplated to provide a valve (not illustrated) that extends down from the bottom of bellows 120 and through a hole (not illustrated) in the bottom of shell 104. A nurse or other caregiver may thereby bleed out pressurized air or oil (into a container) via the valve to allow plate to be pushed manually into shell 104.

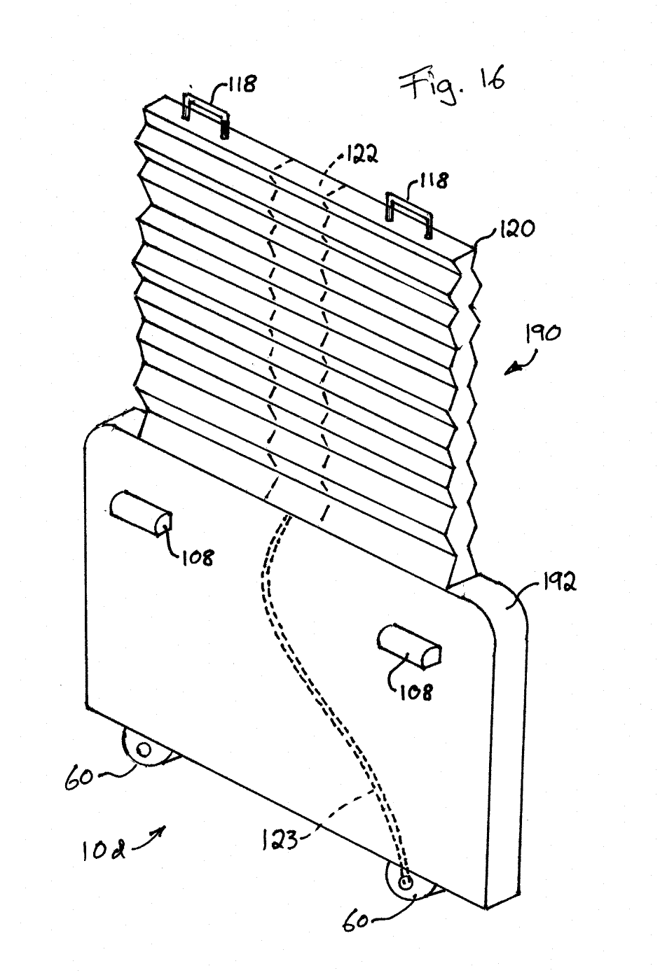

Referring now to FIG. 15, a second alternative expanding panel 134 is illustrated for alternative bed 10c. Alternative bed 10c includes each of the structures, materials, functionality and alternatives for any one or more or all of frame 12, wheels 14, foot pedal 16, cross-beams 18, control unit 20, wiring 22, linear actuator wiring 22a, user input device wiring 22b, legs 24, mattress platform 26, piston-cylinders 28, mounts 30, member of mount 32, frame bearing 34, first portion of frame bearing 34a, second portion of frame bearing 34b, panel bearing 36, first portion of panel bearing 36a, second portion of panel bearing 36b, first hardstop 38a, second hardstop 38b, electrical contact switch or sensor 39, mattress 40, fold line of mattress 41, shaft 42, arm 44, sliding seal of arm 44a, distal end of arm 44b, and cap 46 of bed 10a. The difference is that panels 50a to 50f of bed 10a are replaced by panels 134a to 134f (referred to herein collectively as panels 134 or generally individually as panel 134) for bed 10c. Panels 134 may be provided, like before, for any one or more or all of head panel, foot panel, two left side panels and two right side panels of bed 10b. Moreover, panels 134 may be rotated and/or translated back and forth between the bed-entry/exit state of FIG. 3 and the patient in-bed state of FIG. 4 via any of the structures and methodologies discussed herein.

Panels 134 each include a shell 136. Shell 136 may be made of any of the materials described above for lower shell 52 and upper shell 54, e.g., of a material that is easily cleaned and disinfected, and which can withstand cleaning solvents. FIG. 15 illustrates mounting flanges 60 at the bottom of shell 136, which mate with member 32 or shaft 42 of mounts 30 as illustrated above in connection with FIGS. 6A, 6B, 8A and 8B.

Panel 134 is similar to the manual version of panel 102 of FIGS. 12 to 14. Plate 138 of panel 134 is mounted alternatively on the outside of the panel. Plate 138 may be made of any of the materials specified for shell 136. In the illustrated embodiment, plate 138 slides within slot-forming members 140 formed with or attached to the outside of shell 136 and extending vertically along the sides of the outside of shell 136. Plate 138 is provided with a top lip 142, which provides a handle to move plate and also provided a hardstop against the tops of members 140 to form a fully contracted position for panel 134. The tops of members 140 each include inwardly extending tabs 144 against which aligned tabs 146 at the bottom of plate 138 abut as a hardstop to form a fully expanded position for panel 134.

Plate 138 is lifted up from shell 136 to expand panel 134 manually and is pushed downwardly along the outside of shell 136 to contract panel 134 manually in the illustrated embodiment. In an embodiment, slot-forming members 140 hold plate 138 frictionally in a lifted position. In an alternative embodiment, one of the mating surface of plate 138 and the mating surface of shell 136 defines one or more protrusion that mates with a mating one or more recess of the other of the mating surface of plate 138 and the mating surface of shell 136 to hold plate 138 frictionally in a lifted position. The tops of members 140 and their inwardly extending tabs 144 hold plate 138 firm against the outside of shell 136 even when plate 138 is lifted fully relative to shell 136. The mating of tabs 146 against tabs 144 prevents the plate from being removed from panel 134. Shell 136 may include one or more handle (not illustrated) to move panel 134 back and forth between the bed-entry/exit state of FIG. 3 and the patient in-bed state of FIG. 4.

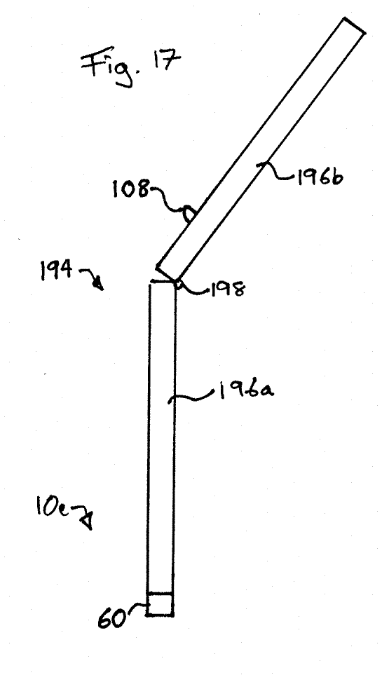

Referring now to FIG. 16, a third alternative expanding panel 190 is illustrated for alternative bed 10d. Alternative bed 10d includes each of the structures, materials, functionality and alternatives for any one or more or all of frame 12, wheels 14, foot pedal 16, cross-beams 18, control unit 20, wiring 22, linear actuator wiring 22a, user input device wiring 22b, legs 24, mattress platform 26, piston-cylinders 28, mounts 30, member of mount 32, frame bearing 34, first portion of frame bearing 34a, second portion of frame bearing 34b, panel bearing 36, first portion of panel bearing 36a, second portion of panel bearing 36b, first hardstop 38a, second hardstop 38b, electrical contact switch or sensor 39, mattress 40, fold line of mattress 41, shaft 42, arm 44, sliding seal of arm 44a, distal end of arm 44b, and cap 46 of bed 10a. The difference is that panels 50a to 50f of bed 10a are replaced by panels 190a to 190f (referred to herein collectively as panels 102 or generally individually as panel 102) for bed 10d. Panels 190 may be provided, like before, for any one or more or all of head panel, foot panel, two left side panels and two right side panels of bed 10d. Moreover, panels 190 may be rotated and/or translated back and forth between the bed-entry/exit state of FIG. 3 and the patient in-bed state of FIG. 4 via any of the structures and methodologies discussed herein.

Panels 190 each include a shell 192. Shell 192 may be made of any of the materials described above for lower shell 52 and upper shell 54, e.g., of a material that is easily cleaned and disinfected, and which can withstand cleaning solvents. FIG. 16 illustrates mounting flanges 60 at the bottom of shell 192, which mate with member 32 or shaft 42 of mounts 30 as illustrated above in connection with FIGS. 6A, 6B, 8A and 8B. Shell 192 may include one or more handle 108 to move panel 190 back and forth between the bed-entry/exit state of FIG. 3 and the patient in-bed state of FIG. 4.

Panels 190 include bellows 120 described above for panels 102 of FIGS. 12 to 14. Here, however, bellows 120 is mounted on the outside of shell 192 and on the top of the shell. Bellows 120 may be made of any of the materials described above for it in connection with panel 102. Bellows 120 may include handles 118 as illustrated to lift and compress the bellows to fully expanded and fully contracted positions manually. Alternatively or additionally, bellows 120 may be inflated to a fully expanded position and deflated to a fully contracted position using positive and negative pressure, respectively, as described above, e.g., via air or oil pressure provided inside of one or more sealed section 122 of bellows 120. One or more pneumatic or hydraulic line 123 may be extended to bellows 120 via one of mounting flanges 60 up through the inside of shell 192. Automatic control of the positive and negative pressure within bellows 120 is as described above for panels 102 in one embodiment.

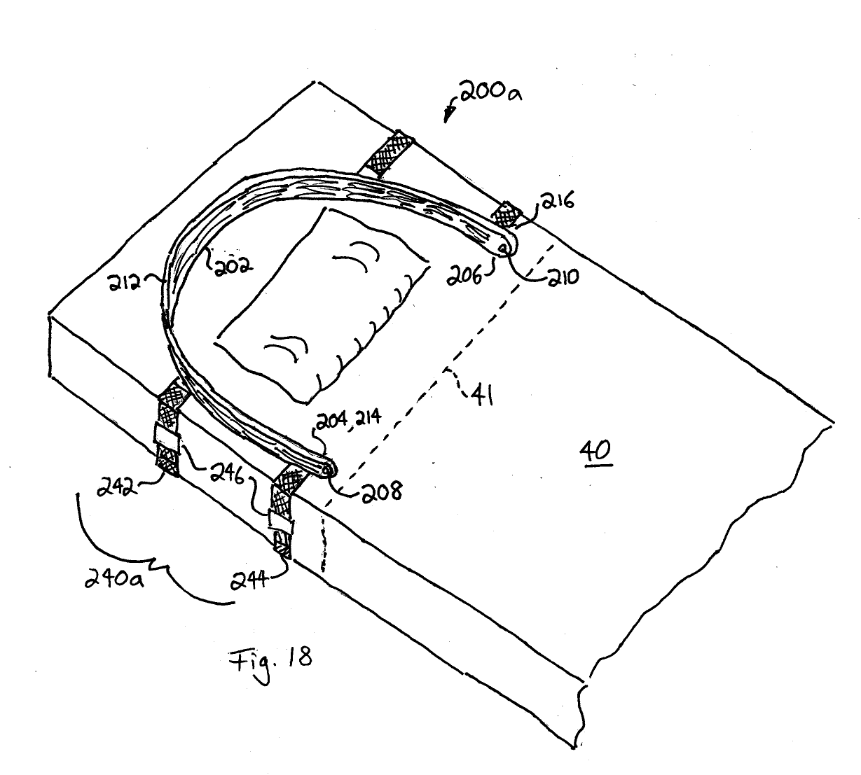

Referring now to FIG. 17, a fourth alternative expanding panel 194 is illustrated for alternative bed 10e. Alternative bed 10e includes each of the structures, materials, functionality and alternatives for any one or more or all of frame 12, wheels 14, foot pedal 16, cross-beams 18, control unit 20, wiring 22, linear actuator wiring 22a, user input device wiring 22b, legs 24, mattress platform 26, piston-cylinders 28, mounts 30, member of mount 32, frame bearing 34, first portion of frame bearing 34a, second portion of frame bearing 34b, panel bearing 36, first portion of panel bearing 36a, second portion of panel bearing 36b, first hardstop 38a, second hardstop 38b, electrical contact switch or sensor 39, mattress 40, fold line of mattress 41, shaft 42, arm 44, sliding seal of arm 44a, distal end of arm 44b, and cap 46 of bed 10a. The difference is that panels 50a to 50f of bed 10a are replaced by panels 194a to 194f (referred to herein collectively as panels 194 or generally individually as panel 194) for bed 10e. Panels 194 may be provided, like before, for any one or more or all of head panel, foot panel, two left side panels and two right side panels of bed 10e. Moreover, panels 194 may be rotated and/or translated back and forth between the bed-entry/exit state of FIG. 3 and the patient in-bed state of FIG. 4 via any of the structures and methodologies discussed herein.

Panels 194 each include a base shell 196a. Base shell 196a may be made of any of the materials described above for lower shell 52 and upper shell 54, e.g., of a material that is easily cleaned and disinfected, and which can withstand cleaning solvents. FIG. 17 illustrates mounting flanges 60 at the bottom of base shell 196a, which mate with member 32 or shaft 42 of mounts 30 as illustrated above in connection with FIGS. 6A, 6B, 8A and 8B.

Base shell 196a is connected hingedly to a rotating shell 196b via a hinge 198. Rotating shell 196b may be made of any of the materials used for base shell 196a. Hinge 198 is provided at the top outer edge of base shell 196a in the illustrated embodiment. In this manner, the bottom of rotating shell 196b may come to rest on the top of base shell 196a. The top of lower shell 196a may for example include one or more protrusion (not illustrated) that releasably locks into a mating one or more recess (not illustrated) provided at the bottom of rotating shell 196b when rotating shell 196b is rotated up to form an expanded panel 194. The one or more recess comes free from the one or more protrusion when rotating shell 196b is rotated down to form a contracted panel 194.

Rotating shell 196b may include one or more handle 108 to move panel 194 back and forth between the bed-entry/exit state of FIG. 3 and the patient in-bed state of FIG. 4 when rotating shell 196b is folded flat against base shell 196a. Hinge 198 may be a living hinge formed between shells 196a and 196b. Hinge 198 may alternatively be one or more piano type hinges.

### Portable Patient Privacy Apparatus

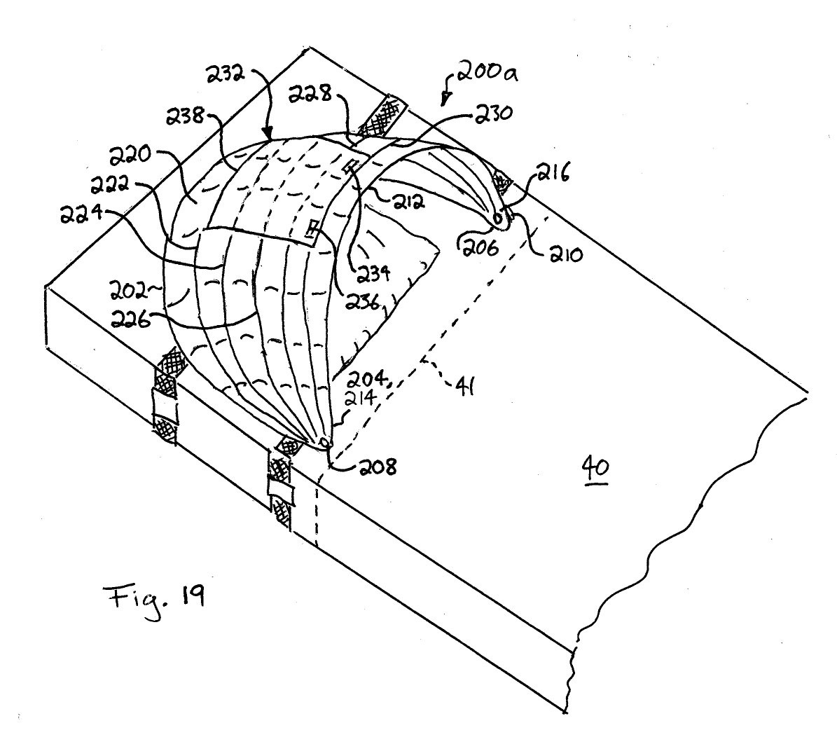

Hospital beds 10a to 10e as set forth above in FIGS. 1 to 17 is are fully-integrated, and in certain instances fully-automated, systems delivered by the manufacturer of beds 10a to 10e to provide selective patient privacy. For existing hospital beds and other resting devices, such as gurneys, a different solution for patient privacy is needed (although it is contemplated to retrofit panels 50, control unit 20, and any other needed structure of beds 10a to 10e onto an existing hospital bed if desired). Referring now to FIGS. 18 and 19, one apparatus for providing patient privacy to existing hospital beds and gurneys is illustrated by portable patient privacy apparatus 200a. Portable patient privacy apparatus 200a is placed on a mattress 40 of the hospital bed or gurney, e.g., above a fold line 41 where mattress 40 is folded so that the patient may sit up to eat, converse with visitors, watch television, and the like.

Apparatus 200a in the illustrated embodiment includes a U-shaped or polygonal-shaped base 202 including a first end 204 and a second end 206. Base 202 may be made of metal (e.g., aluminum, steel, stainless steel), plastic (e.g., teflon) or combinations thereof. A U-shape is illustrated for base 202, however, base 202 may alternatively have, for example, a three-sided, four-sided, or five-sided polygonal shape.

Apparatus 200a in the illustrated embodiment also includes a correspondingly U-shaped or polygonal-shaped member 212, such as an outer member, including a first end 214 mated with the first end 204 of base 202 and a second end 216 mated with second end 206 of base 202. Outer member 212 may be made of metal (e.g., aluminum, steel, stainless steel), plastic (e.g., teflon) or combinations thereof. Outer member 212 may have any of the U- or polygonal shapes discussed above for base 202. Base 202 and outer member 212 may be flat strips foldable onto each other, wherein the flat strips are formed into one of the U- or polygonal shapes. First end 214 of member 212 may be connected to or separate from first end 204 of base 202, while second end 216 of member 212 may be connected to or separate from second end 206 of base 202.

In the illustrated embodiment, first end 214 of member 212 is mechanically associated with first end 204 of base 202 via a first hinge 208, while second end 216 of member 212 is mechanically associated with second end 206 of base 202 via a second hinge 210. Mechanically associated may mean that ends 204 and 214 are mechanically connected to hinge 208, while ends 206 and 216 are mechanically connected to hinge 210. Hinges 208 and 210 may include internal detents that releasably lock the hinges and thus privacy apparatus 200 into a partially or fully unfolded position. Hinges 208 and 210 may be made of metal (e.g., aluminum, steel, stainless steel), plastic (e.g., teflon) or combinations thereof.

Outer member 212 and base 202 are (i) attached to an outside of or (ii) imbedded within upper and lower ends, respectively, of a hood 220. Hood 220 when unfolded as illustrated in FIG. 18 is the primary portion of apparatus 200a providing privacy to the patient. Hood is in one preferred embodiment made of a material that is foldable, washable and resistant to chemical detergents and disinfectants. Hood 220 in an embodiment is made of a smooth rubber or plastic. Hood 220 may alternatively be made of a polymer coated fabric, such as canvas coated with a smooth rubber or plastic. Hood 220 may alternatively be made of a water-proof fabric, such as a synthetic fabric. In any case, hood 220 may be easily cleaned and is resistant to cleaning chemicals.

Hood 220 as illustrated in FIGS. 18 and 19 is foldable such that when outer member 212 is folded against base 202, hood 220 folds onto itself between member 212 and base 202, and when member 212 is unfolded away from base 202, with first ends 204, 214 remaining in a mated relationship and second ends 206, 216 remaining in a mated relationship, hood 220 unfolds between member 212 and base 202 to provide a patient privacy cover. Base 202, member 212 and hood 220 are configured to be manually folded and unfolded in the illustrated embodiment.

FIG. 19 illustrates that patient privacy apparatus 200a further includes at least one correspondingly U-shaped or polygonal-shaped intermediate members 222, 224, 226, 228 and 230 located between base 202 and top member 212. Intermediate members 222, 224, 226, 228 and 230 may likewise be made of metal (e.g., aluminum, steel, stainless steel), plastic (e.g., teflon) or combinations thereof. Intermediate members 222, 224, 226, 228 and 230 may have any of the U- or polygonal shapes discussed above for base 202 and outer member 212. Intermediate members 222, 224, 226, 228 and 230, like base 202 and outer member 212, may be flat strips foldable onto each other, wherein the flat strips are formed into one of the U- or polygonal shapes. While five intermediate members are illustrated in FIG. 19, apparatus 200a may provide less than five or more than five such members.

Each of intermediate members 222, 224, 226, 228 and 230 includes a first end and a second end, wherein each first end aligns at least generally with first ends 204 and 214 of base 202 and outer member 214, respectively, and wherein each second end aligns at least generally with second ends 206 and 216 of base 202 and outer member 214, respectively. The first ends of intermediate members 222, 224, 226, 228 and 230 may be connected to, terminate at, or terminate before hinge 208. The second ends of intermediate members 222, 224, 226, 228 and 230 may likewise be connected to, terminate at, or terminate before hinge 210. In various embodiments, intermediate members 222, 224, 226, 228 and 230 are (i) attached to an outside of or (ii) imbedded within multiple plies of hood 220.

When patient privacy apparatus 200a is partially or fully unfolded, intermediate members 222, 224, 226, 228 and 230 provide spoke-like support for hood 220 between base 202 and outer member 212. In an embodiment, intermediate members 222, 224, 226, 228 and 230 have like radii or are otherwise sized the same as base 202 and outer member 212, so that a dome-like form of privacy may be established over a patient's head. Such privacy may be desired inside a hospital room or in a hospital hallway as has been described above. Additionally, patient privacy apparatus 200a may be provided outside while a patient lies on a gurney, providing privacy while the patient is being transported, while the patient waits for an ambulance to be prepared, and perhaps additionally providing cover against ambient conditions, such as hot sun, rain, wind, and/or snow.

As illustrated in FIG. 19, hood 220 may be provided with a window or openable hatch 232 for viewing the patient when hood 220 is unfolded. Window 232 may be a clear or semi-clear plastic sheet. Openable hatch 232 may be made of the same, e.g., opaque, material as the rest of hood 220. In the illustrated embodiment, openable hatch 232 is disconnected at the top, e.g., via one or more hook and loop connector 234 and 236 and folded down along fold line 238 to create a hole within hood 220. In a further alternative embodiment, a clear or semi-clear plastic sheet may be located beneath openable hatch 232. In any of the window or openable hatch 232 embodiments, a patient or caregiver located behind patient privacy apparatus 200a, e.g., pushing a hospital bed or gurney, may view the patient if desired.

FIGS. 18 and 19 illustrate that patient privacy apparatus 200a is provided with a structure 240a placed in an embodiment in mechanical communication with base 202, wherein structure 240a is configured to discourage patient privacy apparatus 200a from moving after being placed on the hospital bed or gurney. Structure 240a in the illustrated embodiment includes first strap 242 and a second strap 244. Each strap 242 and 244 includes a first portion extending from one side of base 202 beneath mattress 40 and a second portion extending from the other side of base beneath. The two portions are separated by a buckle or latch 246, which enables straps 242 and 244 to be securely tightened around mattresses 40 of different sizes. Buckle or latch 246 is positioned along one of the portions of each strap 242 and 244 so as to reside along a side of mattress 40, so that the buckle or latch may be access easily for tightening and loosening. When tightened, straps 242 and 244 hold base 202 and patient privacy apparatus 200a in place against mattress 40 even when the head of mattress 40 is rotated up along fold line 41 for the patient to sit.

While straps 242 and 244 are illustrated as extending from the sides of base 202 and beneath mattress 40, straps 242 and 244 may extend alternatively or additionally from the head or rounded portion of base 202 towards the head side of mattress 40. Here, straps 242 and 244 may hook to or loop around a portion of the frame of the bed. Again, these alternative straps hold base 202 and patient privacy apparatus 200a in place against mattress 40 even when the head of mattress 40 is rotated up along fold line 41 for the patient to sit.

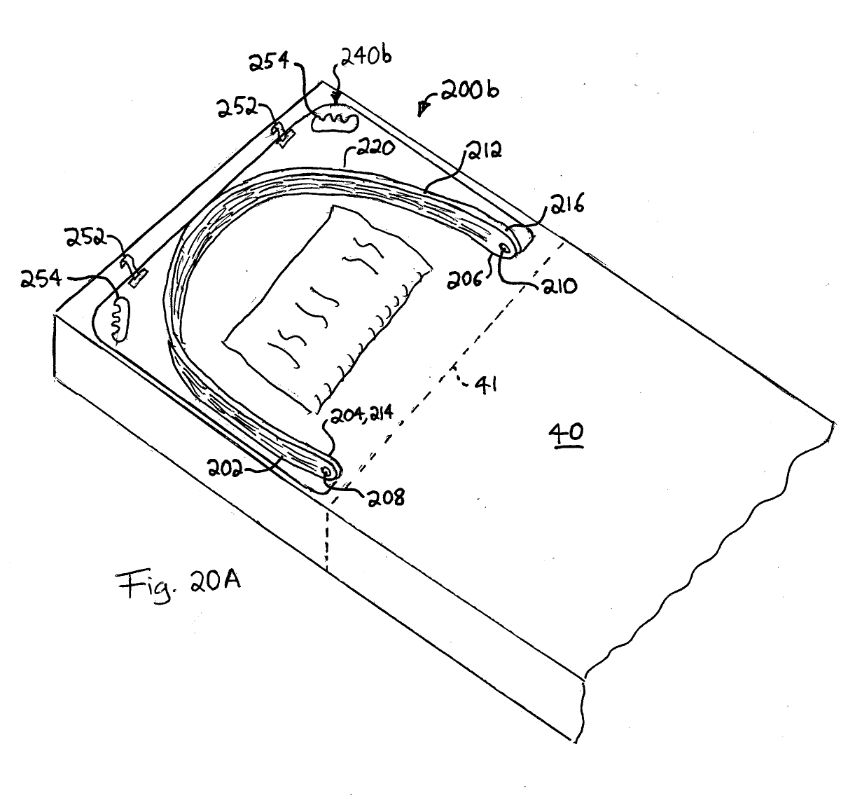

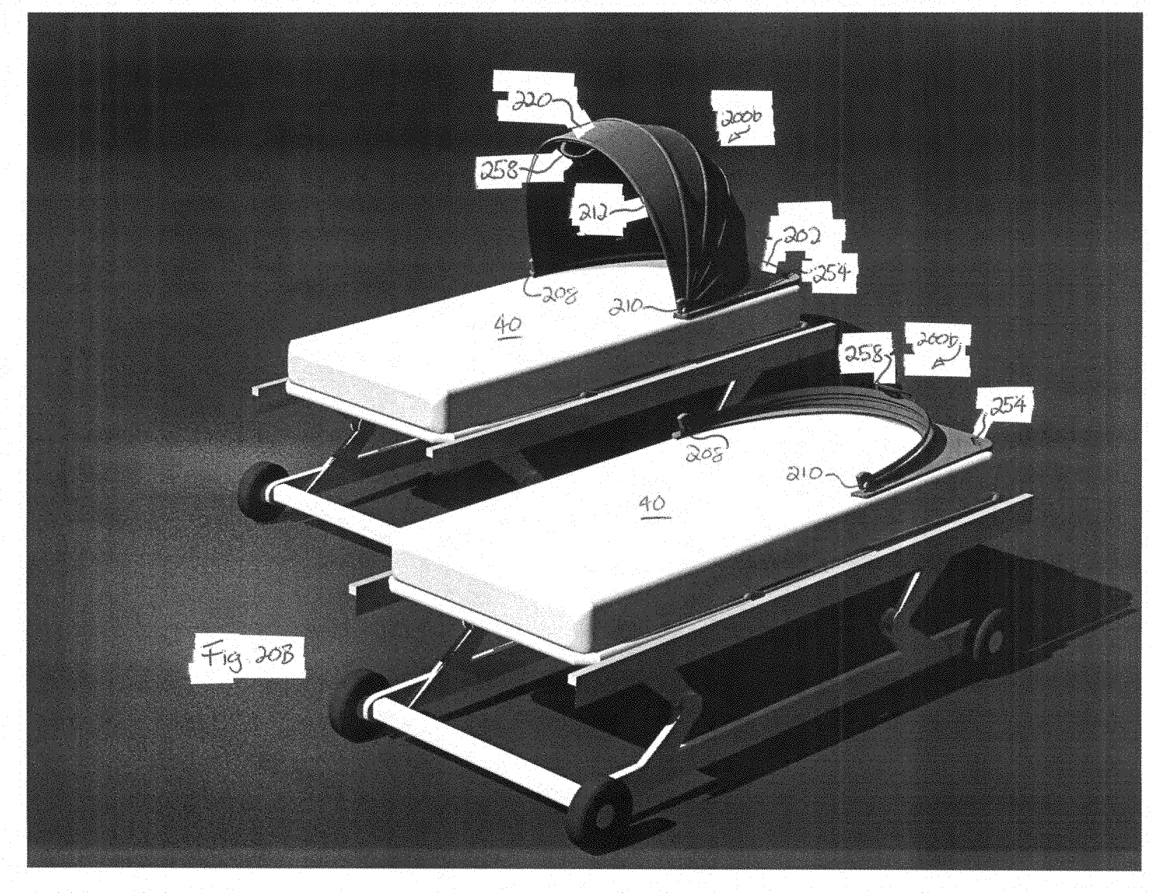

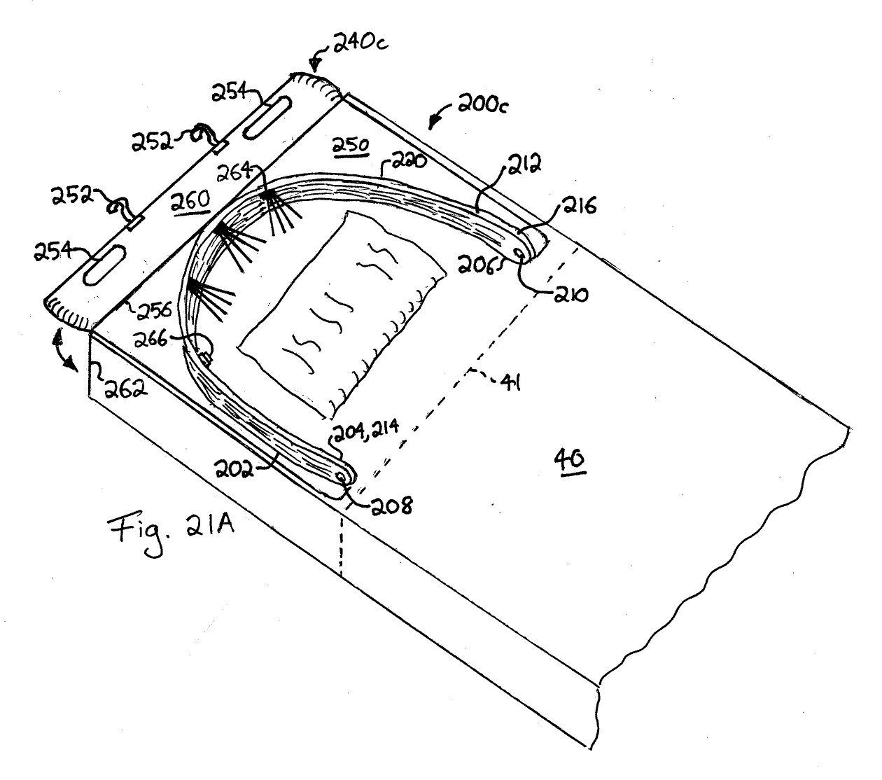

Referring now to FIGS. 20A and 20B, an alternative portable patient privacy apparatus 200b is illustrated. Portable patient privacy apparatus 200b includes any and all structure, functionality and alternatives discussed above for base 202, outer member 212, intermediate members 222, 224, 226, 228 and 230, and hood 220 discussed above for patient privacy apparatus 200a. Portable patient privacy apparatus 200b includes an alternative structure 240b configured to discourage patient privacy apparatus 200b from moving after being placed on the hospital bed or gurney. Structure 240b includes a flange extending from base 202, wherein flange 240b provides at least one of weight or friction to stabilize apparatus 200b when outer member 212 is moved with respect to base 212 and to resist sliding when mattress 40 is raised.

Flange 240b may be made of any of the materials discussed above for base 202, and may be formed with base 202 or attached to it. In the illustrated embodiment, flange 250 flange extends perpendicularly from base 202. In an alternative embodiment, flange 240b is curved downwardly, such that privacy apparatus 200b rests on one or more peripheral edge of flange 240b. Flange 240b may be made of a frictional material, such as a frictional rubber, be coated with the frictional material, or have a lower surface covered with the frictional material.

In the illustrated embodiment, flange 240b includes at least one of (i) one or more hook 252 for hooking portable apparatus 200b to a side of the hospital bed or gurney for storage, or (ii) a handle or handle cutout 254 for transporting portable apparatus 200b. Hook 252 and handle 254 may alternatively be combined into a single one or more curved edge portion of flange 240b that serves both to hook around a portion of the bed or gurney and act as a handle or griping device. In any case, it is contemplated that when portable patient privacy apparatus 200b is not in use that the apparatus can be transported easily off of the bed or gurney and hooked a structure near the bed or gurney, or to the bed or gurney itself to be stored vertically, out of the way, and in a convenient location for future use.

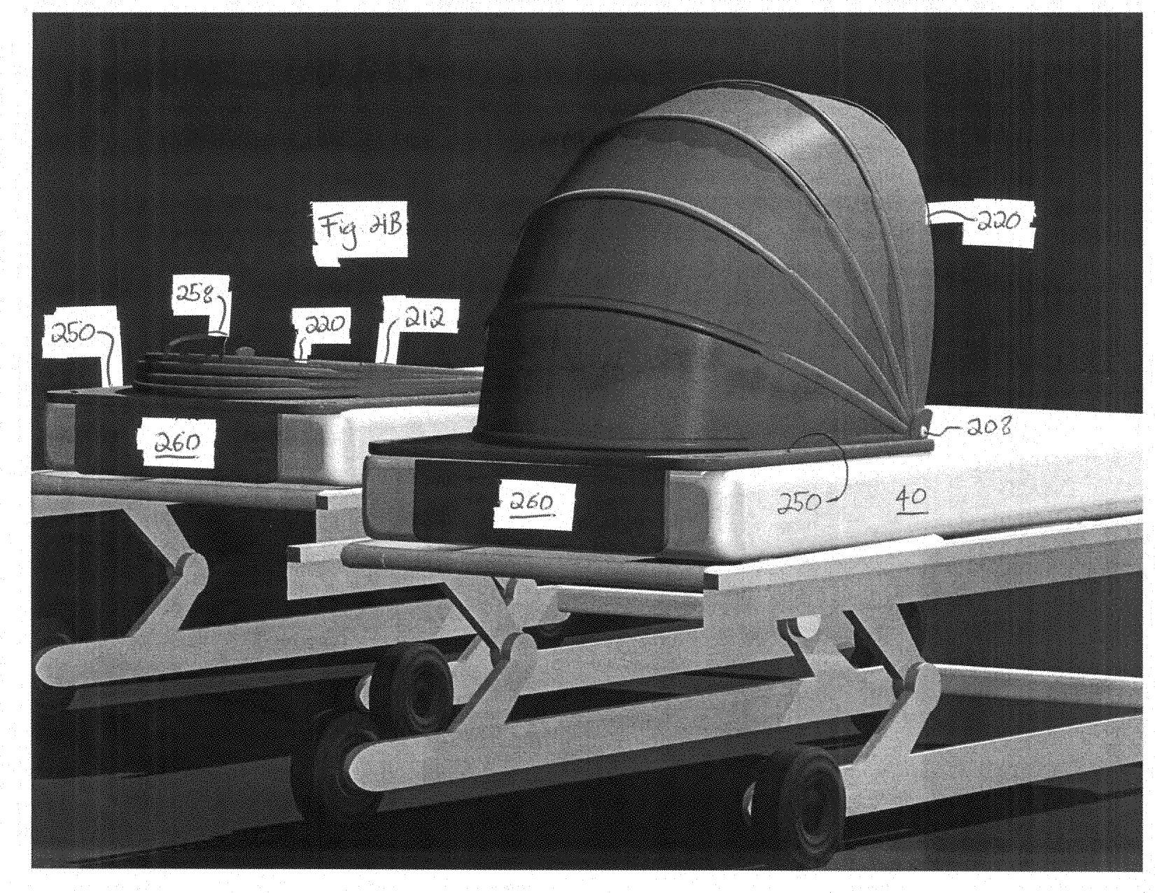

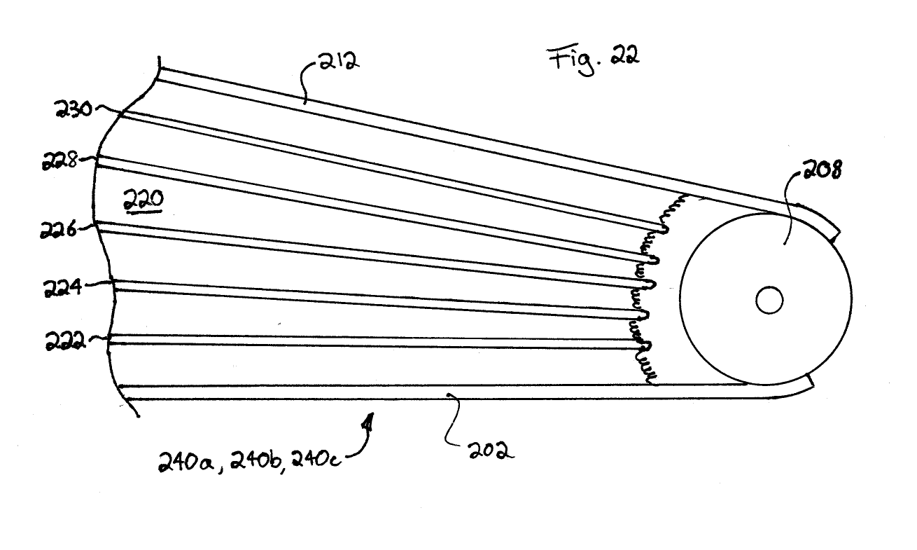

Referring now to FIGS. 21A and 21B, a further alternative portable patient privacy apparatus 200c is illustrated. Portable patient privacy apparatus 200c includes any and all structure, functionality and alternatives discussed above for base 202, outer member 212, intermediate members 222, 224, 226, 228 and 230, and hood 220 discussed above for patient privacy apparatus 200a. Portable patient privacy apparatus 200 includes an alternative structure 240c configured to discourage patient privacy apparatus 200b from moving after being placed on the hospital bed or gurney. Structure 240c includes a flange section 250 extending from base 202, wherein flange 250 provides at least one of weight or friction to stabilize apparatus 200b when outer member 212 is moved with respect to base 212 and to resist sliding when mattress 40 is raised.

Flange section 250 also provides a straight edge 256 against which a weighted flap 260 may reside. Weighted flap 260 is attached, e.g., sewn, adhered to, and/or press-fitted onto or into flange section 250. Weighted flap 260 may for example be made of a flexible material, such as rubber or a plastic coated fabric. Weighted flap 260 may be filled for example with bone dry sand. Weighted flap 260 even if laid flat on mattress 40 provides additional weight to stabilize apparatus 200b when outer member 212 is moved with respect to base 212 and to resist sliding when mattress 40 is raised. Weighted flap 260 as illustrated in FIGS. 21A and 21B also folds down over the upper edge 262 of mattress 40. Doing so prevents patient privacy apparatus 200c from sliding when mattress 40 is raised.

In the illustrated embodiment, weighted flap 260 includes at least one of (i) one or more hook 252 for hooking portable apparatus 200c to a side of the hospital bed or gurney for storage, or (ii) a handle or handle cutout 254 for transporting portable apparatus 200c. Hook 252 and handle 254 may alternatively be combined into a single one or more curved edge portion of flange 240b that serves both to hook around a portion of the bed or gurney and act as a handle or griping device.

FIGS. 21A and 21B also illustrate that hood 220 (for any of patient privacy apparatuses 200a to 200c) may be provided with one or more light 264 and switch 266 for turning lights 264 on and off. In the illustrated embodiment lights are located at outer member 212 and are oriented such that they cast light towards mattress 40 when hood 220 is unfolded. Lights 264 may for example be sewn, adhered, and/or mechanically fastened to and inside of hood 220. Lights 264 in an embodiment are or include high intensity light-emitting diodes (LED's) that are powered via a replaceable battery, such as a lithium battery. Lights 264 each have wires running within hood to switch 266, which (i) is a single switch that powers and unpowers each of lights 264 simultaneously or (ii) a multiple position or multiple actuation switch that powers, e.g., middle light 264 only at a first position or actuation and all three lights 264 at a second position or actuation. Lights 264 may be used for night reading, for inspecting the patient, or for any desired purpose.

FIGS. 20B and 21B illustrate that any of the portable patient privacy apparatuses, e.g., apparatus 200b or 200c, may provide a handle 258 with hood 220. Handle 258 in the illustrated embodiment is located in the middle of hood 220 and is formed with or connected to outer member 212, so that the patient or nurse may selectively grasp handle 258 and pull hood 20 from its folded state in FIGS. 20B and 21B to its fully unfolded state FIGS. 20B and 21B. The patient or nurse may also selectively grasp handle 258 and push hood 20 from its fully unfolded state to its folded state.

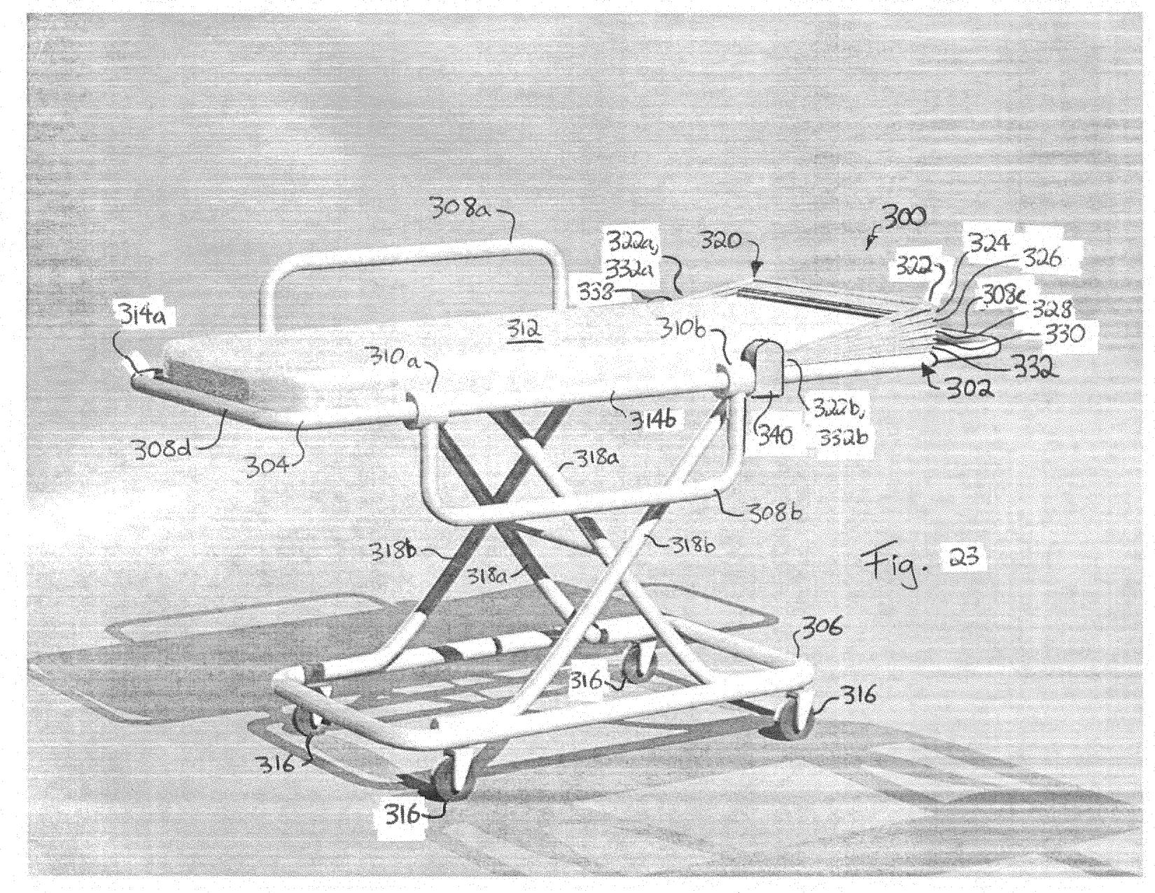

Referring now to FIG. 22, hinge 208 is illustrated in more detail. Its teachings are applicable equally to hinge 210. Hinge 208 (and 210) of FIG. 22 may be used with any of the alternative structure 240a to 240c discussed in connection with FIGS. 18 to 21. FIG. 22 illustrates that hinge 208 is connected hingedly to outer member 212 and perhaps to base 202. In one embodiment, base 202 does not move with respect to hinge 208 and indeed may be formed integrally with hinge 208. In an alternative embodiment, base member 202 does move hingedly with respect to hinge 208. Hinge 208 may include internal ratchets (not illustrated) that enable hood 220 to be releasably held in a fully folded state, fully unfolded state, or any intermediate state in between.

In the illustrated embodiment, intermediate members 222, 224, 226, 228 and 230 extend close to but do not contact hinge 208. Intermediate members 222, 224, 226, 228 and 230 extend within or between hood 220 or hood sections 220, respectively, to provide stability and shape to hood 220 when it is unfolded. Although not seen in FIG. 22, it should be appreciated that when portable patient privacy apparatuses 200a to 200c are in their folded positions, as is generally depicted in FIG. 22, hood 220 or hood sections 220 between base 202, outer member 212 and intermediate members 222, 224, 226, 228 and 230 are likewise folded. Hood 220 or hood sections 220 become unfolded when portable patient privacy apparatuses 200a to 200c become unfolded.

### Gurney with Integrated Patient Privacy Apparatus

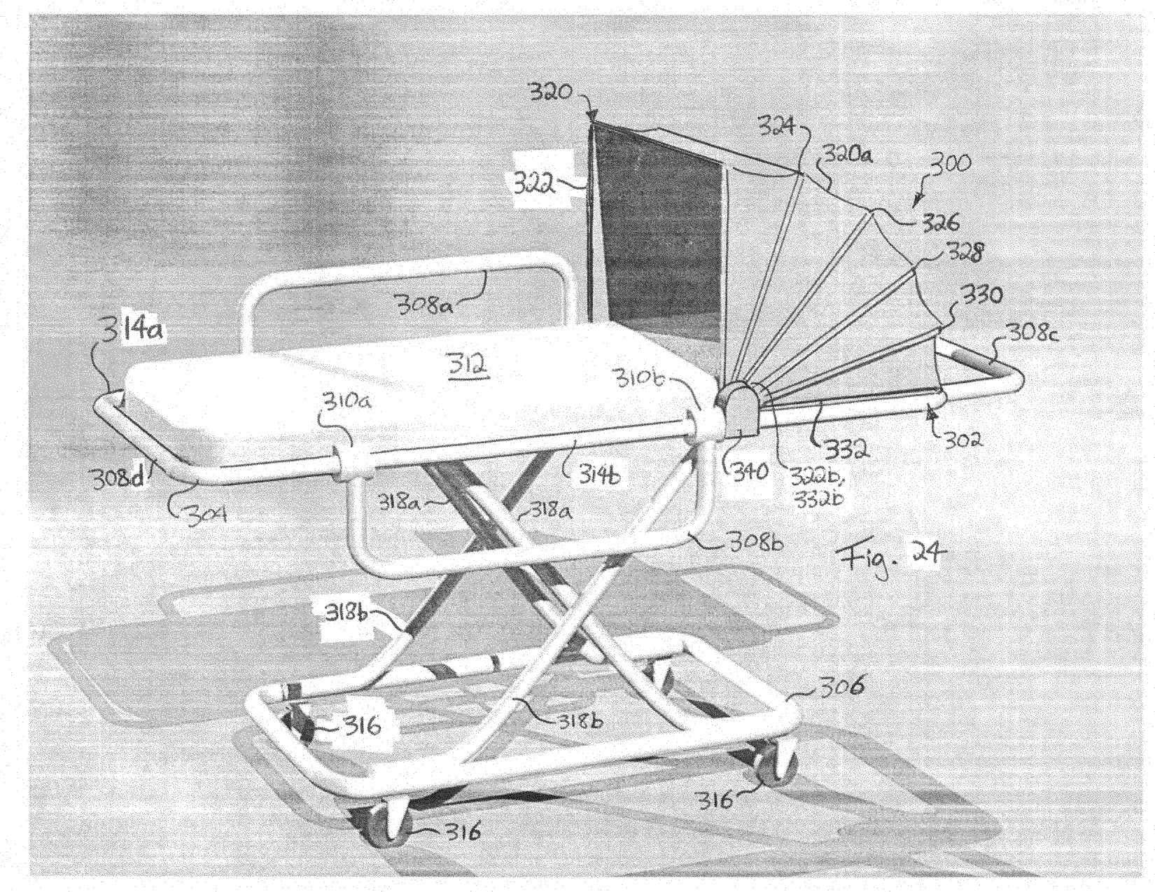

Referring now to FIGS. 23 to 25, one embodiment for a gurney having selectable patient privacy of the present disclosure is illustrated by gurney 300. Gurney 300 includes a collapsible frame assembly 302 including an upper frame 304 and a lower frame 306. Upper frame 304 may be made of multiple pieces fastened, press-fitted and/or welded together or may be made of a single bent piece fastened, press-fitted and/or welded together at its ends. Lower frame 306 may likewise be made of multiple pieces fastened, press-fitted and/or welded together or may be made of a single bent piece fastened, press-fitted and/or welded together at its ends. Upper and lower frames may be made of the same or different materials, such as metal (e.g., steel, stainless steel, aluminum or combinations thereof) or a tough and resilient plastic (e.g., teflon).

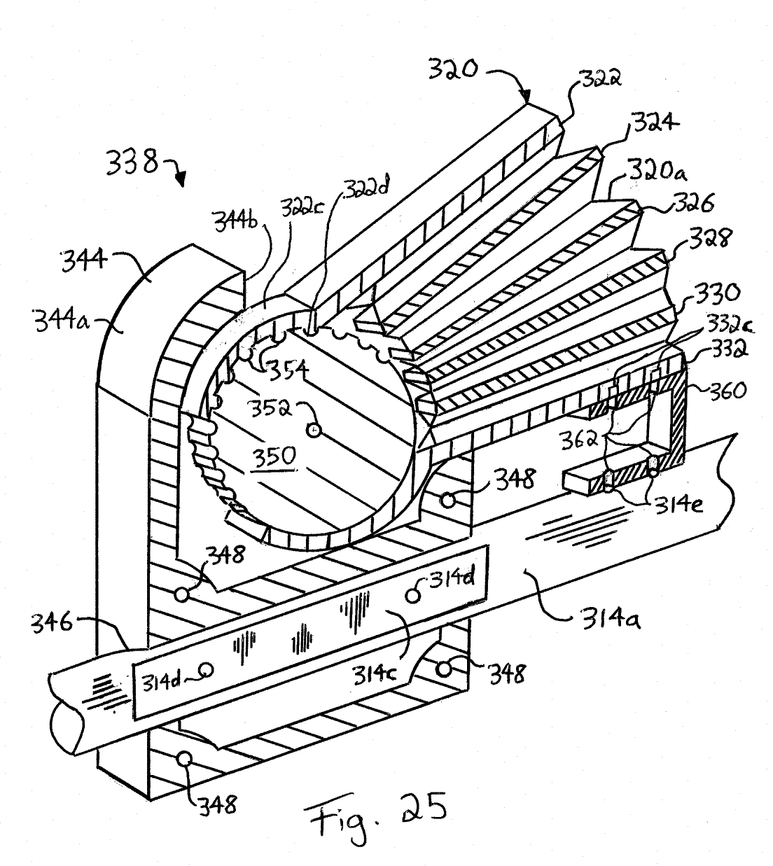

Side handles 308a and 308b are coupled rotationally and selectively lockingly to upper frame 304 via rotating and locking couplers 310a and 310b, respectively. Couplers 310a and 310b rotate about both side members 314a and 314b of upper frame 304. In FIGS. 23 and 24, side handle 308a is illustrated in the fully-up position, while side handle 308b is illustrated in the fully-down position. The fully-down position allows an injured or sick person to be lifted onto a mattress 312 of gurney 300. The fully-up position protects the injured or sick person from falling out of gurney 300. End handles 308c and 308d extend from upper frame 304 for a user to push or pull gurney 300 from either side of the gurney.

In an embodiment, couplers 310a and 310b do not lock in the fully-down position and instead rely on gravity to hold side handles 308a and 308b in their fully-down positions. Couplers 310a and 310b do however lock into place in their fully-up positions. In one embodiment, couplers 310a and 310b include spring-loaded pegs (not illustrated) that spring into a locking position when the pegs are rotated fully-up to meet mating detents (not illustrated) formed in side members 314a and 314b of upper frame. To release the locking pegs, the user is able to pull side handles 308a and 308b upwardly, for example, to lift the pegs out of the detents and then allow the side handles to be rotated downwardly to their fully-down position. As side handles 308a and 308b are rotated to their fully-down positions, locking pegs are compressed by the side handles back into couplers 310a and 310b.

Mattress 312 is in various embodiments supported by plural members or straps (not illustrated) extending between side members 314a and 314b. Mattress 312 may or may not be fastened to any one or more of side members 314a and 314b and/or the plural members or straps extending between same, e.g., via hook and pile fasteners.

Plural wheels or casters 316 are connected to lower frame 306 so as to have desired degrees of freedom of rotation. Upper frame 304 is connected in front in FIGS. 23 and 24 to lower frame 306, for example, via cross-members 318a and 318b. A like pair of cross-members 318a and 318b resides on the rear side of gurney 300. Cross-members 318a and 318b are hinged to each other so that gurney 300 may be collapsed when stored and transported. The hinged relationship between cross-members 318a and 318b also enables gurney 300 to be opened to the position illustrated in FIGS. 23 and 24. At the opened position, cross-members 318a and 318b lock as is known to those of skill, so that gurney 300 stays open and so that it may support an injured or sick person. Gurney 300 may then be collapsed when it is unlocked and cross-members 318a and 318b are flattened against each other.

Gurney 300 includes a built-in or connected hood assembly 320. Hood assembly 320 includes all of the structure, functionality and alternatives discussed above for hood 220. Hood assembly 320 when unfolded as illustrated in FIG. 24 is the portion of gurney 300 providing selective privacy to the injured or sick person. A hood 300a of hood assembly 320 is again made of a material that is foldable, washable and resistant to chemical detergents and disinfectants. Hood 320a in an embodiment is made of a smooth rubber or plastic. Hood 320a may alternatively be made of a polymer coated fabric, such as canvas coated with a smooth rubber or plastic. Hood 320a may further alternatively be made of a water-proof fabric, such as a synthetic fabric. In a preferred embodiment, hood 320a may be easily cleaned and is resistant to cleaning chemicals.

Hood assembly 320 as illustrated in FIG. 23 is foldable such that when its outer member 322 is folded against its base member 332, hood 320a folds onto itself between outer member 322 and its base member 332. When outer member 322 is unfolded away from base member 332, with the hinged ends of the members remaining in a mated relationship, hood 320a unfolds between outer member 322 and base member 332 to provide a patient privacy cover. Base member 332 and outer member 322 of hood assembly 320 are configured to be manually folded and unfolded in the illustrated embodiment.

FIG. 24 illustrates that hood assembly 320 of gurney 300 further includes at least one correspondingly rectangular, square, U-shaped or other polygonal-shaped intermediate member 324, 326, 328 and 330 located between base member 332 and top or outer member 322. Intermediate members 324, 326, 328 and 330 may, like base member 332 and outer member 322, be made of metal (e.g., aluminum, steel, stainless steel), plastic (e.g., teflon) or combinations thereof. Intermediate members 324, 326, 328 and 330 may have any of the rectangular, square, U- or other polygonal shapes discussed above for base member 332 and outer member 322. Intermediate members 324, 326, 328 and 330, like base member 332 and outer member 322, may be flat or otherwise structured strips foldable onto each other, wherein the flat strips are formed into one of the rectangular, square, U- or other polygonal shapes. While four intermediate members are illustrated in FIG. 24, hood assembly 320 may be provided with less than four or more than four such members.

Each of intermediate members 324, 326, 328 and 330 includes a first end and a second end, wherein each first end aligns at least generally with first ends 332a and 322a of base member 332 and outer member 322, respectively, and wherein each second end aligns at least generally with second ends 332b and 322b of base member 332 and outer member 322, respectively. The first ends of intermediate members 324, 326, 328 and 330 may be connected to, terminate at, or terminate before hinge 338. The second ends of intermediate members 324, 326, 328 and 330 may likewise be connected to, terminate at, or terminate before hinge 340. In various embodiments, intermediate members 324, 326, 328 and 330 are (i) attached to an outside of or (ii) imbedded within multiple plies of hood 320a. Hinges 338 and 340 are connected to side members 314a and 314b, respectively, of upper frame 304 and are illustrated in detail below in connection with FIG. 25.

When hood assembly 320 is partially or fully unfolded, intermediate members 324, 326, 328 and 330 provide spoke-like support for the hood between its base member 332 and its outer member 322. In an embodiment, intermediate members 324, 326, 328 and 330 have like radii or are otherwise sized the same as base member 332 and outer member 322, so that a dome-like form of privacy may be established over an injured or sick person's head. Such privacy may be desired inside a hospital room or in a hospital hallway as has been described above. Additionally, privacy may be provided outside while an injured or sick person is being transported, waits for an ambulance to be prepared. Gurney 300 additionally provides cover against ambient conditions, such as hot sun, rain, wind, and/or snow.

Although not illustrated in FIG. 24, hood assembly 320, like hood 220, may be provided with an openable hatch 232 (FIG. 19) for viewing the injured or sick person when hood assembly 320 is unfolded. A window may be provided beneath the opened hatch 232 and may be a clear or semi-clear plastic sheet. Openable hatch 232 may be made of the same, e.g., opaque, material as the rest of hood assembly 320. Openable hatch 232 may also be disconnected at its top, e.g., via one or more hook and loop connector 234 and 236 (FIG. 19), and folded down along fold line 238 (FIG. 19) to create a hole within hood assembly 320. As mentioned, in an alternative embodiment, a clear or semi-clear plastic sheet may be located beneath openable hatch 232. In any of the window or openable hatch 232 embodiments, a patient or caregiver located behind gurney 300, e.g., pushing the gurney via end handle 308c, may view the injured or sick person if desired. Additionally, although not illustrated in FIGS. 23 and 24, hood assembly 320 of gurney 300 may be provided with a handle 258 as described above, including the disclosed location of handle 258.

Referring now to FIG. 25, hinge 338 of hood assembly 320 and gurney 300 is illustrated in more detail. Its teachings are applicable equally to hinge 340. In the illustrated embodiment, hinge 338 includes a hinge housing 344, which may be made of metal, e.g., steel, stainless steel, aluminum, and alloys thereof, or alternatively of a rugged plastic, such as teflon. Housing 344 may be made of first and second pieces that each define an aperture 346 sized to fit snugly around a portion (e.g., half) of side member 314a (or side member 314b for hinge 340) of upper frame 304 of gurney 300. The first and second pieces of housing 344 in the illustrated embodiment fit together around side member 314a and bolt to each other via mounting holes 348. Side member 314a may include flats or flattened portions 314c on either side to center the separate pieces of housing 344. Hinge 338 may be configured such that housing 344 compresses onto flats or flattened portions 314c to hold the hinge fixed to side member 314a. Alternatively or additionally, side member 314a includes or defines mounting holes 314d, which mate with or mount to mating holes (not illustrated) in the separate pieces of housing 344.

A ratcheted, geared or detent providing disk 350 is located within housing 344 in the illustrated embodiment. In the illustrated embodiment, disk 350 does not move within housing 344 and base member 332 does not move with respect to disk 350. Disk 350 may therefore be formed integrally with housing 344 or be a separate piece bolted (e.g., via mounting hole 352), adhered to or press-fitted to housing 344. A first portion, e.g., half, of disk 350 may for example be formed with a first piece of housing 344, while a second portion, e.g., half, of disk 350 may be formed with a second piece of housing 344. Alternatively, disk 350 is provided in whole with one of the pieces of housing 344. Base member 332 may be formed with or connected to either one or both of housing 344 and/or disk 350.

Base member 332 in the illustrated embodiment is connected in multiple places to side members 314a and 314b (and the end member, not illustrated, extending between the side members 314a and 314b) of upper frame 304 of gurney 300 via multiple metal or plastic u-brackets 360. U-brackets 360 include mounting holes 362 that mate with (i) mating holes 314e in side members 314a and 314b and the end member of upper frame 304 extending between side members 314a and 314b and (ii) mating holes 332c formed in base member 332. Alternatively, base member 332 extends directly along and contacts the top of side members 314a and 314b and the end member of upper frame 304 extending between side members 314a and 314b (see e.g., FIGS. 23 and 24), where base member 332 may be bolted via mating holes 332c and 314e, or otherwise fastened, e.g., via hook and loop connectors, directly to side members 314a and 314b and the end member of upper frame 304 extending between side members 314a and 314b. Here, u-brackets 360 are not needed. In still another alternative embodiment, side members 314a and 314b, and the end member of upper frame 304 extending between side members 314a and 314b, serve as the base member 332 of hood assembly 320, where the flexible hood 320a is connected directly to side members 314a and 314b and the end member of upper frame 304 extending between side members 314a and 314b. Here again, u-brackets 360 are not needed.

In the illustrated embodiment, disk 350 includes ratchets, gears or detents 354. Outer member 322 includes a curved section 322c that fits within and is held in place by a curved section 344a of housing 344. Curved section 322c of outer member 322 includes or defines mating ratchets, gears or detents 322d that slide along and mate with ratchets, gears or detents 354 of disk 350 when outer member 322 is rotated to a desired position. The mating ratchets, gears or detents hold hood assembly 320a in a desired fully unfolded or partially unfolded position. In one embodiment, curved section 344a of housing 344 is configured such that its end 344b is located so as to provide a hardstop when outer member 322 is rotated to its fully unfolded position, causing hood assembly 320 to provide maximum patient privacy. Curved section 322c of outer member 322 is made to be long enough such that it resides beneath and is thus held in place by curved section 344a of housing 344 even when outer member 322 is rotated to its fully folded position (clockwise in FIG. 25). The mating ratchets, gears or detents may also be used between outer member 212 and hinge 208 in FIGS. 18 to 22 above.

In the illustrated embodiment, intermediate members 324, 326, 328 and 330 extend close to but do not contact hinge disk 350. Intermediate members 324, 326, 328 and 330 extend within or between hood assembly 320 or hood assembly sections 320, respectively, to provide stability and shape to hood assembly 320 when it is unfolded. Although not seen in FIG. 25, it should be appreciated that when hood assembly 320 is in its fully folded position, as is generally depicted in FIG. 23, hood assembly 320 or hood assembly sections 320 between base member 332, outer member 322 and intermediate members 324, 326, 328 and 330 are likewise folded. Hood assembly 320 becomes unfolded when intermediate members 324, 326, 328 and 330 become unfolded.

### ELEMENT NUMBER LISTING

10a—hospital bed
10b—hospital bed
10c—hospital bed
12—frame
14—wheels
16—foot pedal
18—cross-beams
20—control unit
22—wiring
22a—linear actuator wiring
22b—user input device wiring
24—legs
26—mattress platform
28—piston-cylinders
30—mounts
32—member of mount
34—frame bearing
34a—first portion of frame bearing
34b—second portion of frame bearing
36—panel bearing
36a—first portion of panel bearing
36b—second portion of panel bearing
38a—first hardstop
38b—second hardstop
39—electrical contact switch or sensor
40—mattress
41—fold line of mattress
42—shaft
44—arm
44a—sliding seal of arm
44b—distal end of arm
46—cap
48—server computer
50 (50a to 50f)—expandable and contractible panels
52—lower shell of panels
54—upper shell of panels
55a, 55b—linear actuator holding cylinders
56—cutouts in upper shell
58—handles
60—mounting flanges
62—gasket between shells
64—guides of lower shell
66—clearance mounting hole of upper shell
68a to 68a—hospitals
69—nurse
70—linear actuation assembly
72—mounting plate
73—notches made in sidewall of mounting plate
74—lower bearing
76—upper bearing
78—lead or ball screw
80—motor
82—flexible coupler
84—smaller pulley
86—timing belt
88—larger pulley
90—drive arm
92—limit switch catch of drive arm
94—lower limit switch
96—upper limit switch
98—wiring conduit
100—linear actuator
102 (102a to 102f)—first alternative panel
104—shell including shell halves 104a and 104b
106—slot
108—handles
110—plate
112—roller bearings
114—bearing housings
115—attachment flange
116—top of plate
118—handles
120—bellows
122—sealed section
123—hydraulic line
124—flap
130—brush holder
132—brushes
134—second alternative panel
136—shell
138—plate
140—slot-forming members
142—top lip
144—inwardly extending tabs
146—aligned tabs at the bottom of plate 138
150a—master user input device
150b—individual panel user input device
152—flexible electrical conduit
154—threaded mounting hole
156—quick disconnect connector
156a—quick disconnect connector half
156b—quick disconnect connector half
158—housing of master user interface device
160—up/down rocker switch of master user interface device
161a and 161b—up and down buttons
162—panel selection button
163—bed selection button
164—button light
165—raise bed button
166—upper-3 selection button
168—lower-3 selection button
170—axis
172—undo button
174—home button
176—nurse lock button
178—travel stop indicator
180—upper momentary button
182—upper lock button
184—lower momentary button
186—lower lock button
190—third alternative panel
192—shell
194—fourth alternative panel
196a—base shell
196b—rotating shell
198—hinge
200a, 200b, 200c—portable patient privacy apparatuses
202—base
204—first end of base
206—second end of base
208—first hinge
210—second hinge
212—outer member
214—first end of outer member
216—second end of outer member
220—hood
222, 224, 226, 228 and 230—intermediate members
232—window or openable hatch
234 and 236—hook and loop connectors
238—fold line
240a to 240c—structures configured to discourage patient privacy apparatus from moving
242—first strap of portable patient privacy apparatus
244—second strap of portable patient privacy apparatus
246—buckle or latch of the straps
250—flange section
252—hooks of the flange
254—handle of the flange
256—straight edge
258—handle of hood
260—weighted flap
262—upper edge of the mattress
264—lights
266—switch for lights
300—gurney
302—collapsible frame assembly
304—upper frame
306—lower frame
308a, 308b—side handles of upper frame
308c, 308d—end handles of upper frame
310a, 310b—locking couplers
312—mattress of gurney
314a and 314b—side members of upper frame
314c—flats or flattened portions of side members
314d—hinge mounting holes in side members
314e—u-bracket mounting holes in side members
316—wheels or casters
318a and 318b—cross-members
320—hood assembly of gurney
320a—hood of hood assembly
322—outer member of hood
322a, 322b—first and second ends of outer member
322c—curved section of outer member
322d—ratchets, gears or detents of outer member
324, 326, 328 and 330—intermediate members of hood
332—base member of hood
332a, 332b—first and second ends of base member
332c—u-bracket mounting holes of base member
338—hinge of hood and gurney
340—hinge of hood and gurney
344—hinge housing
344a—curved portion of hinge housing
344b—hardstop of hinge housing
346—pole mounting aperture in hinge housing
348—mounting holes in hinge housing
350—ratcheted, geared or detent disk of hinges
352—mounting hole of disk
354—ratchets, gears or detents of disk
360—u-bracket
362—mounting holes of u-bracket

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A hospital bed comprising:
a frame defining a location to place a mattress; and
at least one side panel in mechanical communication with the frame, the at least one side panel selectively expandable so as to provide patient privacy when desired and contractible when privacy is not desired.

2. The hospital bed of claim 1, wherein the at least one side panel is additionally selectively translatable relative to the frame.

3. The hospital bed of claim 2, wherein the at least one side panel is manually translatable relative to the frame.

4. The hospital bed of claim 1, wherein the at least one side panel is additionally selectively rotatable relative to the frame.

5. The hospital bed of claim 4, wherein the at least one side panel is manually rotatable relative to the frame.

6. The hospital bed of claim 1, which includes a control unit and a user input device in communication with the control unit, the control unit programmed to enable the user to actuate a button of user the user input device to cause the at least one side panel to expand or contract.

7. The hospital bed of claim 6, wherein the user input device and the control unit are configured such that the at least one side panel expands or contracts as the user continues to actuate the button of the user input device.

8. The hospital bed of claim 6, wherein the user input device and the control unit are configured such that the at least one side panel continues to expand or contract after the user discontinues actuation of the button of the user input device.

9. The hospital bed of claim 6, wherein the button of the user input device includes first and second settings, wherein the first setting and the control unit are configured to cause the at least one side panel to expand or contract as the user continues to actuate the input device at the first setting, and wherein the second setting and the control unit are configured to cause the at least one side panel to continue to expand or contract after the user discontinues actuation of the second setting.

10. The hospital bed of claim 6, wherein the button of the user input device is a first button, and which includes a second button, wherein the first button and the control unit are configured to cause the at least one side panel to expand or contract as the user continues to actuate the first button, and wherein the second button and the control unit are configured to cause the at least one side panel to continue to expand or contract after the user discontinues actuation of the second button.

11. The hospital bed of claim 6, wherein the user input device is at least one of (i) located so as to be actuated by a patient lying in bed, (ii) located so as to be actuated by a non-patient standing next to the bed, (iii) located along a flexible cord, (iv) provided separately as part of a wireless controller, (v) located on the at least one panel, or (vi) located on a user's personal communication device (“PCD”).

12. The hospital bed of claim 11, which includes a plurality of input devices located or provided according to at any two or more of (i) to (vi).

13. The hospital bed of claim 1, wherein the at least one selectively expandable side panel includes a first shell that slidingly engages the second shell.

14. The hospital bed of claim 13, wherein the second shell is in mechanical communication with the frame and includes a linear actuator that translates the first shell with respect to the second shell to selectively expand or contract the at least one side panel.

15. The hospital bed of claim 14, wherein the linear actuator includes a motor outputting to a lead screw and a translatable drive arm threadingly engaging the lead screw.

16. The hospital bed of claim 15, wherein the motor and the lead screw are mounted to the second shell, and wherein the drive arm is in mechanical communication with the first shell.

17. The hospital bed of claim 15, wherein the drive arm includes a first portion threadingly engaging the lead screw and a second elongated portion mechanically engaging the first shell.

18. The hospital bed of claim 17, wherein the second elongated portion mechanically engages a top of the first shell.

19. The hospital bed of claim 18, wherein a top of the second elongated portion is mechanically secured to the top of the first shell.

20. The hospital bed of claim 15, wherein the motor is mechanically connected to the lead screw via mechanical reduction device.

21. The hospital bed of claim 1, wherein the at least one side panel is selectively expandable via a plate located within a shell of the panel, the shell including a slot enabling the plate to move outside of and back into the shell.

22. The hospital bed of claim 21, which includes a bellows located within the shell and beneath the plate, the bellows selectively expandable via positive pressure and selectively contractible via negative pressure.

23. The hospital bed of claim 1, wherein the at least one side panel is selectively expandable via a plate located on an outside surface of the panel, the outside surface including plural slot forming members slideably holding the plate.

24. The hospital bed of claim 1, wherein the at least one side panel is selectively expandable via an expandable bellows located on a top surface of the panel, the bellows optionally selectively expandable via positive pressure and selectively contractible via negative pressure.

25. The hospital bed of claim 1, wherein the at least one side panel is selectively expandable via a rotatable shell connected hingedly to a lower shell, the lower shell in mechanical communication with the frame.

26. A hospital bed comprising:
a frame defining a location to place a mattress;
a first side panel in mechanical communication with the frame, the first side panel selectively expandable so as to provide patient privacy when desired and contractible when privacy is not desired;
a second side panel in mechanical communication with the frame, the second side panel selectively expandable so as to provide patient privacy when desired and contractible when privacy is not desired; and
a control unit programmed to enable the user to expand or contract the first and second side panels separately.

27. The hospital bed of claim 26, wherein the first and second side panels are disposed on opposing sides of the frame.

28. The hospital bed of claim 26, wherein the first and second side panels are disposed perpendicular to one another.

29. The hospital bed of claim 26, wherein the first and second side panels are disposed on a same side of the frame.

30. The hospital bed of claim 26, wherein the control unit is further programmed to enable the user to expand or contract the first and second side panels together.

31. The hospital bed of claim 26, which includes at least one additional side panel that is non-expandable.

32. The hospital bed of claim 31, wherein the first and second selectively expandable side panels and the at least one additional non-expandable side panel are selectively translatable and/or rotatable relative to the frame.
